(19) United States
(12) Patent Application Publication
(10) Pub. No.: US 2016/0055583 A1
(43) Pub. Date: Feb. 25, 2016

(54) MOBILE GLOBAL EXCHANGE PLATFORM

(71) Applicant: Mozido, Inc., Austin, TX (US)

(72) Inventors: Michael A. Liberty, Orlando, FL (US); Mike Love, Austin, TX (US); Steve Bacastow, Cumming, GA (US); Minaz Sarangi, Newmarket (CA); Randall Dion Lund, Cedar Park, TX (US); Brent Charles Cerrato, Atlanta, GA (US)

(21) Appl. No.: 14/928,105

(22) Filed: Oct. 30, 2015

Related U.S. Application Data
(63) Continuation-in-part of application No. 13/964,707, filed on Aug. 12, 2013, now abandoned.
Application No. 13/964,707 is a continuation of application No. 13/484,199, filed on May 30, 2012, now Pat. No. 8,538,845.
(60) Provisional application No. 62/075,657, filed on Nov. 5, 2014.
(60) Provisional application No. 61/522,099, filed on Aug. 10, 2011.
(60) Provisional application No. 61/493,064, filed on Jun. 3, 2011.

(51) Int. Cl. G06Q 40/04; G06Q 20/36; G06Q 20/10; G06Q 20/40

(52) U.S. Cl. CPC G06Q 40/04; G06Q 20/4016; G06Q 20/405; G06Q 20/36; G06Q 20/108

(57) ABSTRACT

A mobile global exchange platform is provided. The mobile global exchange platform includes a processor, a hardware receiver that receives an indication that a sum is to be transferred between transaction systems, a determining component that determines a country of origin for the transaction systems, a data accessing component that accesses data structures that indicate financial regulatory schemes under which the transaction systems operate, an analyzing engine that analyzes the current regulatory schemes to determine how to transfer sums between the first and second transaction systems in accordance with each system's respective financial regulatory scheme, and a value transferring component configured to electronically transfer the sum, in compliance with the regulatory schemes of the transaction systems, so that the sum is transferred from one transaction system to another transaction system according to each system's respective current regulatory schemes.

### CROSS-REFERENCE TO RELATED APPLICATIONS

This application claims priority to and the benefit of U.S. Provisional Patent Application Ser. No. 62/075,657, entitled “Mobile Global Exchange Platform”, filed on Nov. 5, 2014, and is a continuation-in-part of U.S. patent application Ser. No. 13/964,707, filed Aug. 12, 2013, entitled “Monetary Transaction System”, which application is a continuation of U.S. patent application Ser. No. 13/484,199 (now U.S. Pat. No. 8,538,845), filed May 30, 2012, entitled “Monetary Transaction System”, which application claims priority to and the benefit of U.S. Provisional Application Ser. No. 61/522,099, filed on Aug. 10, 2011, entitled “Mobile Wallet Platform”, and also claims priority to and the benefit of U.S. Provisional Application Ser. No. 61/493,064, filed on Jun. 3, 2011, entitled “Mobile Wallet Platform”. All of the aforementioned applications are incorporated by reference herein in their entirety.

### BACKGROUND

Mobile phones and other digital devices have become increasingly popular in recent years. Many mobile device users use their devices to perform countless different daily tasks. For instance, mobile devices allow users to check email, send and receive instant messages, check calendar items, take notes, set up reminders, browse the internet, play games or perform any number of different things using specialized applications or “apps”. These applications allow mobile devices to communicate with other computer systems and perform a wide variety of network-connected tasks previously not possible with a mobile device.

### BRIEF SUMMARY

Embodiments described herein are directed to monetary transaction system for conducting monetary transactions between transaction system subscribers and other entities. In one embodiment, the monetary transaction system includes a mobile device configured to run a monetary transaction system application. The monetary transaction system also includes a monetary transaction system subscriber that has a profile with the system. The subscriber indicates, via the monetary transaction system application, one or more specified transactions that are to be performed using the monetary transaction system. The system further includes a monetary transaction system processor that performs the transactions specified by the subscriber. Performing these transactions includes communicating with a monetary transaction database to determine whether the transaction is permissible based on data indicated in the subscriber's profile.

The monetary transaction system also includes at least one entity that is to be involved in the specified transaction, where the entity has a profile with the monetary transaction system. This entity may be a person, a retail store, an agent or other entity. The subscriber may have access to a bank account, or may be an “unbanked user” that does not have access to a bank account. Each of the terms included above will be described in greater detail below in conjunction with the drawings.

The monetary transaction system may be used for many different tasks including enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below.

In one embodiment, a cloud-based mobile global exchange platform is provided. The mobile global exchange platform includes one or more processors, a hardware receiver that receives an indication that a specified sum is to be transferred between a first transaction system and a second transaction system, a determining component that determines a country of origin for the first transaction system, and further determines a country of origin for the second transaction system, and a data accessing component that accesses a database with a first data structure indicating a regulatory scheme under which the first transaction system operates, and further configured to access a second data structure indicating a regulatory scheme under which the second transaction system currently operates. The first and second regulatory schemes indicate multiple rules that are to be enforced when transferring value in or out of the country of origin. The first regulatory scheme has at least one rule that is different than the second regulatory scheme.

The cloud-based mobile global exchange platform also includes an analysis engine that conducts a real-time analysis of the current regulatory schemes for the first and second transaction systems operable to determine which specific rules apply when transferring the specified sum between the first and second transaction systems in accordance with each system's respective regulatory scheme. The cloud-based mobile global exchange platform also includes a value transferring component configured to electronically transfer the specified sum, in compliance with the regulatory schemes of the first and second transaction systems, such that the specified sum is transferred from the first transaction system to the second transaction system according to each system's respective current regulatory schemes.

In another embodiment, a computer program product is provided that causes a computing system to instantiate a user interface that includes the following: a first button that, when selected, transmits one or more portions of data indicating that a specified sum is to be transferred between a first transaction system and a second transaction system, a second button that, when selected, transmits authentication credentials from a mobile wallet application, the authentication credentials corresponding to a mobile wallet user, a graphical indicator indicating that the transfer is currently being processed, and an electronic receipt indicator configured to show that the sum was transferred between the first transaction system and the second transaction system.

In another embodiment, a mobile global exchange platform includes processors and computer-readable storage media having stored thereon computer-executable instructions that, when executed by the processors, causes the computing system to perform a remittance. Performing a remittance includes the following: receiving subscriber communication over one of a plurality of channels connected to the mobile global exchange platform, where the subscriber communication indicates that a subscriber desires to transfer a specified sum to a recipient using a selected transfer method from the subscriber. Performing a remittance further includes verifying that the selected transfer method is capable of providing the specified sum, validating the status of the recipient to ensure the recipient has a valid subscriber account, debiting the selected payment method by the specified sum, transferring the specified sum to the recipient over at least one of the plurality of channels connected to the mobile global exchange platform and notifying the subscriber that the specified sum was transferred to the recipient over at least one of the plurality of channels connected to the mobile global exchange platform.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a monetary transaction system architecture in which embodiments described herein may operate.

FIG. 2 illustrates an alternate example embodiment of a monetary transaction system.

FIG. 3 illustrates an example data flow for performing a subscriber deposit via a mobile wallet.

FIG. 4 illustrates an example data flow for performing a subscriber withdrawal via a mobile wallet.

FIGS. 5A and 5B illustrate example data flows for performing subscriber-to-subscriber and subscriber-to-non-subscriber eMoney transfers via a mobile wallet, respectively.

FIGS. 6A and 6B illustrate example data flows for performing subscriber-to-subscriber and subscriber-to-non-subscriber international eMoney transfers via a mobile wallet, respectively.

FIG. 7 illustrates an example data flow for performing a subscriber airtime purchase via a mobile wallet.

FIG. 8 illustrates an example data flow for performing a subscriber-initiated bill pay via a mobile wallet.

FIG. 9 illustrates an example data flow for performing a subscriber-initiated retail purchase via a mobile wallet.

FIGS. 10A and 10B illustrate example data flows for requesting and repaying micro-loans via a mobile wallet, respectively.

FIG. 11A illustrates an example data flow of a subscriber receiving a direct deposit via a mobile wallet.

FIG. 11B illustrates an example data flow of a subscriber receiving a governmental welfare payment via a mobile wallet.

FIG. 12A illustrates an example data flow of an agent administrator distributing eMoney via a mobile wallet.

FIG. 12B illustrates an example data flow of an agent company making a deposit using a mobile wallet.

FIG. 13 illustrates an example data flow of an agent company making a withdrawal using a mobile wallet.

FIG. 14 illustrates an example data flow of a subscriber making a deposit at an agent branch using a mobile wallet.

FIG. 15 illustrates an example data flow of a subscriber making a deposit with a non-agent using a mobile wallet.

FIG. 16 illustrates an example data flow of a subscriber making a withdrawal with an agent using a mobile wallet.

FIG. 17A illustrates an example data flow of a subscriber making a withdrawal from an ATM using a mobile wallet.

FIG. 17B illustrates an example data flow of a subscriber-to-subscriber money transfer using a mobile wallet.

FIG. 17C illustrates an example data flow of a subscriber-to-non-subscriber money transfer using a mobile wallet.

FIG. 18A illustrates an example data flow of a subscriber-to-subscriber international money transfer using a mobile wallet.

FIG. 18B illustrates an example data flow of a subscriber-to-non-subscriber international money transfer using a mobile wallet.

FIG. 19A illustrates an example data flow of a subscriber-to-subscriber international money transfer using a mobile wallet.

FIG. 19B illustrates an example data flow of a non-subscriber-to-subscriber international money transfer using a mobile wallet.

FIG. 20 illustrates an embodiment of a Mobile Global Exchange (MGX) platform and various complementary components.

FIG. 21 illustrates another embodiment of an MGX platform and its various complementary components.

FIG. 22 illustrates an embodiment of an integrated platform of which the MGX platform is a part.

FIG. 23 illustrates an embodiment of a proposed fee distribution among parties for different transactions.

FIG. 24A illustrates an embodiment of a smart phone having functionality provided by the MGX platform.

FIG. 24B illustrates an embodiment of an alternative phone having functionality provided by the MGX platform.

FIG. 25 illustrates an embodiment in which a user interacts with a monetary transaction system to perform different functions.

FIG. 26-29 describe the detailed steps performed by the MGX platform in connection with a remittance transaction.

FIG. 30 illustrates an embodiment in which the MGX platform is implemented as a centralized message processing application.

FIG. 31 illustrates an embodiment of a flowchart in which a payment is processed using the MGX platform.

FIG. 32 illustrates an embodiment in which the MGX platform is implemented of facilitate a peer-to-peer transfer.

FIG. 33 illustrates an embodiment of a flowchart in which a peer-to-peer transfer is processed using the MGX platform.

FIG. 34 illustrates a computing architecture that includes at least portions of a MGX platform.

FIG. 35 illustrates an embodiment of a user interface in a mobile device.

### DETAILED DESCRIPTION

Embodiments described herein are directed to monetary transaction system for conducting monetary transactions between transaction system subscribers and other entities. In one embodiment, the monetary transaction system includes a mobile device configured to run a monetary transaction system application. The monetary transaction system also includes a monetary transaction system subscriber that has a profile with the system. The subscriber indicates, via the monetary transaction system application, one or more specified transactions that are to be performed using the monetary transaction system. The system further includes a monetary transaction system processor that performs the transactions specified by the subscriber. Performing these transactions includes communicating with a monetary transaction database to determine whether the transaction is permissible based on data indicated in the subscriber's profile.

The monetary transaction system also includes at least one entity that is to be involved in the specified transaction, where the entity has a profile with the monetary transaction system. This entity may be a person, a retail store, an agent or other entity. The subscriber may have access to a bank account, or may be an “unbanked user” that does not have access to a bank account. Each of the terms included above will be described in greater detail below in conjunction with the drawings.

The monetary transaction system may be used for many different tasks including enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below.

In one embodiment, a cloud-based mobile global exchange platform is provided. The mobile global exchange platform includes one or more processors, a hardware receiver that receives an indication that a specified sum is to be transferred between a first transaction system and a second transaction system, a determining component that determines a country of origin for the first transaction system, and further determines a country of origin for the second transaction system, and a data accessing component that accesses a database with a first data structure indicating a regulatory scheme under which the first transaction system operates, and further configured to access a second data structure indicating a regulatory scheme under which the second transaction system currently operates. The first and second regulatory schemes indicate multiple rules that are to be enforced when transferring value in or out of the country of origin. The first regulatory scheme has at least one rule that is different than the second regulatory scheme.

The cloud-based mobile global exchange platform also includes an analysis engine that conducts a real-time analysis of the current regulatory schemes for the first and second transaction systems operate to determine which specific rules apply when transferring the specified sum between the first and second transaction systems in accordance with each system's respective regulatory scheme. The cloud-based mobile global exchange platform also includes value transferring component configured to electronically transfer the specified sum, in compliance with the regulatory schemes of the first and second transaction systems, such that the specified sum is transferred from the first transaction system to the second transaction system according to each system's respective current regulatory schemes.

In another embodiment, a computer program product is provided that causes a computing system to instantiate a user interface that includes the following: a first button that, when selected, transmits one or more portions of data indicating that a specified sum is to be transferred between a first transaction system and a second transaction system, a second button that, when selected, transmits authentication credentials from a mobile wallet application, the authentication credentials corresponding to a mobile wallet user, a graphical indicator indicating that the transfer is currently being processed, and an electronic receipt indicator configured to show that the sum was transferred between the first transaction system and the second transaction system.

In another embodiment, a mobile global exchange platform includes processors and computer-readable storage media having stored thereon computer-executable instructions that, when executed by the processors, causes the computing system to perform a remittance. Performing a remittance includes the following: receiving subscriber communication over one of a plurality of channels connected to the mobile global exchange platform, where the subscriber communication indicates that a subscriber desires to transfer a specified sum to a recipient using a selected transfer method from the subscriber. Performing a remittance further includes verifying that the selected transfer method is capable of providing the specified sum, validating the status of the recipient to ensure the recipient has a valid subscriber account, debiting the selected payment method by the specified sum, transferring the specified sum to the recipient over at least one of the plurality of channels connected to the mobile global exchange platform and notifying the subscriber that the specified sum was transferred to the recipient over at least one of the plurality of channels connected to the mobile global exchange platform.

The following discussion now refers to a number of methods and method steps or acts that may be performed. It should be noted, that although the method steps may be discussed in a certain order or illustrated in a flow chart as occurring in a particular order, no particular ordering is necessarily required unless specifically stated, or required because a step is dependent on another step being completed prior to the step being performed.

Embodiments of the mobile global exchange platform described herein may comprise or utilize a special purpose or general-purpose computer including computer hardware, such as, for example, one or more processors and system memory, as discussed in greater detail below. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

a computing system typically includes at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product. An example of such an operation involves the manipulation of data. The computer-executable instructions (and the manipulated data) may be stored in the memory of the computing system. The computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments described herein also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, embodiments described herein may comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

Various terminology will be used herein to describe the monetary transaction system (also referred to as a “mobile wallet platform”, “mobile wallet program” or “mobile wallet transaction system”). The term “agent” is used to refer to an individual with mobile financial services (mFS) transaction system tools and training to support specific mFS functions. These mFS functions include subscriber registration and activation, and the deposit and withdrawal of funds from the mFS transaction system. Agents are representatives of the mFS transaction system or “program”. Agents can be employees or contractors of the program provider, or other companies and organizations that partner with the program provider to provide these services themselves. Agents may be found in every facet of a typical economy, and may include large retailers, mobile network operators (MNO) airtime sales agents, gas stations, kiosks, or other places of business.

The mobile wallet platform includes a mobile wallet application, web interface or some other type of functionality that allows the user to interact with the mFS platform using their mobile device. The mobile wallet application may include a subscriber identity module (SIM) application, an Unstructured Supplementary Service Data (USSD) application, a smartphone application, a web application, a mobile web application, a Wireless Application Protocol (WAP) application, a Java 2 Platform, Micro Edition (J2ME) application, a tablet application or any other type of application or interface that provides tools for the agent to register, activate, and offer other services to the mFS subscriber.

As used herein, a mobile wallet application is a mobile wallet application installed on a SIM card. A USSD application is an application that implements USSD for various functionality including prepaid callback service, location-based content services, menu-based information services and other mobile wallet platform services. A web application is one that implements or uses the internet to provide mobile wallet platform functionality. A mobile web application is similar to a web application, but is tailored for mobile devices. A WAP application is one that uses the wireless application protocol to communicate with the mobile wallet platform to provide the platform's functionality. A J2ME application is an application developed in Java and is designed to provide mobile wallet functionality on a variety of different hardware. A tablet application is an application specifically designed for a touchscreen-based tablet that provides mobile wallet platform functionality for tablet devices, and as part of configuring the phone on the network. Any of these applications (or any combination thereof) may be provided on the user's mobile device. This functionality can also be made available on a retail point of sale (POS) system or web site.

The term “agent administrator” refers to an individual with mFS program tools and training to administrate the allocation of funds to agent branches (e.g. retail locations). As agents perform mFS transactions with subscribers, such as depositing and withdrawing money, the agents are adding and removing money from their own accounts. If there are insufficient funds in the agent's account to complete a transaction, additional money will need to be transferred from the agent company's master account to that agent branch account to cover that transaction. An agent administrator is responsible for these funds transfers. Any of the applications referred to above may be configured to provide tools used by the agent administrator to view the agent company balance, view the agent branch balances, and transfer funds into and out of agent branch mobile wallets. This functionality can also be made available on a website for easier access.

The term “agent administrator mobile wallet application” refers to a software program or application installed on the agent administrator's terminal in the agent administrator's mobile device (such as a mobile phone or tablet). This software application provides the agent administrator the ability to securely perform agent administrator functions such as querying the agent company account balance or transferring funds into and out of agent branch accounts. The agent administrator's mobile wallet application may be installed on a global system for mobile communications (GSM) SIM card (or on any other type of SIM card), and may be accessed using a GSM mobile phone. The agent administrator's application may also be installed on a code division multiple access (CDMA) mobile phone, a 3G, 4G, 4G LTE (Long Term Evolution) or other wireless carrier standard. The application may, additionally or alternatively, be installed directly on the agent administrator's mobile device. The application communicates with the mFS transaction system using binary and/or text short message service (SMS) messages. A wireless service provider or MNO provides the GSM SMS network infrastructure on which the mFS platform operates.

In some embodiments, the mFS platform application may utilize triple data encryption standard (3DES) encryption (or some other type of encryption), encrypted message signing, and password security on some or all of its communications with the mFS transaction system in order to ensure that the transactions are properly secured and authenticated.

The term “agent branch” refers to any location where an agent provides support for subscriber services of the mFS platform. Funds are allocated by the agent administrator from the agent company's main account to each agent branch to fund the subscriber mFS functions such as depositing or withdrawing cash, in-store purchases, bill payments, prepaid airtime top-ups and money transfers. In some cases, multiple agents may work in a single branch. However, at least in some cases, monetary funds are allocated to from the agent company's main account on a per branch basis.

The term “agent branch account balance” refers to the amount of money residing in a particular agent branch account at a given time. Funds can be deposited into the branch account by the agent administrator, or the funds can come from participating in subscriber mFS transactions such as depositing or withdrawing cash from the subscriber's mobile wallet accounts, or making retail purchases with the mobile wallet.

Each agent branch is to maintain a balance in their branch account. This applies more strongly in countries where mFS program and financial services infrastructure is still developing. In cases where real-time processing of financial transactions including card processing is not practical, subscribers leverage the applications on their mobile phones to submit transactions and conduct business with retailers, businesses, and other subscribers. The mFS platform manages the balance of mobile wallet accounts for each subscriber as value is transferred from one mobile wallet to another (e.g. from a subscriber's mobile wallet to an agent's mobile wallet in payment for goods or services). This value is referred to herein as “eMoney”.

As subscribers conduct business with mFS agents, they deposit or withdraw cash from their mobile wallet accounts. Virtual or eMoney credits are transferred between the subscriber's mobile wallet account and the agent branch's account as a form of currency to support the transaction. As agents accept cash into their cash register by mFS subscribers, they transfer the equivalent amount of eMoney credits into the mFS subscriber's mobile wallet account. For instance, if an mFS subscriber gives an mFS agent $10 to deposit into the subscriber's mobile wallet account, the agent would place the cash into his register and transfer $10 from the agent branch's eMoney account into the subscriber's mobile wallet account. While the agent acquired $10 in his register, he transferred out $10 of eMoney credits from his branch eMoney account.

In some embodiments, in countries with more developed economies, it may be beneficial to use program-issued pre-paid debit cards, pre-paid access accounts, stored value accounts or gift cards to conduct business along with the added convenience of card processing networks such as Cirrus, STAR, or Visa for POS and automated teller machine (ATM) functionality. Agents, particularly those in retail outlets and kiosks, can still support subscribers with deposits, withdrawals, and other transfers, but in this case bank external card processors manage the mobile wallet and branch account balances and provide the real-time transfer of funds.

The term “agent branch ledger” refers to a written (or electronic) ledger maintained by the mFS platform. Agent branch transactions are performed on the agent's and subscriber's mobile phones where an electronic record of the transaction is generated and stored on the mFS platform. These electronic transactions are then reconciled with agent branch ledgers to ensure the security and integrity of the transaction. Agent branch ledgers are printed or electronic transaction logs that are distributed to the agent branch locations in hard copy form to serve as a backup record to the electronic transactions.

The term “agent company” refers to a business that registers to participate in the mFS program as a partner of the mFS program provider or owner. The agent company has one or more agent branches which conduct mFS business with mFS program subscribers. In some cases, the agent company may be referred to as a distributor or retailer.

The term “agent company account balance” refers to the sum of the funds deposited at a “partner bank” (defined below) by the agent company to fund the agent company's daily transactions. The funds in the agent company account are then distributed to agent branches by the agent company's agent administrator to conduct everyday business such as accepting cash deposits and cash withdrawals from mFS subscribers. This balance is sometimes referred to as the “agent company float”.

An “agent manager” is a supervisor of company agents for a given company. The agent manager has the training and tools to create, delete or modify agent accounts for a company, as well as monitor the transactions performed by agents. The agent manager may have a special application or an increased level of rights to access applications features not available to other users. The special application is a program installed on the agent manager's terminal. This application provides the agent manager the ability to securely perform agent manager functions such as registering and activating new agent accounts.

The mFS agent manager application may be installed on any terminal or device. It communicates with the mFS platform using binary and/or text SMS messages. A wireless service provider or MNO provides the GSM SMS network infrastructure on which the mFS platform operates. The mFS platform mobile wallet applications may utilize 3DES encryption (or any other type of encryption), encrypted message signing, and password security on some or all of its communications with the mFS platform in order to ensure that the transactions are properly secured and authenticated.

The term “agent application” refers to an application that provides all the tools necessary for an agent to register, activate, and offer other services to the mFS subscriber. The agent application is a program installed on the agent's SIM card or otherwise installed in the agent's mobile device's memory. This application provides the agent the ability to securely perform agent functions such as registering and activating new subscribers and depositing and withdrawing funds from mobile wallet accounts. The mFS agent application may be installed on a GSM SIM card or mobile phone and may be accessed using a GSM or CDMA mobile phone. A wireless service provider or MNO provides the data and SMS network infrastructure on which the mFS platform operates.

The terms “mFS platform”, “mobile wallet platform” and “monetary transaction system” refer to an overall platform or ecosystem of different components that work together to provide the various functions described herein on a global scale. At least some of the various logic components include the following: the application. The “mobile wallet application” or “mFS application” manages the processing of incoming transactions regardless of their source. The application handles end-user authentication, transaction processing, subscriber profile management, and further manages interactions between the various platform components.

The mFS platform further includes a transaction processor. This component is used when the mFS application is implemented in a country where real-time processing of financial transactions is not practical (or not possible). The transaction processor manages the balance of mobile wallet accounts, agent accounts, and the accounts of any other program participant. The transaction processor handles balance inquiries, credits, debits, and transaction roll-backs.

The mFS platform further includes a rules engine that manages and applies the rules and policy that are defined for transactions as they are processed on the mFS platform. Rules impact transaction fees, limits, velocity limits, and commissions as well as program actor roles and permissions. Rules can be customized for each implementation. The mFS platform also includes an integration interface that manages the integration and interaction between external systems (i.e. external to the mFS platform) and the mFS platform. Connectivity to the wireless service provider's pre-paid airtime billing platform and the program partner bank, for example, are managed by the integration interface.

The mFS platform further includes a transaction database that stores the data that supports the mFS platform. This includes subscriber profiles and subscription data, transaction data and logs, and application configuration and run-time data, among other types of data. Another component of the mFS platform is a handset support service that interfaces with the wireless service provider's SMS network to allow communication between the mobile wallet applications and the back-office systems via SMS messaging or some other form of data transfer. Still further, another component of the mFS platform is a web component that provides a web interface to the mFS program participants that allows the subscriber to perform the same functions in the web interface that they would have available through their applications.

The term “bill pay company” refers to a business that signs-up to participate in the mFS transaction system. As a participant in the mFS transaction system, the company accepts payment from mFS mobile wallet accounts, either in the form of eMoney or through periodic settlements.

At least in some embodiments, financial transactions that take place in the mFS mobile wallet platform are funded through pre-paid mobile wallet accounts. Mobile wallet platform subscribers can deposit cash into their mobile wallet account through a process referred to herein as ‘cash-in’. The cash-in process is supported by mFS agents at agent branch locations. The agent accepts the cash from the subscriber and transfers the equivalent amount of eMoney to the subscriber's mobile wallet account. This process is similar to withdrawing cash from a bank account.

As mentioned above, in some embodiments, financial transactions that take place in the mobile wallet platform are funded through pre-paid mobile wallet accounts. Mobile wallet platform subscribers can withdraw cash from their mobile wallet account through a process known as “cash-out”. The cash-out process is supported by mFS agents at agent branch locations. The subscriber transfers eMoney from their mobile wallet account to the agent's eMoney account. Upon receiving the eMoney, the agent gives the subscriber cash from their branch cash register.

Accounts managed on the mFS platform by the mFS eMoney transaction processor maintain the mobile wallet balance of mFS program participants including subscribers, agent branches, agent companies, and non-agent companies. eMoney is moved between Mobile Wallet accounts by the transaction processor based on mFS transaction processing. Only when transactions involving cash (i.e. depositing or withdrawing funds from the mFS program) or the movement of money from mFS participants to non-mFS program participants are funds moved from the master bank accounts.

As subscribers, agents, and other mFS program participants conduct business in the mFS program, value is transferred from one account to the next as payment for services rendered or goods purchased. This value can be in the form of real currency or the electronic representation referred to herein as eMoney.

Among other situations, eMoney is used in mFS implementations where the real-time processing of financial transactions including card processing is not practical. The mFS platform utilizes an internal transaction processor for managing the real-time balance of mobile wallet and agent accounts as value (eMoney) is transferred from one mobile wallet to another in payment for services.

As subscribers conduct business with mFS agents, they deposit or withdraw cash from their mobile wallet accounts. Virtual or eMoney credits are transferred between the subscriber mobile wallet accounts and the agent branch accounts as a form of currency to support the transaction. As agents accept cash into their cash register by mFS subscribers, they transfer the equivalent amount of eMoney credits into the mFS subscriber's mobile wallet account. For example, if an mFS subscriber gives an mFS agent $10 to deposit into the subscriber's mobile wallet account, the agent would place the cash into his or her register, and transfer $10 from the agent branch eMoney account into the subscriber's mobile wallet account. While the agent acquired $10 in his or her register, the agent transferred-out $10 of eMoney credits from his or her branch eMoney account. This will be explained in greater detail below.

In some embodiments, employers may wish to participate in the mFS program by allowing the direct deposit of paychecks into subscribers' mobile wallet accounts. Accordingly, each payday, the user's pay is directly transferred to the subscribers' mobile wallet.

The term “know your customer” or “KYC” refers to information collected about an individual that identifies that individual. Such information is used to establish a mobile wallet account with the mobile wallet platform. Regulatory requirements in some countries require that new bank account creation must be preceded by a display of a valid government ID. These KYC regulations may vary from country to country. Accordingly, different KYC information may be requested from subscribers in different countries in order to establish a mobile wallet account.

The term micro-finance institution (MFI) refers to a lender that issues small loans. MFls participating in the mFS program lend to mFS program subscribers and accept loan repayment either in the form of eMoney or settlements with the mFS platform provider.

The term “mFS program”, like the term “mFS platform” refers to the ecosystem of companies, service providers, and subscribers that participate in providing mobile financial services to their customers. In some embodiments, there may be one mFS program implementation per country. Each program includes a program owner and operator, a program platform, a partner wireless services provider or MNO, and a partner bank.

The term “mFS program master account” refers to a bank account maintained by the mFS program partner bank to provide funds and float for the operation of the mFS platform. Depending on the type of mFS implementation, the master account can include sub-accounts for each of the agent branches and subscriber mobile wallets, giving the bank visibility into all transactions on a per-user basis. The mFS platform can also manage the balance of sub-accounts and interact with the bank's master account when funds need to be deposited or withdrawn from the account.

The term mobile network operator (MNO) refers to a provider of mobile phone service including basic voice, SMS, unstructured supplementary service data (USSD) and data service, and may also be referred to as a “wireless service provider”.

The term “mobile wallet” or “mobile wallet account” refers to a stored value account or prepaid access account (PPA) that allows the owner (or “subscriber”) to pay for goods and services on the mFS platform from his or her mobile wallet account. When the mFS eMoney transaction processor is used, the mobile wallet balance is maintained by the mFS platform and value is exchanged within the mFS program as eMoney. When the mFS platform is integrated to an external card processor, the mobile wallet utilizes funds from the subscriber's prepaid debit card and bank account to exchange value on the mFS platform.

The term “non-agent company” refers to a mFS program participant who accepts payments from mFS subscribers but does not provide the same services as mFS agent companies. Payment is accepted either in the form of eMoney or through periodic settlements with the mFS platform provider. Examples of non-agent companies include bill pay providers and micro-finance lenders.

The term “non-mFS subscribers” refers to unregistered users that participates in various use cases in the mFS program. Non-mFS subscribers can send money to or receive money from mFS subscribers through interaction with the mFS program agents or with international remittance providers.

The term “partner bank” refers to the primary bank participating in the mFS program. The partner bank is responsible for holding the mFS program master accounts that hold the funds for all mFS services and transactions. A “PIN” refers to a numeric password that may be required to perform a transaction via the mobile wallet application. A “transaction processor” refers to an application or service that manages the mFS program account balances. The transaction processor determines the amount of funds or eMoney is in a particular account at any given time, and manages account balances. Mobile transaction system requests to credit, debit, or view the balance of a particular mobile wallet or program account are handled by the transaction processor (in conjunction with other components of the mobile wallet platform).

The term “sub-accounts” refers to accounts that are maintained within the mFS platform or by an external card processor. A partner bank may elect to maintain a separate bank account for each subscriber and/or agent branch, or a single master account may be established that contains the funds for all of the subscriber mobile wallet and agent branch accounts (at least within a country or other geographical region). The balance of each individual user may be managed by the mFS transaction processor.

When using a master account, the bank is involved only in transactions that require the movement of funds external to the mFS program. For example, subscriber cash-in and cash-out transactions involve the addition and removal of cash from the mFS program and would consequently include a deposit or withdrawal from the master account. Retail purchases from participating mFS program retailers or the exchange of funds between mFS subscribers results in no net change in the mFS program balance and thus do not require involvement by the partner bank.

The term “subscriber” refers to a participant of the mFS mobile wallet platform. The subscriber maintains a mobile wallet balance and performs transactions using the mFS application. An “unbanked subscriber” is a subscriber that does not have (or does not have access to) a bank account or credit union account. The application or “mobile wallet application” provides mobile wallet functionality to the (unbanked) subscriber. The mobile wallet application is installed on a mobile device in the device's memory, on a SIM card (such as a GSM SIM card) or is otherwise accessible to the mobile device. The mobile wallet application provides the subscriber the ability to securely perform subscriber functions such as making retail purchases, paying bills, or transferring money to other mFS subscribers and non-subscribers. The mobile wallet application communicates with the mFS platform using binary and text SMS messages, among other forms of wireless communication. A wireless service provider or MNO provides the GSM network infrastructure on which the mFS platform operates.

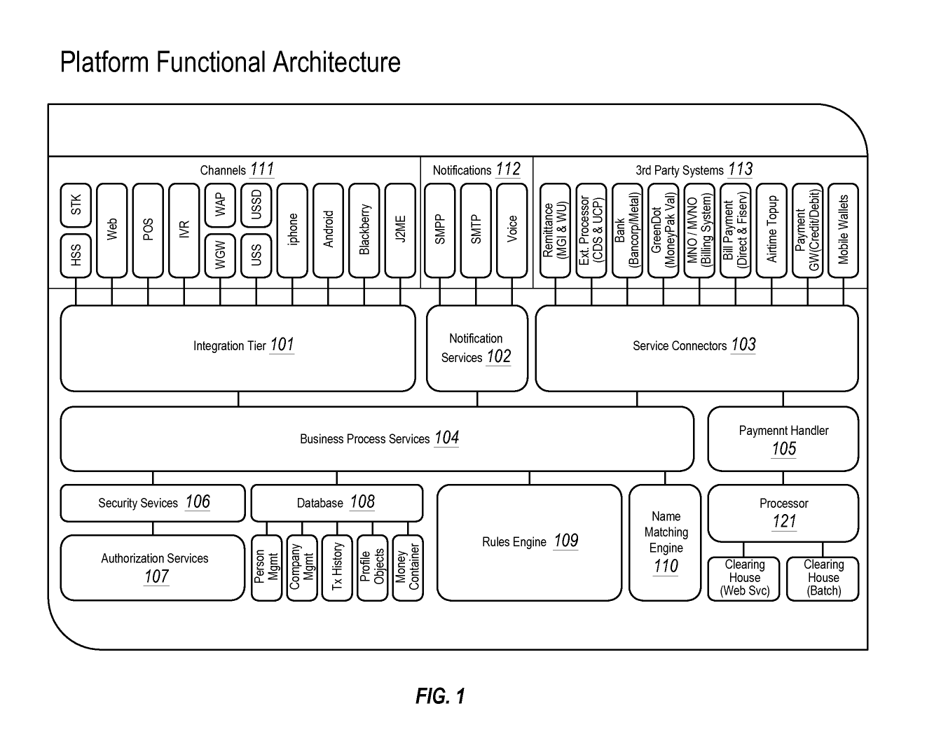

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors.

Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be use to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

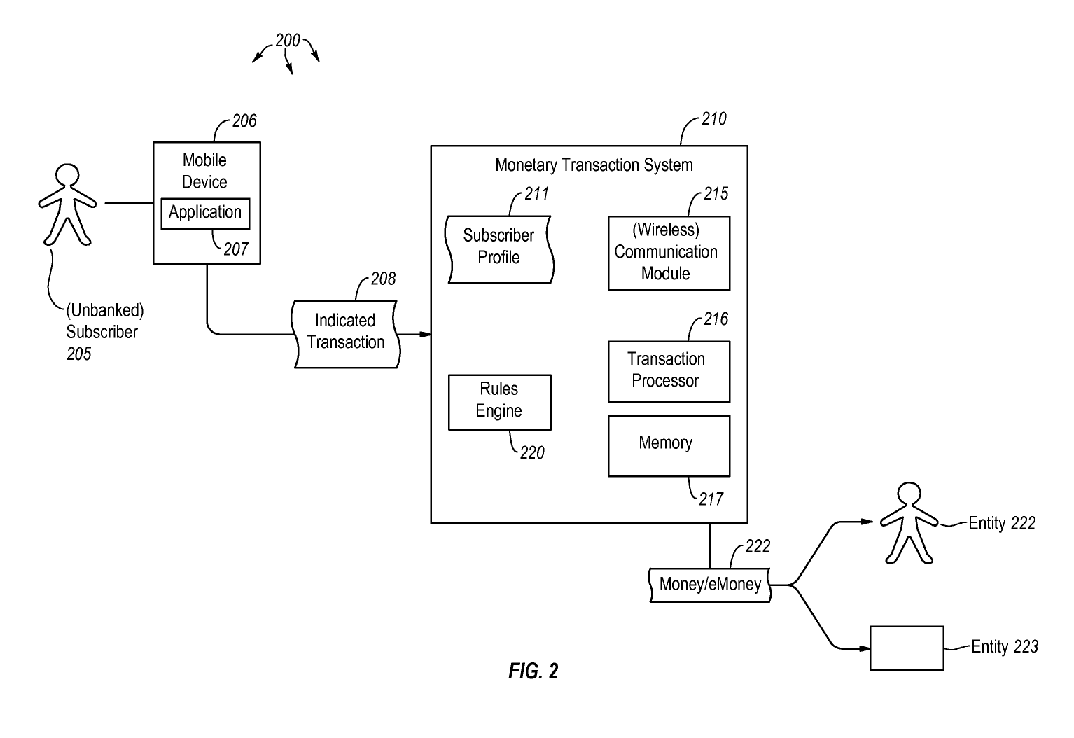

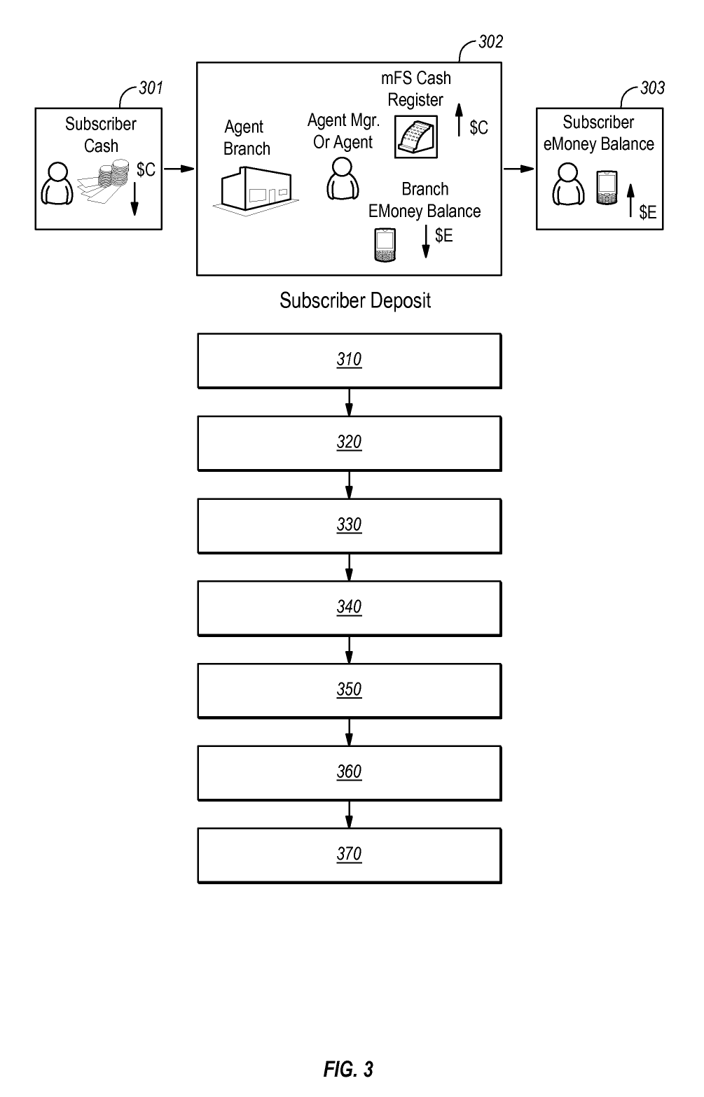

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below. These services will be described in greater detail below with regard to system FIGS. 1 and 2, as well as FIGS. 3-19B.

FIG. 2 depicts a monetary transaction system 200 similar to that described in FIG. 1. The monetary transaction system 200 may provide a more simplified system structure in which each of the above services may be provided. The system includes a subscriber 205. The subscriber may have access to a bank account, or may be an unbanked subscriber. The subscriber has a profile 211 with the monetary transaction system 210. The profile includes the subscriber's KYC information, as well as any associated bank accounts, credit union accounts, bill pay accounts or other accounts. The subscriber has (or has access to) a mobile device 206 such as a phone or tablet. The mobile device runs the mobile wallet application (or mobile wallet application) 207.

The subscriber can indicate, using the mobile application 207 which transaction or other action he or she would like to perform. The indicated transaction 208 is sent to the mobile wallet platform 210 to be carried out by the platform. The transaction processor 216 (which may be similar to or the same as transaction processor 121 of FIG. 1) performs the transaction(s) specified by the (unbanked) subscriber 205. The transaction processor may implement various other components to perform the transaction including memory 217, (wireless) communication module 215, rules engine 210 and/or transaction database 225.

Performing the specified transactions may include communicating with the monetary transaction database 225 to determine whether the transaction is permissible based on data indicated in the unbanked subscriber's profile (for instance, whether the subscriber has enough eMoney in his or her stored value account, or has enough money in his or her bank account). Rules engine 220 may also be consulted to determine whether the subscriber has exceeded a specified number of allowed transactions. Then, if funds are available, and the transaction is otherwise permissible, the monetary transaction system can transfer money or eMoney 221 to or from an entity such as a user or agent (e.g. entity 222) to or from an establishment such as a retail store or agent company (e.g. entity 223).

In some cases, the monetary transaction system 210 application provides a web interface that allows subscribers to perform the same functions provided by the monetary transaction system application. For instance, mobile wallet application 207 may provide a web interface that allows a user to enroll for a mobile wallet. The web interface (or the mobile wallet application itself) receives a subscriber-initiated transaction over one of a plurality of channels (111 from FIG. 1) connected to the monetary transaction system 210. The web interface or mobile wallet application may prompt for and receive enrollment information (e.g. KYC information) for the (unbanked) subscriber 205 over at least one of the plurality of channels (e.g. web, point-of-sale (POS), interactive voice response (IVR, etc.). The web interface or mobile wallet application may then send activation instructions over the same or a different channel to activate the (unbanked) subscriber 205 and create a subscriber account for the (unbanked) subscriber.

Once the subscriber has an account, the monetary transaction system generates a corresponding mobile wallet for the unbanked subscriber (available via the web interface and/or the mobile wallet application. The system then presents the (unbanked) subscriber's account data associated with the mobile wallet and/or a notification indicating that enrollment was successful to the subscriber. Accordingly, the mobile wallet application or the web interface may be used to provide user enrollment functionality. It should also be understood that either the mobile wallet application or the web interface may be used to provide substantially all of the mobile wallet functionality described herein.

It should also be noted that the mobile device 206 may be any type of plan-based phone or tablet, or prepaid phone or tablet. Many subscribers, such as unbanked subscribers, may primarily use prepaid phones. The mobile wallet application 207 may be installed on both plan-based phones and prepaid phones. The mobile wallet application may be installed on the device's SIM card, or on the device's main memory. Accordingly, the monetary transaction system 200 may be accessed and used via substantially any type of plan-based or prepaid mobile device.

FIG. 3 shows three different graphics (301-303) and corresponding method steps (310-370) that illustrate an unbanked subscriber making a deposit using a mobile wallet (and, by extension, using the mobile wallet transaction system 210). In at least some of the embodiments described below, the actions of each participant are shown and described. This will also, at least in some embodiments, include an illustration of money flow throughout the mobile wallet transaction system. In the graphics, various terms are used as follows: $C=Cash Balance and $E=Electronic Money (eMoney) Balance.

At graphic 301, it is assumed that the unbanked subscriber (e.g. 205) has already registered and activated an eMoney account at an agent branch location (e.g. a retail store, gas station, or other location that has registered to be an agent branch). To deposit cash in order to get eMoney credit, the subscriber informs the agent manager or agent that they want to deposit a certain amount of cash (in 301). The agent manager/agent takes the cash and notifies the mobile wallet transaction system of the deposit using their agent manager or agent application (302). The transaction system 210 then credits the subscriber's eMoney account (303). Accordingly, any location that has registered to accept eMoney payments from subscribers' mobile wallets can also accept cash deposits. The agent branch's eMoney balance is reduced because their actual money balance was increased by the amount of the deposit. The subscriber's mobile wallet account is credited with eMoney in the amount of the deposit. In this manner, a subscriber can deposit cash into their mobile wallet account (in the form of eMoney) at any retail location or other agent branch location.

Thus, the agent manager receives the physical cash deposit into the subscriber's eMoney account via the agent manager or agent's application. The subscriber gives cash to agent manager or agent, and the mFS platform processes the request, updates the agent branch and subscriber's eMoney balances, logs the transaction, and sends details (such as eMoney account balances, transaction logs, etc.) to bank specified by the mobile wallet platform. These details may be sent instantaneously as transactions occur, or in batches at pre-determined intervals.

In one embodiment, the monetary transaction system 210 of FIG. 2 is implemented to deposit funds at an agent branch using a mobile wallet. The monetary transaction system 210 receives communication from an agent branch over one of a plurality of channels (e.g. 111) connected to the monetary transaction system (step 310). The agent communication indicates that the unbanked subscriber 205 desires to deposit a specified amount of funds into the unbanked subscriber's mobile wallet account. The transaction processor 216 then validates the status of the unbanked subscriber's mobile wallet account (step 320) and determines if the agent branch is authorized to receive deposited money (i.e. determine if it has pre-registered as an official agent branch) (step 330).

The monetary transaction system may then use rules engine 220 to perform a limit check (to determine whether sufficient funds are available) and/or a velocity check (to determine whether the user has exceeded a specified number of (hourly, daily, or weekly) transactions) on the unbanked subscriber's mobile wallet account (step 340). The transaction system then credits the unbanked subscriber's mobile wallet account with the specified amount of funds (step 350) and returns a notification to the agent branch confirming the deposit (step 360) and returns another notification to the subscriber notifying the subscriber that the specified amount of funds was deposited in the their mobile wallet account (step 370). Any of channels 111 may be used to perform these communications.

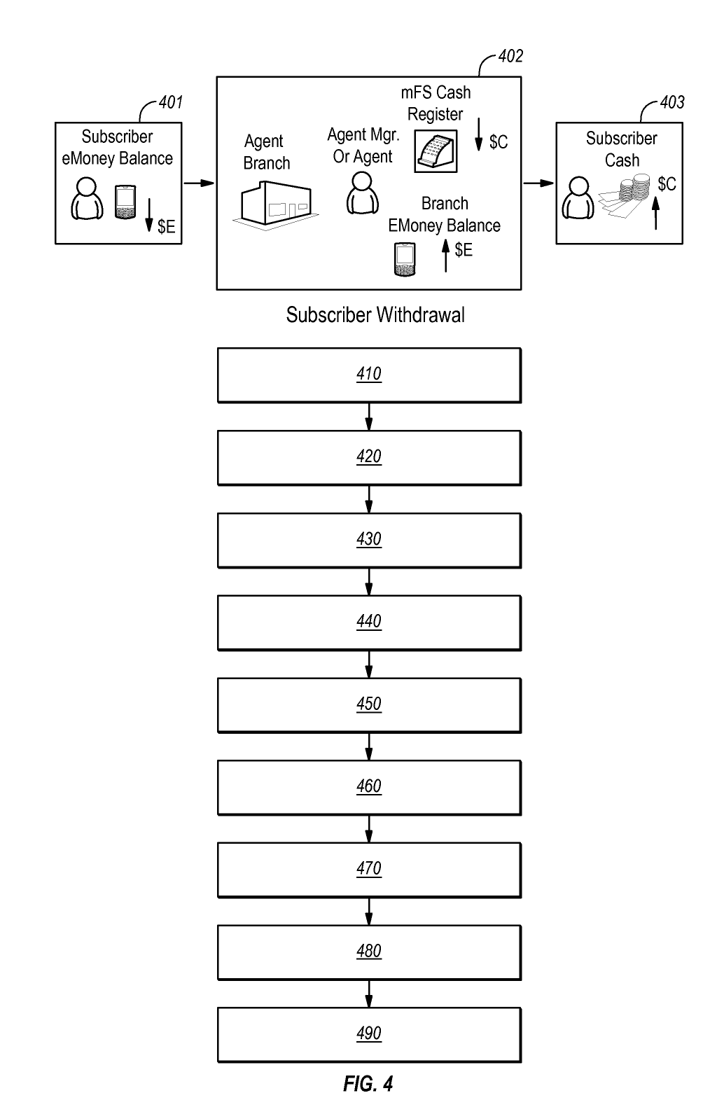

FIG. 4 shows three different graphics (401-403) and corresponding method steps (410-490) that illustrate an unbanked subscriber making a withdrawal using a mobile wallet (and, by extension, using the mobile wallet transaction system 210). As above, the terms in the graphics include “$C” representing cash balance and “$E” representing eMoney balance.

To withdraw cash at an agent branch, a subscriber submits a withdrawal request using their application (401). The subscriber may also enter information about the agent branch (e.g. name of establishment, name of agent, location or other information) that allows the monetary transaction system 210 to identify the agent branch. The transaction processor 216 may then determine whether the unbanked subscriber has enough eMoney to withdraw the requested amount. If he or she does have enough eMoney, then the subscriber's eMoney is deducted and that amount is transferred to the agent branch's eMoney account (402). Then, the agent branch gives the subscriber the requested amount of cash (403). In this manner, any entity that has established itself as an agent branch (including retail stores, gas stations, service providers, etc.) can provide cash withdrawal to a mobile wallet subscriber (whether banked or unbanked). The agent's or agent manager's role is to verify the withdrawal request (e.g. via SMS on the agent's or agent manager's phone) and gives the cash to subscriber. The subscriber requests cash withdrawal from agent branch's eMoney account via the application, and receives physical cash from agent manager/agent. The mobile wallet platform processes the request, updates the agent branch's and subscriber's eMoney balances, logs the transaction, and sends transaction details to a specified bank at pre-determined intervals.

In one embodiment, the monetary transaction system 210 is implemented to withdraw funds at an agent branch using a mobile wallet. The communication module 215 receives a communication from an unbanked subscriber over one of a plurality of channels 111 connected to the monetary transaction system 210 (step 410). The communication indicates that the unbanked subscriber 205 desires to withdraw a specified amount of funds from the unbanked subscriber's mobile wallet account at the agent branch. The monetary transaction system 210 validates the status of the unbanked subscriber's mobile wallet account (step 420) and determines if the balance of the unbanked subscriber's mobile wallet account is sufficient to accommodate the requested withdrawal for the specified amount of funds (step 430).

The transaction processor 216 performs one or more of a limit check (to verify sufficient funds) and a velocity check (to verify the subscriber hasn't exceeded specified transfer limits) on the unbanked subscriber's mobile wallet account (step 440). The monetary transaction system 210 then returns a secure, perishable withdrawal code to the subscriber 205 over at least one of the plurality of channels 111 connected to the monetary transaction system (step 450). The monetary transaction system 210 receives subsequent agent branch communication over at least one of the plurality of channels connected to the monetary transaction system indicating that the withdrawal code has been presented to the agent branch (step 460). The monetary transaction system 210 then debits the unbanked subscriber's mobile wallet account by the specified amount of funds (step 470), returns a notification to the agent branch confirming the withdrawal (step 480) and notifies the subscriber that the specified amount of funds was withdrawn from the unbanked subscriber's mobile wallet account over at least one of the channels 111 connected to the monetary transaction system (step 490). Accordingly, the monetary transaction system 210 may be used to allow subscribers to withdraw cash using their mobile wallet applications at any store or other entity registered as an agent branch.

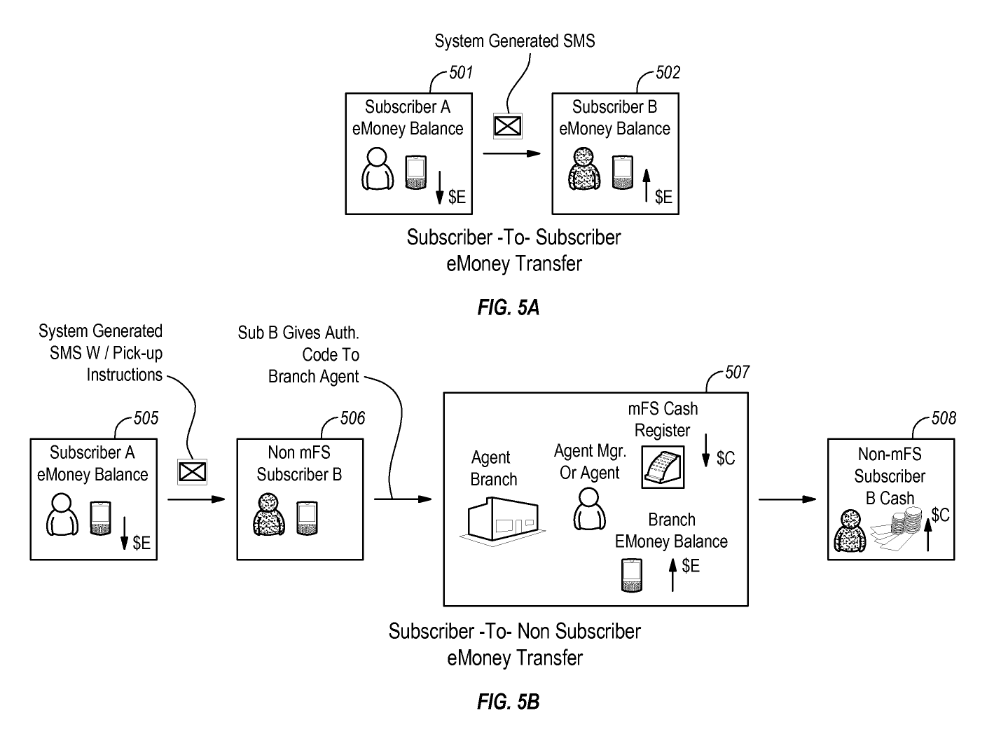

FIG. 5A depicts a subscriber-to-subscriber eMoney transfer. To perform such a transfer, subscriber A (501) enters some type of identification information identifying subscriber B (e.g. subscriber B's phone number) and an amount of money he or she wishes to transfer. The transaction processor 216 of the monetary transaction system 210 determines if there are sufficient funds to complete the transfer. If sufficient funds are available, the monetary transaction system 210 decrements subscriber A's account and credits subscriber B's account (502). The system then sends some kind of notification (e.g. SMS) to subscriber B indicating that a certain amount of money was transferred to their account. Subscriber A may also receive a notification that the transfer was successful. Accordingly, eMoney may be transferred between two mFS platform subscribers, one or both of which may be unbanked. The monetary transaction system 210 processes the subscribers' requests, updates the subscribers' eMoney balances, logs the transactions, and sends transaction information to a specified bank when needed.

FIG. 5B illustrates a subscriber-to-non-subscriber eMoney transfer. In graphic 505, subscriber A wishes to send eMoney to another individual that is not a subscriber to the mFS platform. The transaction is initiated in the same fashion as the subscriber-to-subscriber transfer scenario. However, since non-subscriber B does not have a mobile wallet account, the monetary transaction system 210 cannot credit them with eMoney. Instead, the monetary transaction system 210 sends a notification (e.g. via SMS) to non-subscriber B with instructions for how to pick-up the transferred money, along with an authorization code (506). The monetary transaction system 210 puts a hold on subscriber A's account for the amount transferred. Subscriber B then has a specified number of days to pick up the cash before the hold expires and the amount is credited back to subscriber A's eMoney account by the monetary transaction system 210.

When non-subscriber B goes to pick up the money at an agent branch, the agent branch's manager or agent verifies the authorization code via an agent manager or agent mobile wallet application (that, in turn, accesses the mFS platform). Once the transfer has been validated, the agent gives the cash to non-subscriber B. The agent branch's mFS account is credited with the transfer amount (507) and the user leaves with the cash in hand (508). The mFS platform processes the transfer request, updates subscriber A's eMoney balance, logs the transaction, and sends transaction details to a platform-specified bank.

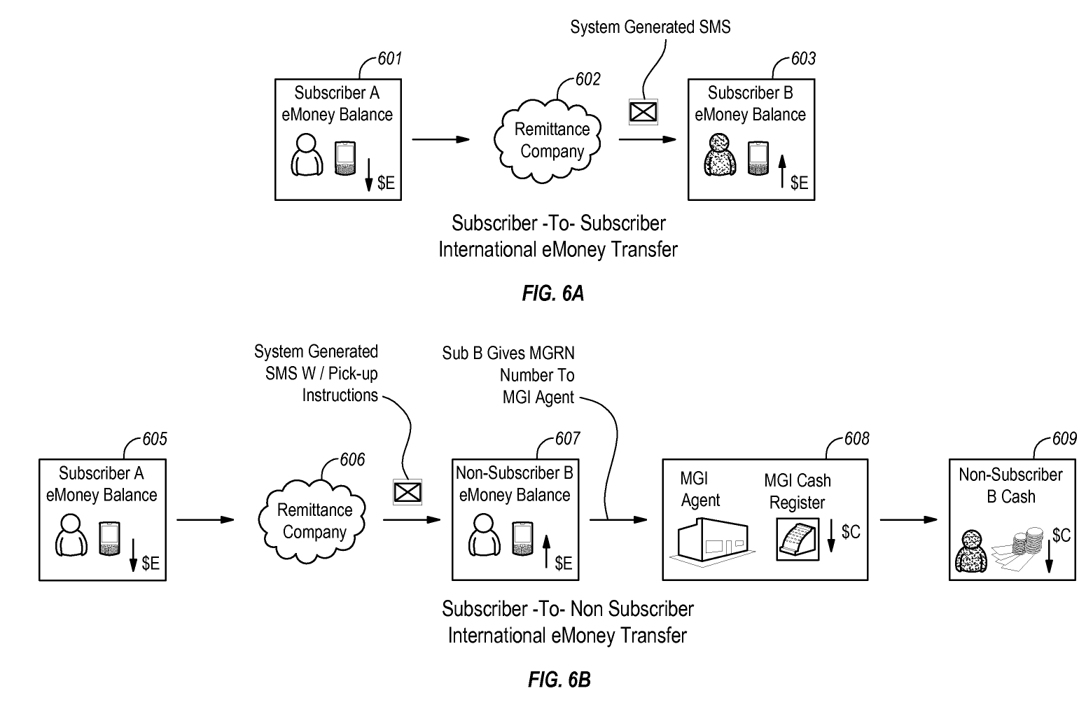

FIG. 6A illustrates a subscriber-to-subscriber international eMoney transfer. This embodiment is, at least in some respects, similar to sending eMoney to an mFS subscriber domestically. In this case the monetary transaction system 210 leverages one or more existing international money transfer organizations or “remittance companies” such as MoneyGram®. In some embodiments, MoneyGram® is pre-integrated to the monetary transaction system 210, but other international money transfer organizations may also be used. Still further, at least in some embodiments, subscriber B may need to have an eMoney account with a foreign mFS program that is also affiliated with MoneyGram® or another international money transfer organization.

In FIG. 6A, subscriber A initiates the international eMoney transfer at 601, the international money transfer organization (e.g. MoneyGram®) transfers the eMoney to subscriber B at 602 and subscriber B's eMoney balance is increased by the transferred amount. Thus, subscriber A requests to send eMoney from his or her eMoney account via the mobile wallet application. The eMoney is transferred using an international money transfer organization, and subscriber B receives a notification (that may, for example, include a reference number, among other information) that their eMoney balance has increased by the transfer amount. The monetary transfer system 210 processes subscriber A's request, updates subscriber A's and subscriber B's eMoney balances, logs the transaction, and send transaction details to a mFS platform-specified bank.

FIG. 6B illustrates a subscriber-to-non-subscriber international eMoney transfer. In this illustration, subscriber A wishes to send cash to subscriber B who is not an mFS program subscriber. Similar to the scenario described in FIG. 6A, the monetary transaction system 210 leverages various international money transfer organizations or remittance companies such as MoneyGram® to transfer the eMoney. Subscriber A initiates a typical eMoney transfer at 605 by providing non-subscriber B's identification information, as well as the amount to be transferred. The Monetary transaction system 210 recognizes the eMoney transfer is not destined for a domestic phone number and routes the request to the international money transfer organization (e.g. MoneyGram®) (606).

The international money transfer organization sends non-subscriber B a notification (e.g. via SMS) with instructions for how and where to pick up the money (in embodiments where MoneyGram® transfers the eMoney, the notification may include a MoneyGram® reference number (MGRN)) (607). Non-subscriber B can then show the MGRN to an agent at an agent branch (608) and then receive the cash (609). The monetary transaction system 210 then decrements subscriber A's eMoney account for the transferred amount. The monetary transfer system 210 thus processes subscriber A's transfer request, updates subscriber A's eMoney balance, logs the transaction, and sends transaction detail to a platform-specified bank. It should also be noted that an mFS subscriber may also receive money in a foreign country from either a subscriber or a non-subscriber in a similar manner.

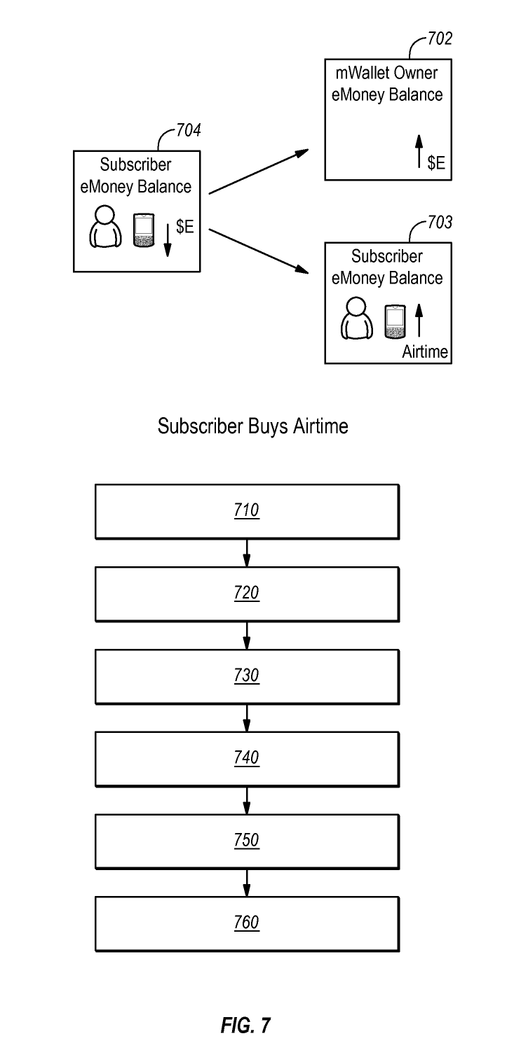

FIG. 7 illustrates a subscriber purchasing airtime using a mobile wallet. Mobile wallet platform subscribers may buy airtime by using their mobile wallet application 207. The monetary transaction system 210 will reload their airtime account within the mobile network operator's (MNO's) systems. The subscriber requests to purchase airtime by entering the request via the mobile wallet application or via a mobile wallet web interface. The monetary transaction system 210 then decrements the subscriber's eMoney account (701), while crediting the mFS platform's eMoney account (702). The purchased airtime is then added to the subscriber's airtime balance (703). The monetary transaction system 210 processes the subscriber's request, updates the subscriber's eMoney balances as well as its own eMoney balance, logs the transaction, and sends transaction detail to a mFS platform-specified bank.

In one embodiment, the monetary transaction system 210 is implemented to top up a prepaid mobile account from a mobile wallet. The communication module 215 of the monetary transaction system 210 receives a subscriber communication over one of a plurality of channels 111 connected to the monetary transaction system (step 710). The subscriber communication indicates that an unbanked subscriber 205 desires to top up a prepaid mobile account by a specified amount using a specified payment method from the unbanked subscriber's mobile wallet. The transaction processor 216 validates the status of the selected payment method (step 720) and performs a limit check and/or a velocity check on the selected payment method (step 730). The monetary transaction system 210 then debits the specified payment method by the specified amount of funds (step 740) and processes the mobile top-up via a billing system integrator and/or an aggregator (step 750), and notifies the subscriber that the prepaid mobile account was topped up over at least one of the channels connected to the monetary transaction system (step 760).

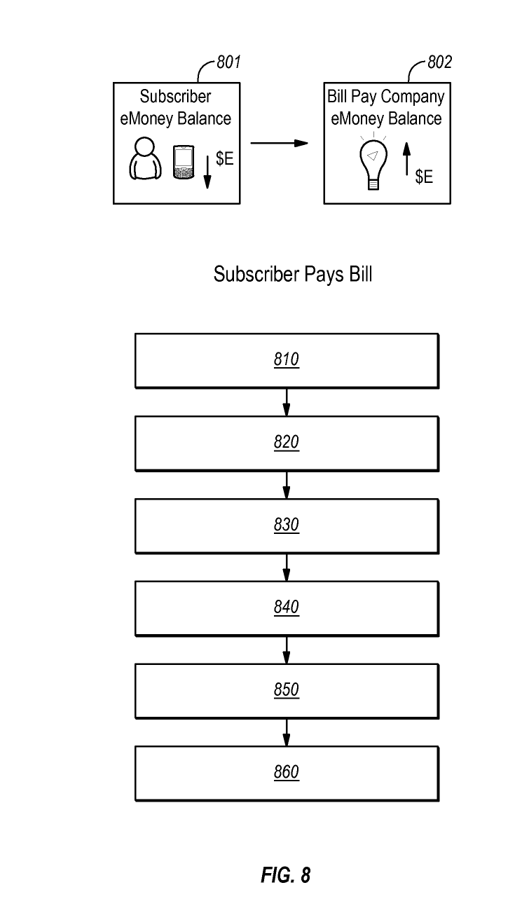

FIG. 8 illustrates an embodiment where a mFS subscriber pays a bill using a mobile wallet. At least in some embodiments, the company that the subscriber wishes to pay needs to have signed-up to be part of the mFS platform. The mFS platform may publish a list of company names that have registered to be part of the mFS platform. This list of companies may include company IDs so that subscribers can know which company ID to enter in their mobile wallet application. Once the company ID is known, the subscriber can pay a bill by entering the company ID and the amount to be paid. The monetary transaction system 210 then decrements the subscriber's eMoney account (801) and credits the identified company's eMoney account (802). Accordingly, in response to the subscriber's request to pay bill via their mobile wallet application, the monetary transaction system 210 processes the request, updates the bill pay company's and the subscriber's eMoney balances, logs the transaction, and sends transaction details to the mFS platform-specified bank.

In one embodiment, the monetary transaction system 210 is implemented to pay a bill from a mobile wallet. The communications module 215 of the monetary transaction system 215 receives a subscriber communication over a communication channel 111 connected to the monetary transaction system (step 810). The subscriber communication indicates that unbanked subscriber 205 desires to pay a bill for a specified amount using a specified payment method from the unbanked subscriber's mobile wallet (e.g. eMoney). The monetary transaction system 210 validates the status of the selected payment method (step 820) and performs a limit check and/or a velocity check on the selected payment method to ensure the eMoney transfer is permissible (step 830). The monetary transaction system then debits the specified payment method by the specified amount of funds (step 840), processes the bill payment via a direct biller connection or a bill pay aggregator (step 850), and notifies the unbanked subscriber that the bill was paid using a communication channel (e.g. SMS) connected to the monetary transaction system (step 860). Thus, in this manner, a subscriber may use a mobile wallet to pay various bills including rent, utility, mortgage, phone, cable, medical and other bills.

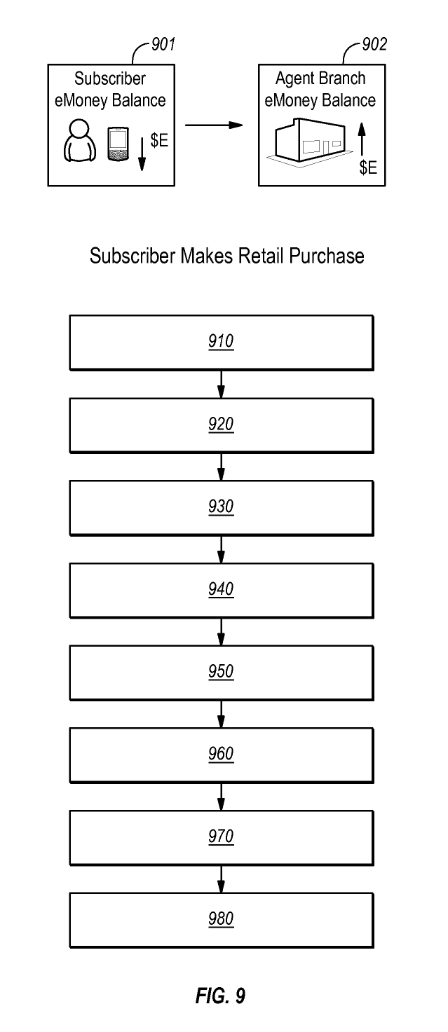

FIG. 9 illustrates a mobile wallet subscriber making a retail purchase. Mobile wallet subscribers can make retail purchases at agent branches directly from their mobile device. Agent branches, as explained above, are retail stores or other entities that have registered with the mFS system and are able to accept mobile wallet payments. Accordingly, a subscriber can select the items they wish to purchase, and indicate (via the mobile wallet application) to the agent branch that they wish to pay for the items. The mobile wallet application then communicates with the agent branch and the monetary transaction system to indicate the price of the transaction. The monetary transaction system 210 then debits the subscriber's eMoney account (901) and credits the agent branch's eMoney account (902). The agent branch (and/or the agent manager or agent) receives confirmation that subscriber paid for the purchase. The subscriber may also receive a summary of the retail purchase and may be asked to confirm the purchase by entering a PIN. The monetary transaction system processes the purchase request, updates the agent branch and subscriber's eMoney balances, logs the transaction, and sends transaction details to a mFS platform-specified bank.

In one embodiment, the monetary transaction system 210 is implemented to make a purchase from a mobile wallet. The communications module 215 of the monetary transaction system 210 receives a communication from a subscriber over a communication channels 111 (step 910). The subscriber communication indicates that an unbanked subscriber 205 desires to purchase an item for a specified amount of funds using a specified payment method from the unbanked subscriber's mobile wallet.

The monetary transaction system 210 then returns a secure, perishable purchase code to the unbanked subscriber over at least one of the channels connected to the monetary transaction system (step 920) and receives a subsequent agent branch communication over a channel indicating that the purchase code has been presented to an agent (branch) (step 930). The monetary transaction system 210 validates the status of the specified payment method (step 940), determines if the specified payment method can accommodate a purchase for the specified amount (step 950), performs a limit check and/or a velocity check on the selected payment method (960), debits the specified payment method by the specified amount of funds (970), returns a notification to the agent branch authorizing the purchase (980) and sends a receipt to the unbanked subscriber over a communication channel. The monetary transaction system 210 may thus be used to make a retail purchase using a mobile wallet.

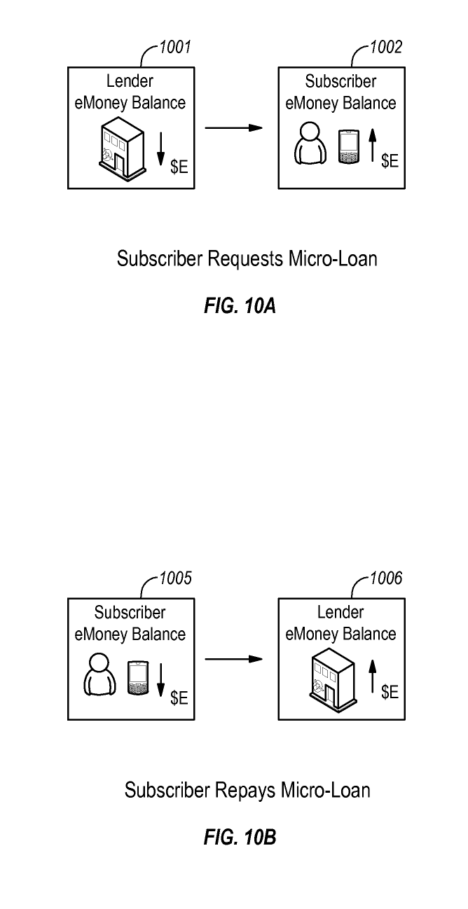

FIG. 10A illustrates a subscriber requesting a micro-loan. Financial institutions and potentially other mFS program participants may sign up to become money or eMoney lenders. Mobile wallet subscribers may be able to use their mobile wallets to request micro-loans from these approved lenders. The micro-loans are tracked by the monetary transaction system 210, and repayment reminders, interest and commissions are managed by the monetary transaction system. The subscriber requests a micro-loan from a lender, indicating the amount in the request, as well as other information such as the repayment date and the commission (i.e. interest rate). Potential lenders then have a chance to counter the loan request with their own terms. Once the lender approves the subscriber's request, the lender's eMoney account balance is debited for the specified amount (1001) and the subscriber's eMoney account is credited with the requested amount (1002). The monetary transaction system 210 processes the micro-loan requests, update the lender and subscriber's eMoney balances, sets up repayment schedules and reminders, logs the transaction, and sends transaction detail to a mFS bank. It should also be noted that while the term “micro-loan” is used herein, the loan may be for substantially any amount of money.

Following on the embodiment described in FIG. 10A, FIG. 10B illustrates a subscriber repaying a micro-loan. The subscriber may repay the loan using functionality provided in the mobile wallet application or in a similar web interface. Repayments can be made in installments or in full depending on the rules of the micro-loan. The subscriber enters the amount they wish to repay and the loan ID. The subscriber's eMoney account is then debited for the specified amount (1005), while the lender's eMoney account is credited the specified amount (1006). Both the lender and the subscriber may receive confirmation that the loan has been repaid via SMS or some other communication channel. The mFS platform thus processes the subscriber's micro-loan repayment request, updates lender and subscriber's eMoney balances, updates repayment schedule and reminders, logs the transaction, and sends transaction details to a specified mFS platform bank.

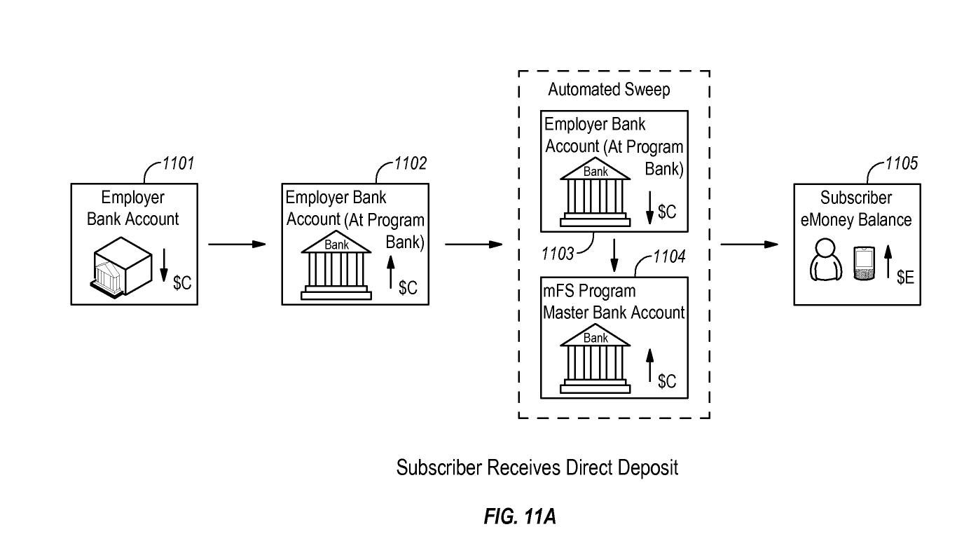

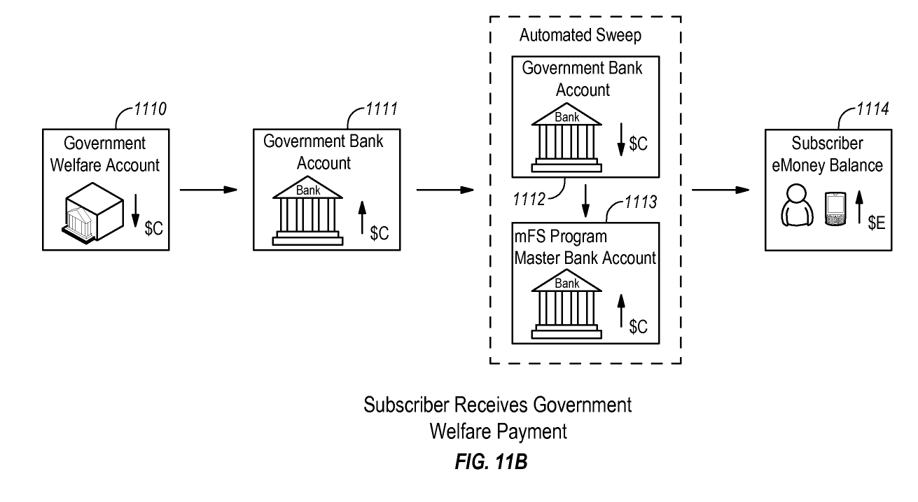

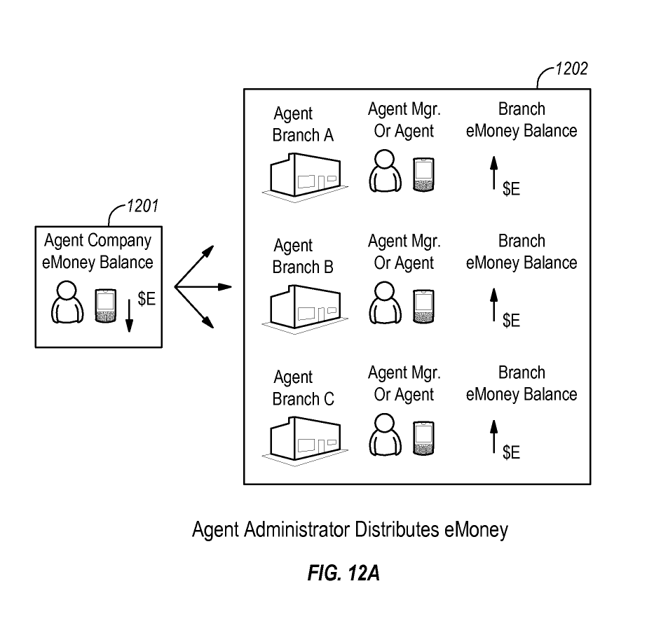

FIG. 11A illustrates a subscriber receiving a direct deposit from an employer or other entity. Subscribers to the mFS platform have the ability to receive any direct deposit into their eMoney account. Subscribers may be asked by their employers to provide account information in order to set up direct deposit. The employer then submits a direct deposit request using their existing processes (i.e the processes they use for a normal checking or savings bank account). Once the direct deposit is set up and a payday arrives, the employer's bank account is debited for the proper amount (1101) and the employer's mFS account is credited with that amount (1102). Then, once the funds have been received at the mFS platform bank, the mFS platform bank sweeps the employers direct deposit balance (1103) into a mFS platform master account (1104) and notifies the mFS platform of each account to be incremented (including the subscriber's mobile wallet (eMoney) account). The subscriber's eMoney account is then credited with the paycheck amount (1105) upon which the eMoney may be used to pay for goods, pay bills, top up airtime, transfer to other entities or for cash withdrawal.

The subscriber does not need to have a bank account to participate in direct deposit. The employer's bank can communicate with the mFS platform's bank to perform the necessary steps in directly depositing the subscriber's paycheck in his or her eMoney mobile wallet account. The bank facilitates monetary deposit into the employer's bank account for direct deposit and performs an automated sweep of recent deposits from the employer's bank account into the mFS platform's master bank account. The bank also sends transaction details to the monetary transaction system 210 including transaction logs. The monetary transaction system receives a list of eMoney accounts that are to be credited directly from the employer (or bank), processes the list and requests to establish a direct deposit, updates subscriber's eMoney balance, log the transaction, and sends transaction details to the mFS platform bank.

In a similar manner, a subscriber may receive a government welfare payment directly on their mobile device. FIG. 11B illustrates a subscriber receiving a government social welfare payment directly into their eMoney account. In some embodiments, subscribers may need to opt-in and register with the government program for which they choose to receive the payment via their mobile wallet. Once the funds have been received, the subscriber can use that eMoney for any goods or services, as described above. Once the direct deposit has been established and a payout has been initiated, the government's welfare account deposits the money (1110) into the government's bank account for welfare payments (1111) and performs an automated sweep of recent deposits from the government's bank account (1112) into the mFS program's master bank account (1113). The bank then sends transaction details to the monetary transaction system 210 regarding the deposit. The subscriber receives a notification that the welfare payment has been credited to their eMoney account (1114). The mFS platform receives an indication of eMoney accounts that are to be credited from the government, processes the welfare payments, updates the subscriber's eMoney balance, logs the transactions, and sends transaction details to the mFS platform bank.

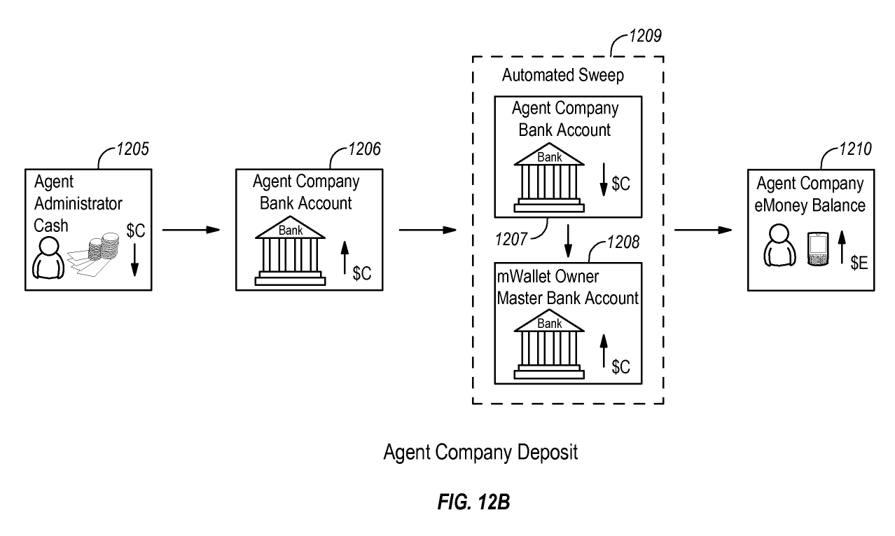

FIG. 12A illustrates an agent administrator distributing eMoney to various recipients. An agent administrator, as explained above, is a person who acts as an agent company's representative. The agent administrator deposits, withdraws, and distributes funds into and out of the agent company's bank account. When an agent administrator deposits cash into an agent company's bank account, it is credited as eMoney to the agent company's account. In order to provide the agent branches with eMoney, the agent administrator first moves the eMoney from the agent company's account (1201) to the branch accounts (1202). This is performed using the agent administrator's mobile wallet application or portal. In an agent administrator money transfer, the monetary transaction system 210 processes the administrator's eMoney transfer request, updates the agent company and agent branch eMoney balances, logs the transaction, and sends transaction details to the mFS platform bank.

FIG. 12B illustrates an agent company deposit. The agent company has an eMoney account in the monetary transaction system 210 that may also include a corresponding bank account (that may be created automatically upon creation of the agent company's eMoney account). After the agent company's bank account has been set up, the agent administrator can make deposits into that account. As FIG. 12B shows, once cash (1205) has been deposited into the bank account (1206), it is transferred to a mFS platform master account (1208) that includes all or a part of the mFS platform's funds. The agent company's bank account is decreased by the deposit amount (1207), while the agent company's eMoney account balance is correspondingly increased (1210). At this time, the agent company account is credited with eMoney. The agent company's bank facilitates a physical cash deposit into the agent company's bank account and performs an automated sweep (1209) of recent deposits from the agent company's bank account into the mFS platform's master bank account. The agent company's bank then sends transaction details to the monetary transaction system 210. The agent administrator physically delivers the cash (or form of money such as a check or money order) to a bank branch for deposit. The monetary transfer system receives transaction details from the agent company's bank about recent transactions (including deposits, as shown in FIG. 12B.

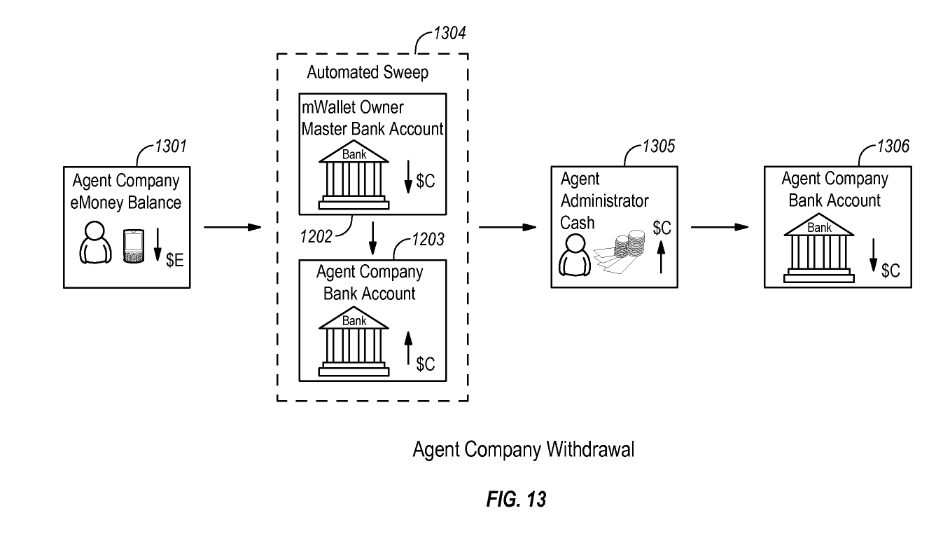

FIG. 13 illustrates an agent company withdrawal. To make a cash withdrawal for an agent company, the agent administrator requests a withdrawal using the agent administrator mobile wallet application. The monetary transaction system 210 then notifies the bank that a certain amount of eMoney is to be transferred from the master mFS account (1302) to the agent company bank account (1303). When the money is in the agent company bank account, the agent administrator can withdraw the cash by traditional withdrawal means. The mFS master bank receives transaction details from the monetary transaction system 210 about recent transactions (recent withdrawals in this case). The mFS master bank performs an automated sweep (1304) of the mFS platform's master bank account to reflect the recent withdrawal request from agent the agent company (1301). The agent company's eMoney account is reduced by the amount of the withdrawal. The agent company also sends transaction details to the monetary transaction system 210. The agent administrator can request withdrawal via the agent administrator mobile wallet application and physically withdrawal cash (1305) from the agent company's bank branch (1306). The mFS platform processes the agent company's withdrawal request, updates agent company and agent branch eMoney balances, logs the transaction, and sends transaction details to an mFS platform-specified bank.

Attention will now be turned to embodiments in which subscribers have bank accounts associated with their mobile wallets. The monetary transaction system 210 provides similar functionality to consumers that have bank or credit union accounts. Although many different transactions are presented herein, many more and varied types of transactions may be processed by the monetary transaction system. In the following figures, “$C” refers to cash balance, “$DC” refers to a debit card (prepaid) balance and “$PIN” refers to a recharge PIN value.

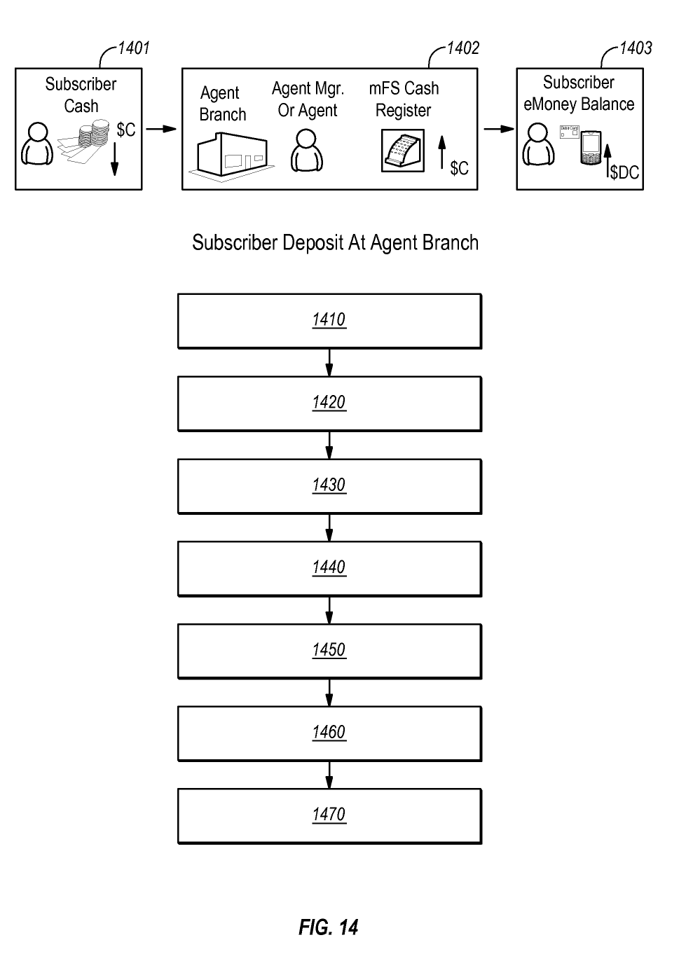

FIG. 14 describes a subscriber deposit at an agent branch. The subscriber has a registered and activated (prepaid) debit card at an agent branch location. The prepaid debit card is associated with the mobile wallet application in the subscriber's mobile device. As such, the debit card is linked to the subscriber's account in the monetary transaction system 210. To deposit cash onto the mobile wallet, the subscriber informs the agent that they want to deposit a specified amount of cash (1401). The agent takes the cash and notifies the monetary transaction system 210 of the deposit using their point of sale (POS) system or the agent mobile wallet application (1402), and the monetary transaction system 210 credits the subscriber's mobile wallet account (1403). The funds collected at the cash register typically do not reach a bank account until the reconciliation and settlement of funds occurs between the agent and the mFS owner's bank.

The subscriber's bank then receives a settlement report from the card processor and receives funds from the agent's bank. The agent or agent manager physically deposits the cash into the subscriber's mobile wallet account via their POS system or agent manager/agent mobile wallet application. The monetary transaction system processes the deposit request, increments the subscriber's mobile wallet balance within the card processor and logs the transaction. An external card processor increments the subscriber's mobile wallet balance and sends reports to the bank for settlement on a regular (e.g. nightly) basis.

In one embodiment, the monetary transaction system 210 is implemented to deposit funds into a bank or credit union account using a mobile wallet. The communications module 215 of the monetary transaction system 210 receives communication from an agent branch over a communication channel (step 1410). The agent communication indicates that a subscriber 205 desires to deposit a specified amount of funds into a bank or credit union account. The transaction processor 216 validates the status of the bank or credit union account (step 1420), determines if the agent branch is authorized to deposit money (step 1430), and performs a limit check and/or a velocity check on the bank or credit union account (step 1440). The monetary transaction system then credits the bank or credit union account with the specified amount of funds (step 1450), returns a notification to the agent branch confirming the deposit (step 1460) and notifies the subscriber that the specified amount of funds was deposited in the bank or credit union account using at least one of the communication channels connected to the monetary transaction system (step 1470). Accordingly, cash may be deposited into a bank or credit union account associated with a subscriber's mobile wallet.

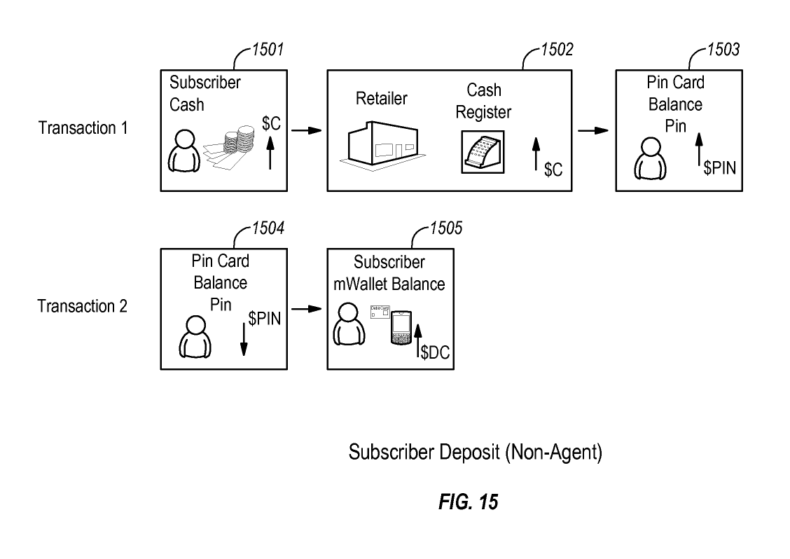

FIG. 15 illustrates a subscriber deposit that is performed with a non-agent. In some economies, subscribers may have the ability to leverage other channels outside of agents to deposit funds onto their card. One deposit method is a PIN-based recharge that allows a subscriber to purchase a PIN worth the deposit value. The PIN can then be redeemed via an interactive voice response (IVR) system or via the subscriber's mobile wallet application. The mobile wallet application will allow the monetary transaction system 210 to deposit the funds onto the subscriber's card. The retailer's bank settles with the PIN card provider's bank and the PIN card provider's bank settles with the mFS platform's bank for the deposit. The subscriber gives cash to the agent (1501) which increases the agent company's physical cash (1502). The subscriber uses IVR or their SIM Application to recharge mobile wallet account using a PIN card (1503). In some cases, an agent may provide the PIN card (i.e. the prepaid debit card) to the subscriber. The monetary transaction system 210 processes the subscriber deposit request, increments the subscriber's mobile wallet balance within the card processor and logs the transaction. An external card processor decreases the subscriber's PIN card balance (1504), increments the subscriber's mobile wallet balance (1505) and send reports to the mFS platform bank for settlement.

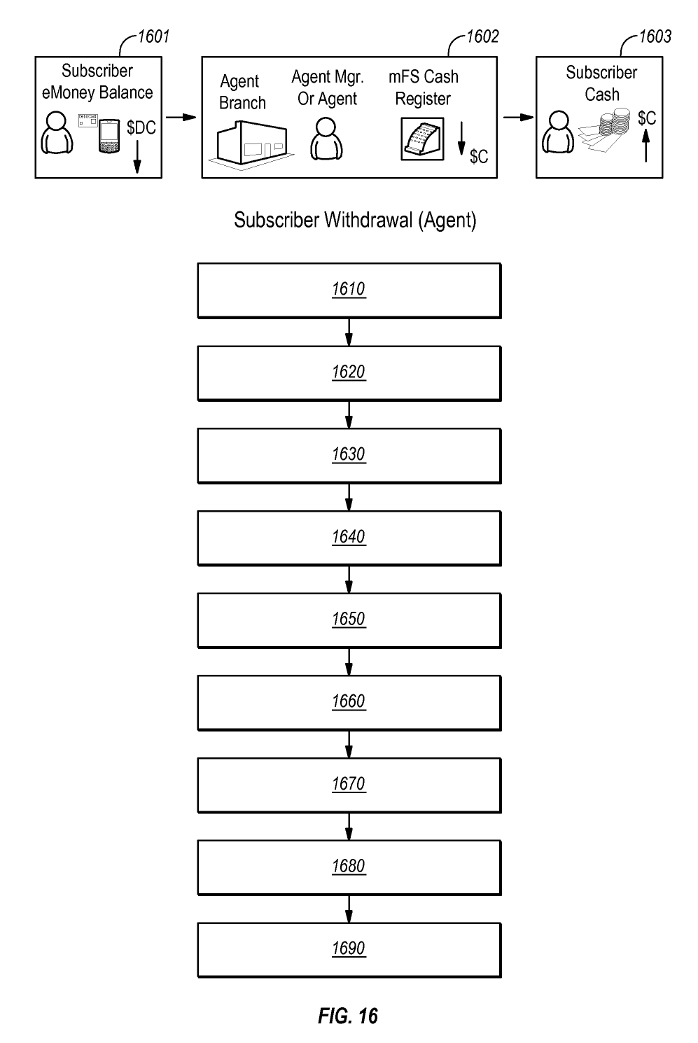

FIG. 16 illustrates a subscriber withdrawal at an agent branch. To withdraw cash at an agent branch from a (prepaid) debit card, a subscriber submits a withdrawal request using the mobile wallet application on their mobile device. The subscriber may also need to enter details about the agent branch that allows the monetary transaction system 210 to determine if the subscriber has sufficient funds on their debit card. The mFS platform then notifies the agent branch that it can give cash to the subscriber. If the subscriber has sufficient funds, the monetary transaction system 210 will decrement the subscriber's funds from their card (1601) and transfer it to the mobile wallet owner's account within the same card processor or bank. The agent branch (1602) then provides the withdrawn cash to the subscriber (1603).

Accordingly, the subscriber requests a cash withdrawal from their own mobile wallet account via the mobile wallet application. The agent or agent manager verifies the withdrawal request via POS authorization or SMS received on agent's phone and, once verified, gives cash to the subscriber. The monetary transaction system 210 processes the subscriber's withdrawal request, decrements the subscriber's mobile wallet balance within the card processor and logs the transaction. An external card processor decrements the subscriber's mobile wallet balance and sends reports to the bank for settlement on a periodic basis.

In one embodiment, the monetary transaction system 210 is implemented to withdraw funds from a bank or credit union account using a mobile wallet. The communication module 215 of the monetary transaction system 210 receives a communication from a subscriber 205 over a communication channel 111 (step 1610). The subscriber communication indicates that subscriber 205 desires to withdraw a specified amount of funds from a bank or credit union account. The transaction processor validates the status of the bank or credit union account (step 1620), determines if the balance of the bank or credit union account is sufficient to accommodate the requested withdrawal for the specified amount of funds (step 1630) and performs a limit check and/or a velocity check on the bank or credit union account (step 1640).

The monetary transaction system 210 then returns a secure, perishable withdrawal code to the subscriber 205 over at least one of the communication channels (step 1650) and receives a subsequent agent branch communication indicating that the withdrawal code has been presented to an agent (step 1660). The monetary transaction system 210 then debits the bank or credit union account by the specified amount of funds (step 1670), returns a notification to the agent branch confirming the withdrawal (1680) and notifies the subscriber that the specified amount of funds were withdrawn from the bank or credit union account using at least one of the communication channels connected to the monetary transaction system (step 1690). Accordingly, a subscriber can withdraw cash stored on their mobile wallet from an agent branch or a non-agent branch.

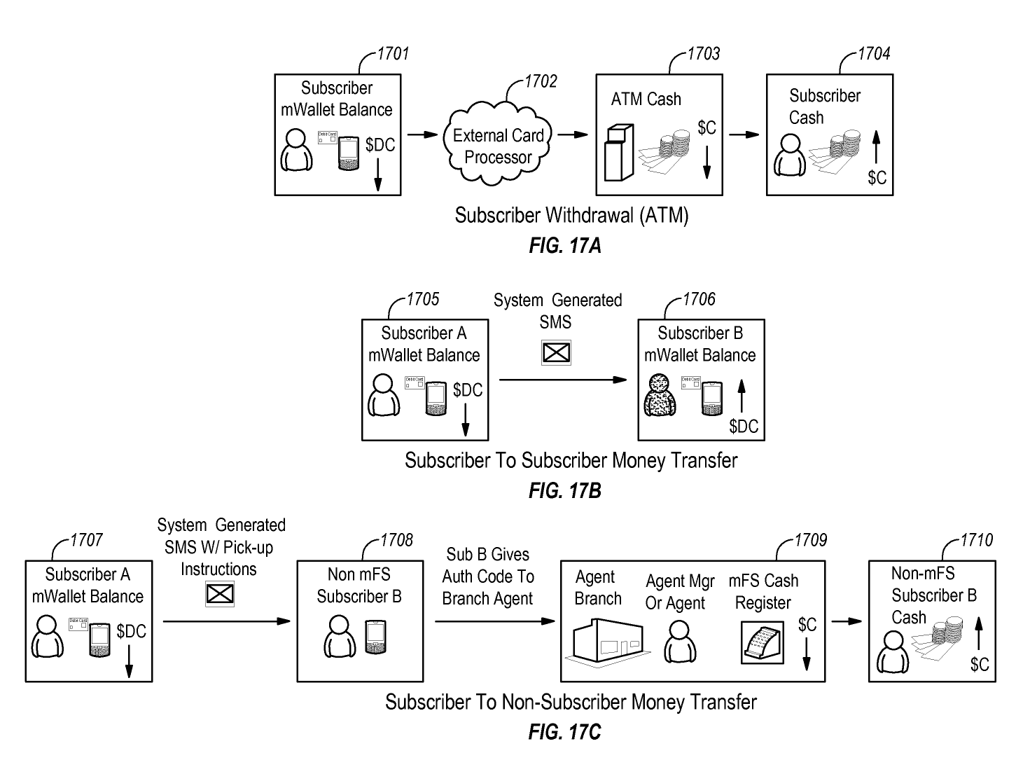

FIG. 17A illustrates a subscriber withdrawal using an automated teller machine (ATM). Subscribers in many countries have access to ATM machines and can use their mobile wallets to perform withdrawals using their (prepaid) debit card at most ATMs. Banks provide ATMs to their customers (typically at no charge) and to non-customers (typically for a small charge). The subscriber requests a cash withdrawal from the subscriber's mobile wallet via the subscriber's debit card that is associated with the mobile wallet. The bank providing the debit card may receive settlement reports from the card processor and may transfer and/or settle funds from subscriber's account to the ATM network bank. An external card processor decrements the subscriber's mobile wallet balance (1701) and sends transaction reports to the bank for settlement. Accordingly, once the withdrawal request has been received and the external card processor (e.g. Visa® or MasterCard®) (1702) has debited the debit card account, the ATM (1703) dispenses the withdrawn cash to the subscriber (1704).

FIG. 17B illustrates a subscriber-to-subscriber money transfer. An mFS subscriber (1705) may send money to another mFS subscriber (1706). To do so, subscriber A enters information identifying subscriber B (e.g. a phone number, email address or other identifier). The monetary transaction system 210 determines if there are enough funds to complete the transaction, and if so, the monetary transaction system 210 decrements subscriber A's debit card and credits subscriber B's debit card. The subscriber, accordingly, may request to send money from their own mobile wallet (i.e. money stored on a (prepaid) debit card) account via the subscriber mobile wallet application. The other subscriber receives a notification that the balance of the debit card associated with their mobile wallet has increased. The bank receives a settlement report from the debit card processor and transfers or settles funds from subscriber A's account to subscriber B's account (if necessary). The monetary transaction system 210 processes the transfer request, updates subscriber A's and subscriber B's debit cards that are associated with their mobile wallets and logs the transaction. The external card processor decrements subscriber A's debit card balance, increments subscriber B's debit card balance and sends transaction reports to the mFS platform bank for settlement.

FIG. 17C illustrates subscriber-to-non-subscriber money transfers. In this embodiment, subscriber A (an mFS subscriber) wishes to send money to another subscriber (a non-mFS subscriber). The transaction is initiated in the same fashion as described above in FIG. 17B. However, since subscriber B does not have an mFS account, the monetary transaction system 210 cannot credit them with money. Instead, the monetary transaction system 210 sends a communication (e.g. a SMS) to subscriber B (1708) with an authorization code and instructions for how to pick up the cash. The monetary transaction system 210 puts a hold on subscriber A's debit card for the amount transferred (1707). Subscriber B has a specified time period in which to pick up the cash before the hold expires and the amount is credited back to the debit card associated with subscriber A's mobile wallet account. The agent branch verifies the authorization code via POS or their agent mobile wallet application (1709) and gives the cash to the non-subscriber (1710). (In some countries, an agent network needs to be capable of giving cash to a subscriber based on the money transfer reference number).

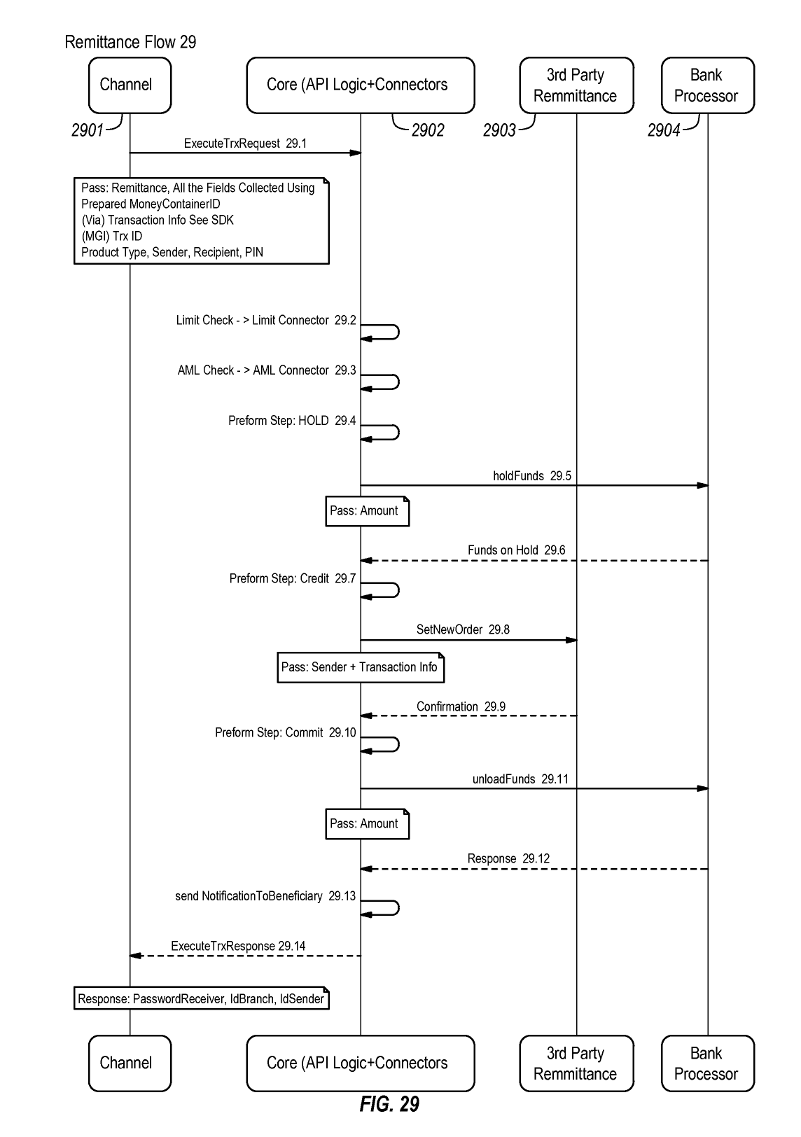

The mFS bank receives a settlement report from the card processor and transfer and settle funds from subscriber A's debit card to the agent's bank (if necessary). The monetary transaction system 210 processes the money transfer request, decrements subscriber A's mobile wallet balance within the card processor (see FIG. 29, step no. 29.4), generates a money transfer reference number, authorizes the reference number to be paid out by the agent and logs the transaction. An external card processor decrements subscriber A's mobile wallet balance and sends periodic transaction reports to the bank for settlement. Thus, as seen in FIGS. 17B and 17C, money may be transferred from subscriber to subscriber and from subscriber to non-subscriber.

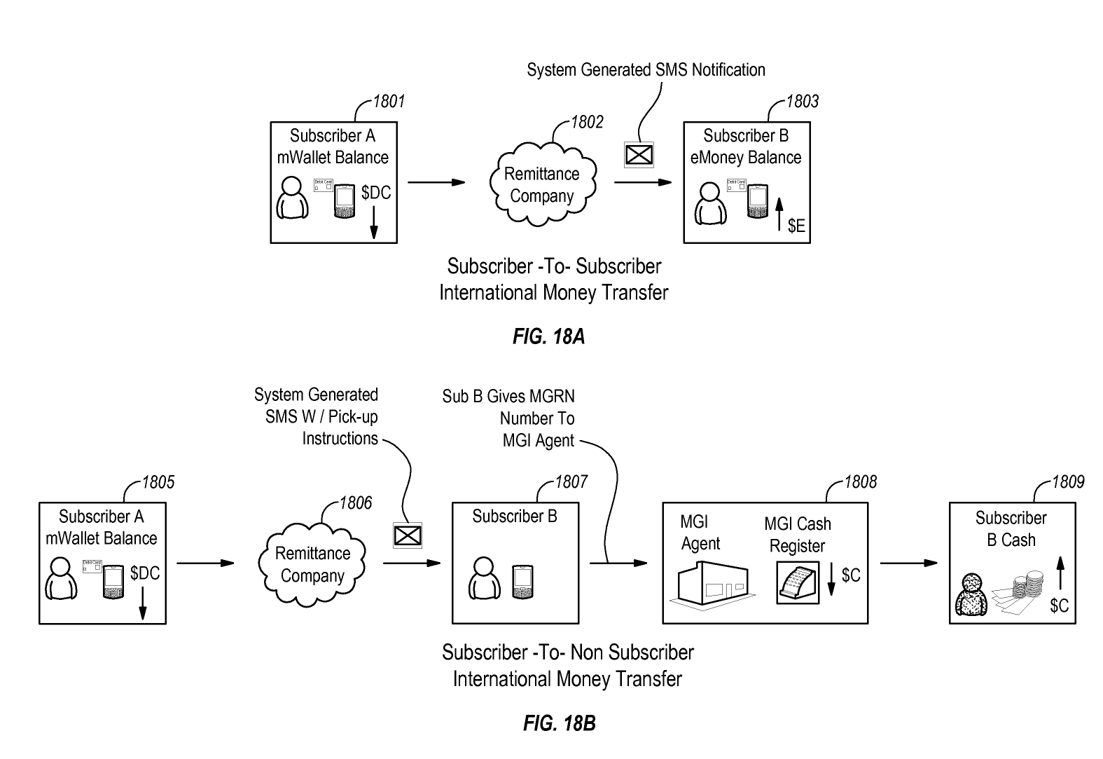

Subscribers may similarly send money internationally to both subscribers and non-subscribers. FIG. 18A illustrates a subscriber-to-subscriber international money transfer. In this embodiment, subscriber A wishes to send cash to subscriber B who resides in another country. As in the embodiments described above where money was transferred internationally, the monetary transaction system 210 may use one or more international money transfer organizations or remittance companies such as MoneyGram® to transfer the money. Subscriber A initiates the international money transfer using his or her phone. Subscriber A's debit card account is decremented by the transfer amount (1801). The money is transferred between countries using an international money transfer organization (1802). In this case, subscriber B has an mFS eMoney account with a foreign mFS platform that is also affiliated with the selected international money transfer organization. That organization can then credit subscriber B's eMoney account directly (1803).

Thus, subscriber A requests to send money from their debit card account via the subscriber mobile wallet application. Subscriber B receives a notification (including a MoneyGram® Reference Number (MGRN) (or other reference number when other international money transfer organizations are used) and instructions on how to access the eMoney) that their eMoney balance has increased. The mFS bank receives settlement reports from the debit card processor and transfers and/or settles funds from subscriber's account to the international organization's bank. The monetary transfer system 210 processes the transfer request, update subscriber A's and subscriber B's eMoney balances and logs the transaction. An external card processor decrements subscriber A's mobile wallet balance and sends periodic transaction reports to the bank for settlement.

FIG. 18B illustrates a subscriber-to-non-subscriber international money transfer. In this embodiment, subscriber A wishes to send cash to subscriber B who resides in another country. As above, the monetary transaction system 210 uses an international money transfer organization (1806) to transfer the money between countries. Once the transfer has been initiated by subscriber A, the international money transfer organization debits subscriber A's debit card account (1805) and transfers that money to subscriber B. Subscriber B (1807) receives a notification (e.g. via SMS) with pick up instructions and a transfer ID number. Subscriber B can then go to an agent company (1808), show them the notification (including, perhaps an authorization code), and receive the transferred money (1809).

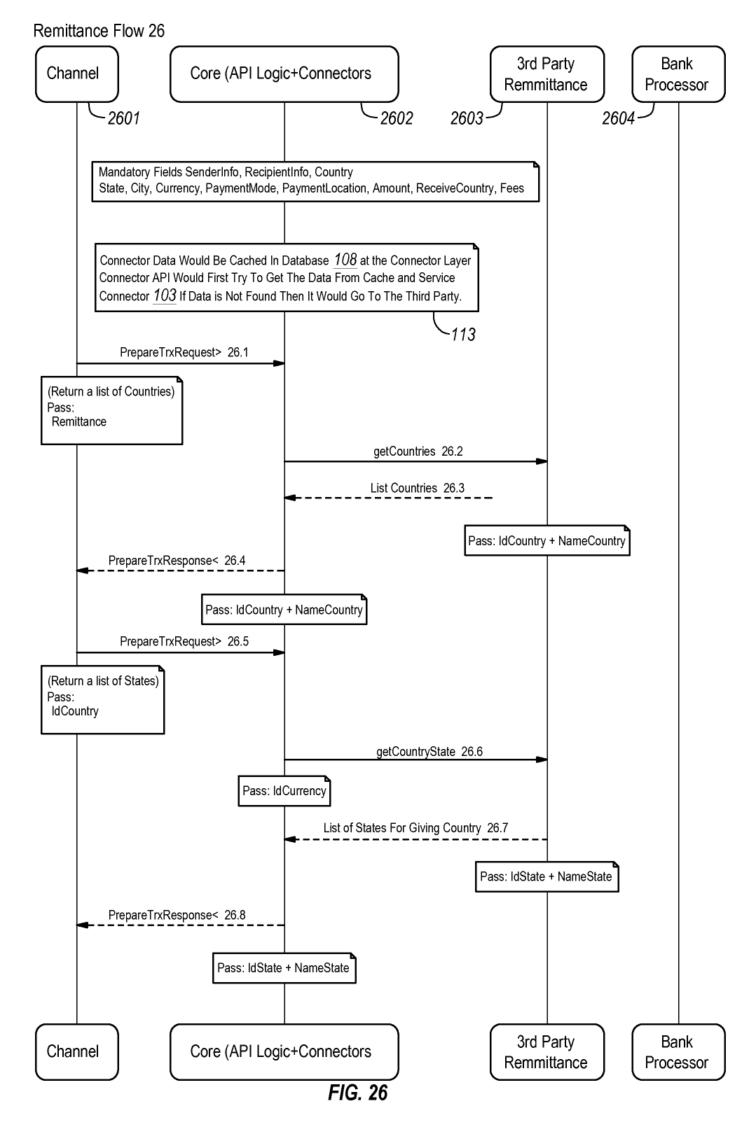

Similar to the transaction described in FIG. 18A, the embodiment of 19A illustrates a transaction where a subscriber receives an international money transfer. Subscriber B (1901) initiates a money transfer using their mobile wallet application. The international money transfer organization (1902) debits subscriber B's eMoney account balance. This money is then transferred by the international money transfer organization to subscriber A. Subscriber A receives a notification along with a transfer ID number indicating that their debit card account has been credited with the transferred money (1903). FIGS. 26, 27, 28, 29 provide a more detailed description of the remittance flow process steps of the technical platform described in FIG. 1.

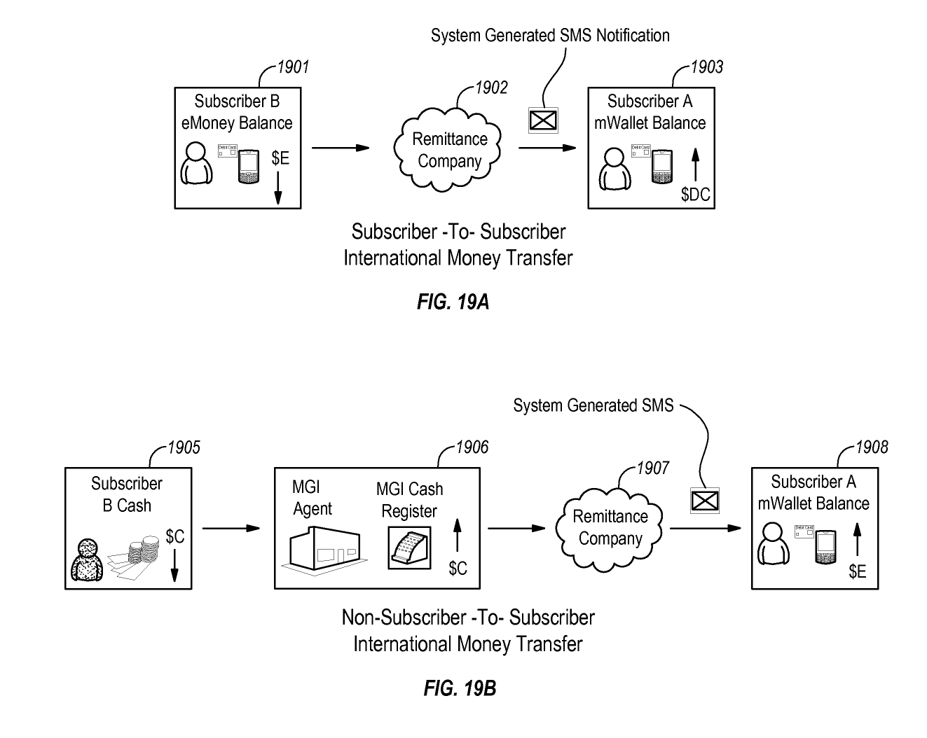

FIG. 19B illustrates a non-subscriber-to-subscriber international money transfer. This scenario is very similar to that described in FIG. 19A from the mFS subscriber's perspective, except that their eMoney account is credited here, and their debit card account was credited in 19A. The initiator, subscriber B (1905), does not have an mFS account and, as a result, takes their cash to an international money transfer organization (e.g. MoneyGram®) or other remittance company's agent (1906) to send it to subscriber A's mobile wallet eMoney account. The international money transfer organization (1907) then transfers the specified amount to subscriber A (1908) and subscriber A's mobile wallet eMoney account is credited with the amount of the transfer. Subscriber A may receive a transaction ID number, along with an indication that the transfer has occurred. The mFS bank may receive settlement reports from the card processor and settle funds from the international money transfer organization's bank to subscriber A's mobile wallet account. The monetary transaction system processes the money transfer request, updates subscriber A's mobile wallet balance within the card processor and logs the transaction. An external card processor increments subscriber A's mobile wallet balance and sends periodic transaction reports to the mFS bank for settlement.

Other functionality described above in relation to using an eMoney mobile wallet account may also apply to banked subscribers using a debit card associated with their mobile wallet. Such subscribers may buy airtime for their mobile device, pay bills, make retail purchases, receive direct deposits, and perform other functionality.

In one embodiment, the monetary transaction system 210 is implemented to add a mobile wallet platform stored value account to a mobile wallet. The stored value account may include eMoney or other monetary credits. In the embodiment, communication module 215 of monetary transaction system 210 may receive subscriber data for an unbanked subscriber 205 over a communication channel. The transaction processor may perform validation checks on the unbanked subscriber to validate that the unbanked subscriber is not exceeding a specified allowable number of accounts per subscriber. The monetary transaction system 210 may then send subscriber data to another entity (such as a third party verification system) for identification of the unbanked subscriber. The monetary transaction system 210 receives results from the third party verification system indicating that the subscriber data appropriately identifies the unbanked subscriber, creates a stored value account for the unbanked subscriber that maintains a recorded balance for the created stored value account, adds the stored value account to the unbanked subscriber's mobile wallet and notifies the unbanked subscriber of the addition of the stored value account over at least one communication channel connected to the mobile wallet platform.

In another embodiment, the monetary transaction system 210 is implemented to add a third party stored value account to a mobile wallet. The monetary transaction system 210 receives unbanked subscriber data, including account details, over a communication channel. The transaction processor 216 performs a validation check on the unbanked subscriber to validate that the unbanked subscriber is not exceeding a specified allowable number of accounts per subscriber. If the validation check is ok, the monetary transaction system 210 sends subscriber data to a third party verification system for identification of the unbanked subscriber. In some cases, validating the status of the sender or the recipient includes performing a check on the specified sender or recipient to comply with the office of foreign assets control. The monetary transaction system 210 then receives results from the third party verification system indicating that the subscriber data appropriately identifies the unbanked subscriber, and submits the unbanked subscriber's account details to a third party account processor. The monetary transaction system 210 receives an indication from the third party account processor that third party account processor created a third party stored value account for the subscriber. The transaction processor maintains a link between the subscriber data and the third party stored value account and adds the third party stored value account to the unbanked subscriber's mobile wallet. The monetary transaction system 210 then notifies the unbanked subscriber of the addition of the third party stored value account over a communication channels connected to the monetary transaction system.

In another embodiment, the monetary transaction system 210 is implemented to add a bank or credit union account to a mobile wallet. The communication module 215 receives subscriber data, including bank or credit union account details, over a communication channel 111. The transaction processor 216 performs validation checks on the subscriber to validate that the subscriber is not exceeding a specified allowable number of accounts per subscriber and sends subscriber data to a third party verification system for identification of the subscriber. The communication module then receives results from the third party verification system indicating that the subscriber data appropriately identifies the subscriber. Upon receiving these results, the monetary transaction system 210 submits bank or credit union account details for validation by the transaction processor, receives an indication that the bank or credit union account details correspond to a valid bank or credit union account, maintains a link between the subscriber data and the bank or credit union account and notifies the subscriber of the bank or credit union account validation over a communication channel.

In still another embodiment, the monetary transaction system is implemented to add a debit or credit card account to a mobile wallet. The communication module 215 receives subscriber data, including a debit or credit card account number, over a communication channel 111 connected to the monetary transaction system. The transaction processor performs validation checks on the subscriber to validate that the subscriber is not exceeding a specified allowable number of accounts per subscriber. The communication module sends subscriber data to a third party verification system for identification of the subscriber and receives results from the third party system indicating that the subscriber data appropriately identifies the subscriber. The monetary transaction system 210 securely stores the debit or credit card account number for access by the mobile wallet (e.g. in memory 217 or transaction database 225), adds the debit or credit card account number to the subscriber's mobile wallet, and notifies the subscriber of the addition of the debit or credit card account number. It should be noted that many other transactions can take place over the monetary transaction system, and that the embodiments described herein should not be read as limiting.

Embodiments of the invention can adhere to Know Your Customer (KYC) rules in the US by performing Customer Identification Program (CIP) checks as required by the Bank Secrecy Act and US PATRIOT Act. A minimum amount of information can be gathered about a customer, such as, for example, first name, last name, date of birth, government ID Type, government ID number and address. The CIP processes are designed to validate customer identity against government blacklists and assists in the prevention of money laundering and terrorist financing. A combination of non-documentary and documentary verification can be used to ensure beyond a reasonable doubt the identity of the customer.

Non-documentary verification can occur through the presentment of the information that was collected from the user to an external third party, such as, for example, Lexis Nexis®. Documentary verification can occur if non-documentary verification fails, then the user is asked to present an unexpired government ID. Various differ forms of identification including driver's license, passport, alien identification (e.g., green card or work visa), and Mexican Consular identification card, can be accepted.

Embodiments of the invention can perform Anti-Money Laundering (AML) and Combating the Financing of Terrorism (CFT) checks. AML and CFT checks can be performed using transaction monitoring methods to flag names and suspicious transactions for further investigation. The mobile wallet platform can perform AML and CFT checks on all electronic financial transactions to ensure that electronic funds are not being used for money laundering or terrorism. Transaction limits can be placed on user accounts. The transaction limits are fully configurable for each particular use case, channel and payment method that allows maximum flexibility to restrict higher risk use cases. Velocity checks can also be performed. Velocity Checks ensure that subscribers are not abusing the mobile wallet platform within the allowable limits.

Embodiments herein are directed to providing geographically diversified mobile cloud ecosystems which work together to deliver optimized financial and retail services to people all over the world. These ecosystems may be linked across borders, forming a worldwide conduit for simple, secure and disruptively priced business-to-business (B2B), business-to-customer (B2C) and consumer-to-consumer (C2C) mobile commerce. The mobile cloud platform described above, and referred to alternatively herein as “Mobile Global Exchange” or “Mobile Global Exchange Platform” provides reliable, scalable and secure capabilities and means used to enable client and partner ecosystems and cross-border linkage.

Embodiments described above include loading money onto mobile phones (cash in), withdrawing money from mobile phones (cash out) and transferring funds between mobile phones (wallet to wallet). These mobile financial and retail commerce services may be provided to undeserved consumers (such as unbanked consumers) as well as to other consumers that have bank accounts or other financial accounts. The services may also be provided to related businesses that are connected to local mobile cloud ecosystems as well as global mobile cloud ecosystems. The mobile cloud ecosystems may deliver instant secure purchasing using mobile tagging and secure cloud technologies optimized for frictionless mobile commence referred to herein as “SMART”.

The SMART financial service provides consumers “one click” purchasing using their mobile phones, as well as secure, cross-border clearing of funds for settlement of purchases or peer-to-peer (P2P) money transfers. Unbanked consumers can utilize SMART money on their mobile phones, while banked consumers can deposit SMART money from their mobile phones into linked bank accounts (e.g. debit accounts) or other card accounts in a simple and secure manner. The mobile phones may be smartphones with rich functionality, or may be feature phones with limited functionality including texting and voice calls.

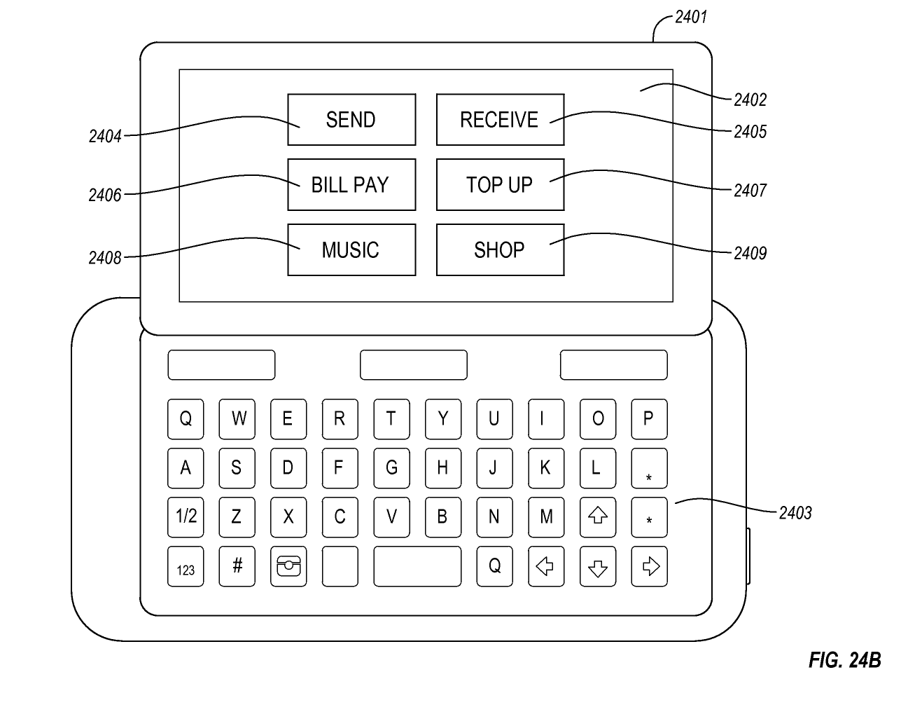

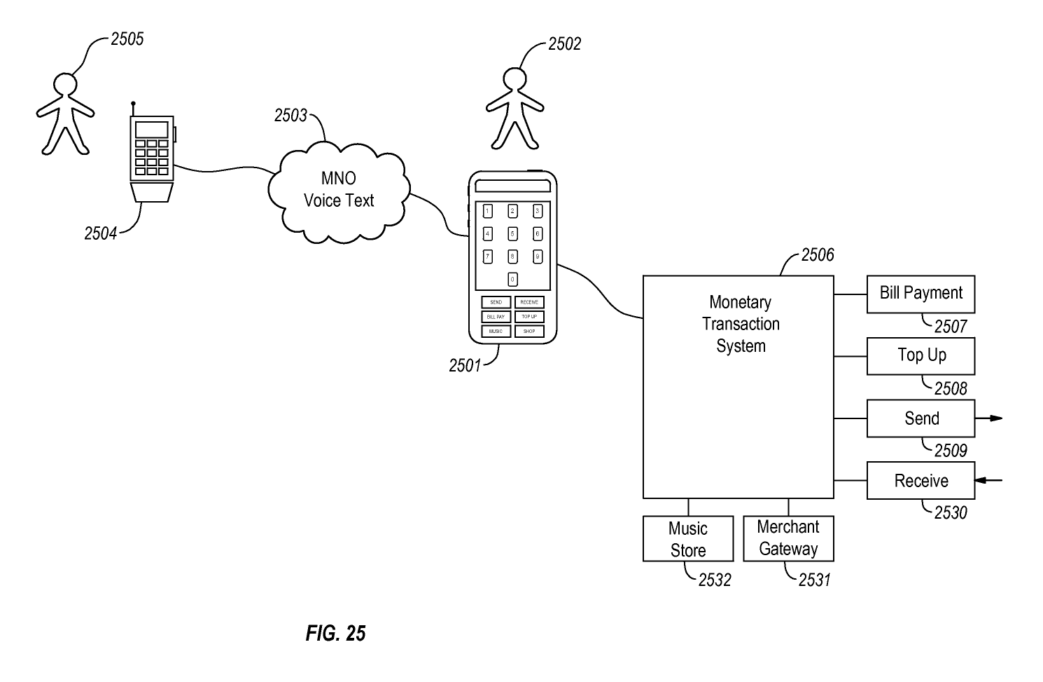

Such feature phones may be custom-built by a mobile handset manufacturer, and a wireless carrier or other entity may provide subsidized mobile phones packaged with SMART services, a built-in search engine, specialized social media membership and global retail fulfillment that enables “one click” secure commerce, potentially with little or no interchange fees for users (including unbanked users) worldwide. Such phones, as further described in FIG. 24 and FIG. 25, may allow consumers to utilize convenient and disruptively priced services such as airtime top-up, bill payment, payroll deposit, P2P money transfers, international remittances, prepaid ID cards, merchant payments, “one click” eCommerce, loyalty rewards, brand promotions, opt-in mobile advertising and other services.

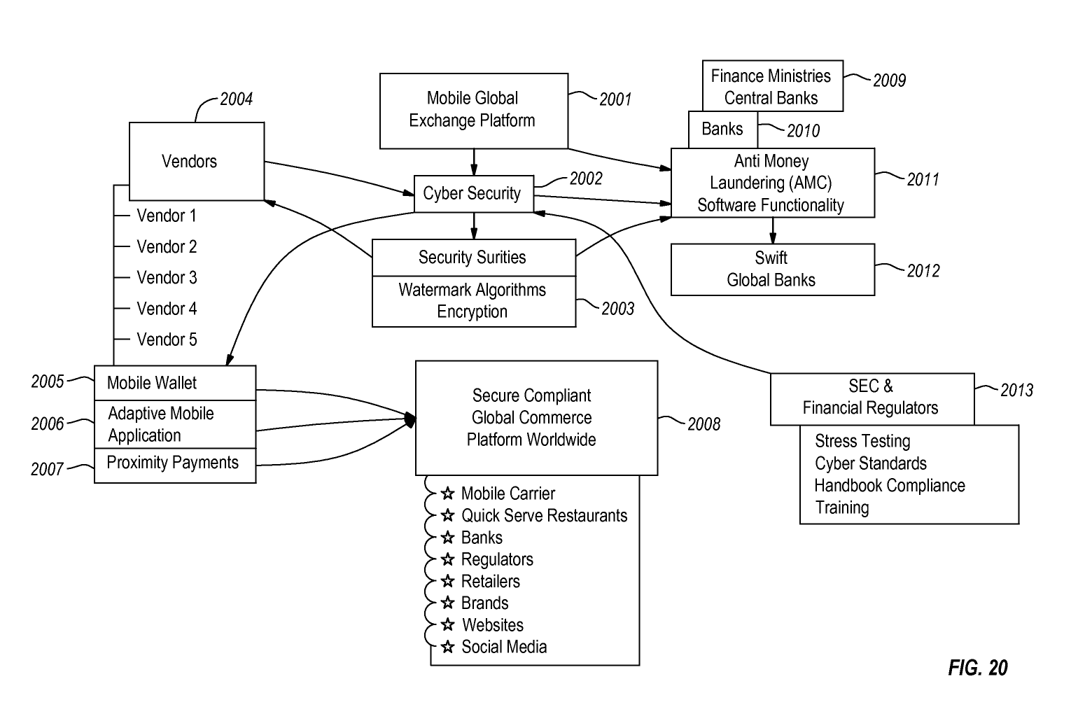

FIG. 20 illustrates a diagram of the eco-system comprising the Mobile Global Exchange Platform referred to above. The Mobile Global Exchange (‘MGX’) Platform 2001 is linked to central banks 2009 and other local banks 2010, anti-money laundering functionality 2011 including hardware and/or software, financial regulators 2013, cyber security 2002, watermark, encryption and other security services 2003, vendors 2004, users and corporations. MGX platform users may use mobile wallet applications 2005, adaptive mobile applications 2006 or other applications to make proximity payments 2007, or perform other functions such as mobile top-up and remittances using the MGX platform. In this manner, the MGX platform 2001 provides a secure, compliant global commerce platform 2008.

The Society for Worldwide Interbank Financial Telecommunication (SWIFT) 2012 is a global organization that handles secured exchange of messages between many thousands of different financial institutions, and between financial institutions and their corporate or other clients. SWIFT provides a shared worldwide data processing and communication link for many of the world's banks, using a common language. SWIFT facilitates wire transfers of funds, but does not hold funds, manage accounts on behalf of customers, or store financial information on an ongoing basis. The cloud-based, mobile-enabled global exchange described herein provides financial interchange and processing functionalities on mobile phones. Moreover, the MGX platform will provide interchange between ecosystems including money transferring entities (e.g. MoneyGram™, banks, mobile network operators (MNOs), retailers, consumer packaged companies (CPGs) and other entities).

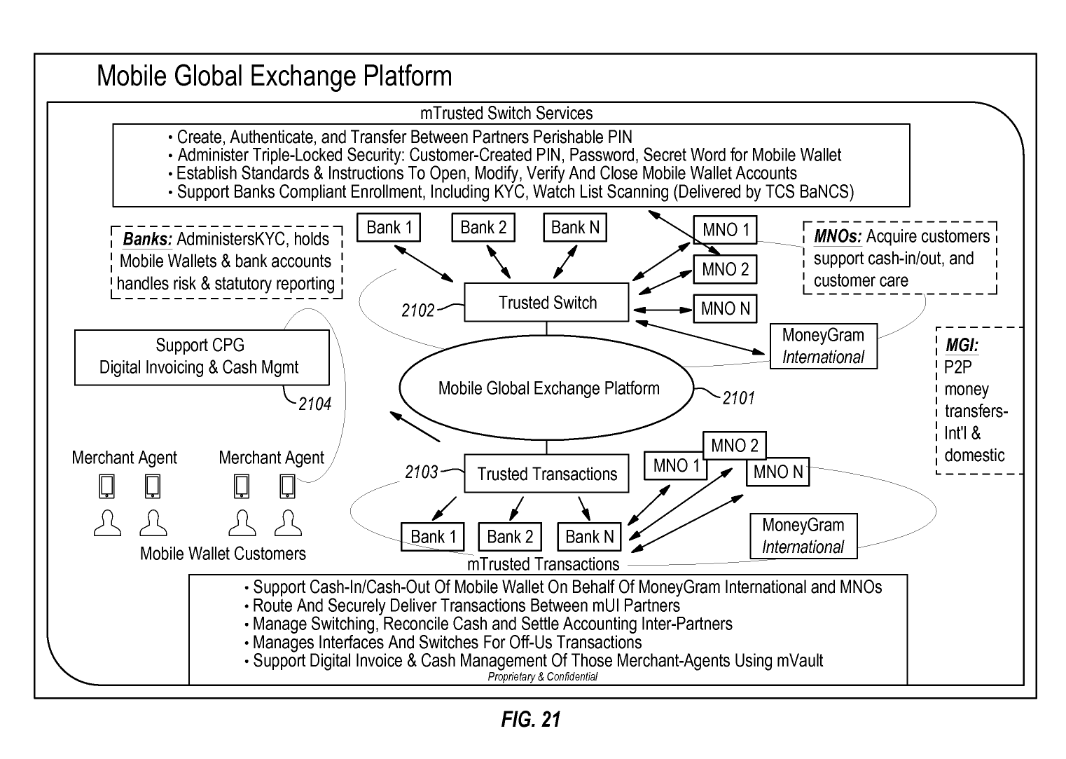

The MGX platform 2001, as described herein, may reduce the interchange and processing costs for users including money transferring entities. These money transferring entities may then pass on the savings in the form of disruptive pricing on business-to-consumer payment products, which drive consumer trial and usage. The MGX platform 2101 of FIG. 21 may include many different services and entities, including any one or more of the following: trusted switch capabilities 2102 creates and authenticates users using perishable PINs or other credentials including passwords or biometric credentials, as well as aggregates, stores, and transfers customer data between parties. The MGX platform 2101 supports banks including providing know your customer (KYC) and other compliance requirements for mobile wallet enrollment.

Trusted transactions capabilities 2103 supports cash-in/cash-out of mobile wallet on behalf of money transferring entities (such as MoneyGram™) and MNOs. Users can cash-in via a money transferring entity's agent, via an ATM, credit card ready-link, point of sale, Greendot MoneyPak, bank account, credit or debit card. Cash-out may be provided via a money transferring entity's agent, via an ATM, credit card ready-link, or point of sale. Trusted transactions capabilities 2103 may also include routing and securely delivering transactions between partners within the Mobile Global Exchange, managing switching, reconciling cash, and settling accounting transactions. Digital invoicing 2104 may also be provided for CPG companies and their merchants, as well as supporting cash management of those merchant-agents.

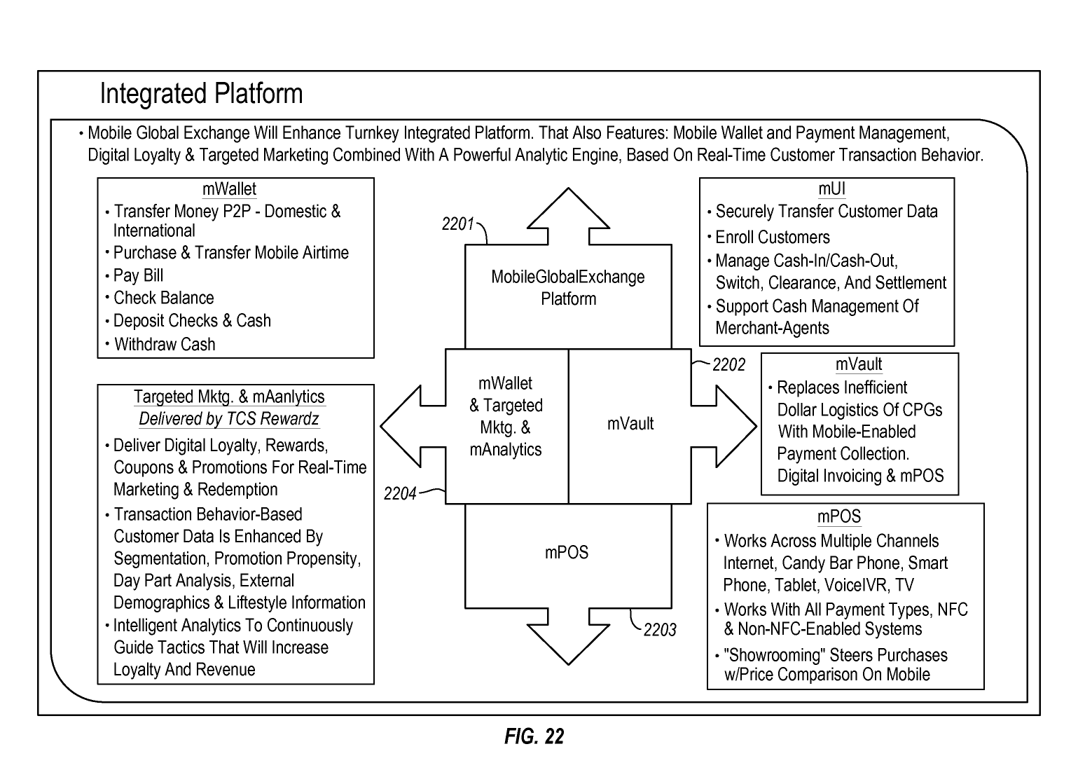

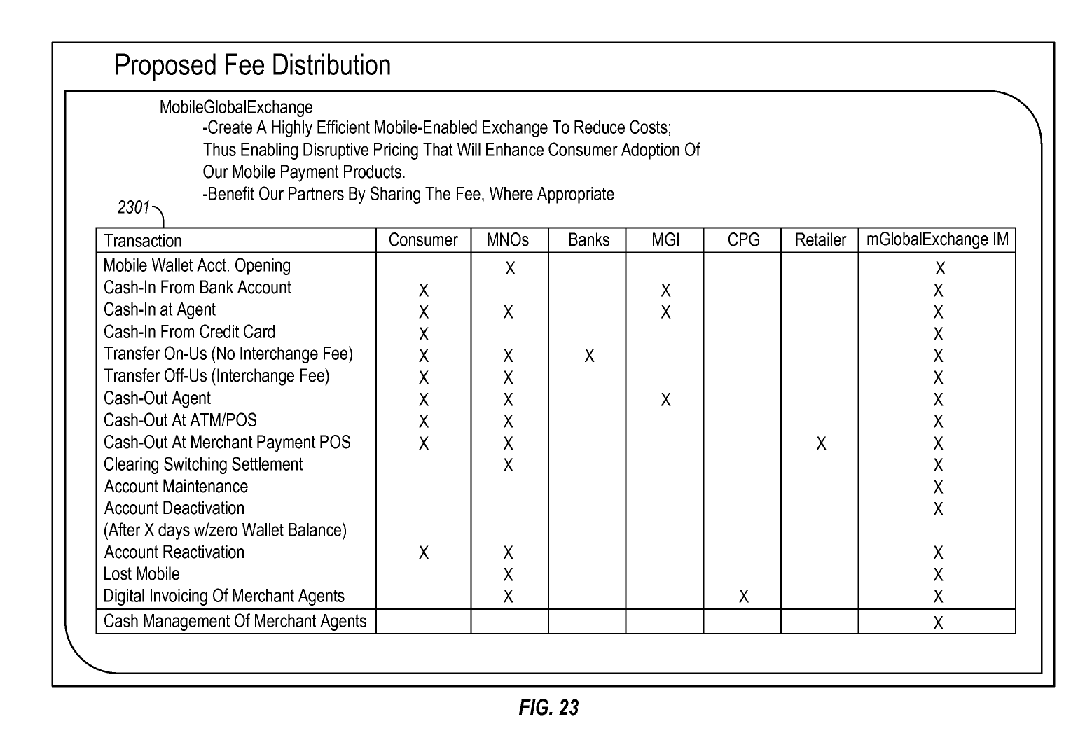

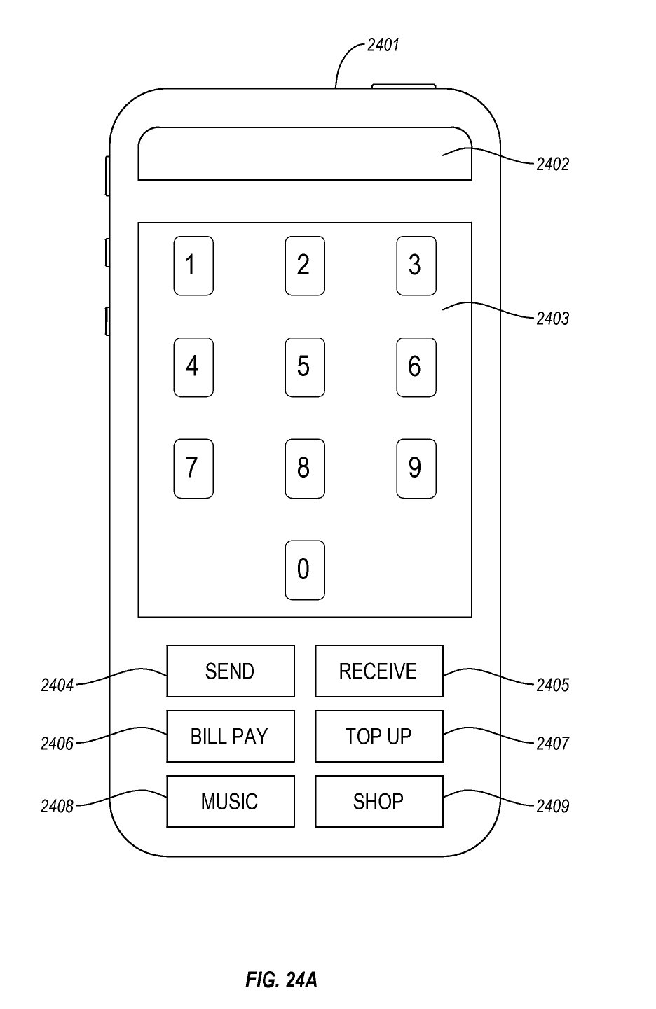

The Mobile Global Exchange Platform provides mobile wallet and payment management, as well as digital loyalty and targeted marketing, combined with an analytics engine that is designed to use real-time customer transaction behavior. As shown in FIG. 22, the MGX platform 2201 includes a mobile wallet 2204 which allows users to transfer money peer-to-peer, domestically and internationally, purchase and transfer mobile airtime minutes, pay bills, check balances, deposit checks and cash, withdraw cash, receive targeted marketing, rewards or loyalty points based on analytics, and receive and redeem coupons and promotions (in real time or otherwise).

Transaction behavior-based customer data may be enhanced by segmentation, promotion propensity, day part analysis, external demographics and lifestyle information. Intelligent analytics may be used to continuously guide tactics that will increase loyalty and revenue. The mobile user interface (mUI) may be implemented to securely transfer customer data, enroll customers, manage cash-in/cash-out, switch, clearance, and settlement, and support cash management of merchants-agents. The mobile vault or “mVault” 2202 facilitates the replacement of cash and cash logistics of CPGs with mobile-enabled payment collection, digital invoicing, and mobile points of sale (mPOSs). Mobile POSs 2203 work across multiple channels including the internet, feature phones, smart phones, tablets, interactive voice response (IVR), television or other channels. The mVault 2202 works with substantially all payment types including card-based systems as well as wireless (e.g. near-field communication (NFC)) and non-NFC-enabled systems). A “Showrooming” feature may be implemented which provides a means for price comparison on mobile device.

FIG. 23 illustrates an example fee distribution chart 2301. The fee distribution chart 2301 shows who pays fees for various types of transactions. The Mobile Global Exchange Platform creates an efficient mobile-enabled exchange to reduce costs, thereby enabling disruptive pricing that enhances consumer adoption of mobile payment products. Partners to the MGX platform may share fees where appropriate.

SWIFT's Digital Asset Grid (DAG) creates a global digital identity exchange that will bring bank-grade identity, privacy, and security to the global exchange of any digital asset between any parties. SWIFT's current business intelligence capability may be improved by extracting more fields, by providing intra-day time stamps, and providing SWIFT traffic data with external market data (e.g., cross-referenced to industry sectors) for opportunity sizing and country risk assessment.

Interbank EBAM (Electronic Bank Account Management) is a corporate-to-bank solution to interbank account management provided by SWIFT. The solution consists of a set of standards and electronic instructions to open, modify, close and verify accounts, combined with a central hub providing standards validation and a repository to store account opening criteria. The interbank EBAM may also contain management, KYC and compliance requirements of correspondent banks.

Transforming Correspondent Banking (TCB) refers to a bank-owned global service for person-to-person payments that is mobile enabled. TCB creates a bank-owned company/product providing a simple yet compelling, international, domestic person-to-person, mobile-enabled payment service with accounts, as well as cash pay-in/pay-out capabilities. An international money infrastructure may be implemented to reach smaller banks. The international money infrastructure may create a payment hub to complement existing correspondent banking arrangements. This may include a multi-lateral legal and service level agreement framework for the clearing and settlement of a (potentially limited) set of basic payments products. Each participant may accept to receive and process payments from all (or a limited subset) of the other participants under a set of business rules. Several banks may competitively offer foreign exchange and settlement capabilities to participants within the framework.

In one embodiment, a mobile global exchange platform is described. The mobile global exchange platform includes the following: one or more processors, one or more communication devices configured to communicate with monetary transaction systems, one or more computer-readable storage media having stored thereon computer-executable instructions that, when executed by the one or more processors, causes the computing system to perform a method for performing transactions between a plurality of monetary transaction systems.

The method includes the following: receiving an indication that a specified amount of money is to be transferred between a first monetary transaction system and a second monetary transaction system, receiving authentication credentials from a mobile wallet application, the authentication credentials corresponding to a mobile wallet user, determining the country of origin for the first monetary transaction system, accessing financial regulatory schemes for the first monetary transaction system, determining the country of origin for the second monetary transaction system, accessing financial regulatory schemes for the second monetary transaction system, and generating a money transfer that complies with the financial regulatory schemes of the first and second monetary transaction systems, such that the money is transferred from the first monetary transaction system to the second monetary transaction system according to each systems' respective financial regulatory schemes.

The mobile global exchange platform may be configured to process transactions where first and second monetary transaction systems are located in countries that use different currencies. The mobile global exchange platform may tie each monetary transaction system to a centralized exchange rate. In some cases, banks may perform at least part of the monetary transfer. The money may be transferred from the first monetary transaction system to the second monetary transaction system using a SWIFT exchange. The SWIFT exchange money transfer from the first monetary transaction system to the second monetary transaction system may be performed according to a fee schedule. The fee schedule may specify higher fees for transactions that are processed sooner, and lower fees for transactions that are processed later. These transactions may be processed together in a bulk transaction, with the higher-fee transactions being processed within one day, for example, and the lower-fee transactions being processed within one week.

The mobile wallet application may be configured to communicate with the mobile global exchange platform using local currency and financial regulations, regardless of which country the mobile wallet application is communicating from. Settlements may be processed between ecosystems (e.g. between cloud wallets), remittances may be processed (e.g. weekly), stored value account exchanges may be processed, international money transfers may be performed, and other financial ecosystems may be tied together using the mobile global exchange platform. Each transaction may be tied to a global exchange rate that specifies exchange rates for each of the world's currencies. In some cases, each time the mobile wallet application is used, the application itself may change to use the currency of the country it is in, as well as other financial regulatory schemes. Thus, a global retailer may have their own branded mobile wallet application that changes to different currencies and financial regulatory schemes in order to function in substantially any country in the world, and with multiple different financial ecosystems.

In another embodiment, a computer system is provided which includes the following: one or more processors and a display that displays a user interface, where the user interface provides the following: a first button that, when selected, transmits an indication indicating that a specified amount of money is to be transferred between a first monetary transaction system and a second monetary transaction system, a second button that, when selected, transmits authentication credentials from a mobile wallet application, the authentication credentials corresponding to a mobile wallet user, a graphical indicator indicating that the transaction is currently being processed, and an electronic receipt indication indicating that the transaction amount was transferred between the first monetary transaction system and the second monetary transaction system. In some cases, the user interface may further include an indication of the mobile wallet user's current stored value account balance.

FIG. 24A illustrates an example of a user interface comprised within custom-built mobile device (2401) for a specific country, region, or eco-system. The device may not be a smart phone, and may be a feature phone or other type of phone that facilitates user functionality comparable to a smart phone at a much lower price point. Mobile device 2401 includes LED display (2402), numeric key pad (2403), and several special services buttons including a send money button (2404), a receive money button (2405), a bill pay button (2406), a top up button (2407), a play music button (2408) and a shop button (2409). When in default mode, the numeric key pad (2403) may be functional as a telephone key pad. However, after a special services button is pressed, the numeric key pad may become a slave to that service.

For example, if the send money button (2404) is pressed, a user may enter an amount of money to send using the numeric key pad (2403) and then enter a recipient name using the numeric key pad (2403). Pressing the send money button (2404) again in conjunction with the zero key will reset the phone into default mode. In one embodiment, as shown in FIG. 24B below, the phone may be have slideable portions including a display portion 2401 and a keyboard portion 2403 which may include physical buttons for letters, numbers, symbols or for performing certain assigned functions.

Similarly, if a user selects the receive money button (2405), the user would then enter the amount of money to be received and then enter the name of the sender. In this way, the user of one phone can send money to the user of a second phone with a key control that, at least in some cases, requires an exact match on both the sender and receiver names and amount of the transfer. When the bill pay button is pressed, the user can enter the amount of the bill to be paid followed by the account number. The monetary transaction system can compare the account number to a list of valid account numbers to ensure that the user pays the correct account.

In another implementation, the user merely selects the bill payment button and enters the amount. In this scenario, the monetary transaction system is configured to apply the payment to the oldest bill first. When the user presses the top up special services button, they can then enter the amount of money to be applied to their mobile minute account. The value of the bill payment and mobile top up is deducted from the user's stored value account by the monetary transaction system. When the shop special services button is pressed, the user can specify an amount of money to pay a merchant for goods and services and the user can enter the invoice number or merchant number to pay. In a related embodiment, the phone can be configured to automatically identify the merchant using one of RFID, low energy blue tooth (BLE), sound, beacons, geo coordinates or other means for identifying the merchant.

The monetary transaction system can further be configured to ensure that there is an open invoice to pay in the exact amount paid by the consumer. The monetary transaction system can also be operable to store the phone number of the user with the amount due. The monetary transaction system can further use the phone number of the user to ensure that the correct invoice is being paid by matching the phone number, invoice or merchant number, and amount fields. The shop button can be used in both a proximity payment use case and a remote payment use case. Finally, when the music special services button is pressed, the mobile device may function as an MP3 player. In this mode, the device may store and play a limited number of prepaid songs. Other special services buttons can be implemented such as a camera button.

FIG. 25 shows how the custom-built mobile device can function within a given ecosystem. In this example, device (2501) is operable as the mobile device described above with relation to FIG. 24 (i.e. device 2401). As shown, user (2502) may use the device in default mode to make phone calls or send text messages using a mobile network operator (MNO) network (2503). User (2505) can receive an incoming phone call or text message using mobile device (2504). When any special services button is pressed, the mobile device (2501) may function as described in FIG. 24 through a connection to the monetary transaction system (2506). Monetary transaction system (2506) may be configured with standard internal work flows and with external connection points to third-parties to fulfill requested services including: bill payment service provider (2507), top up service provider (2508), send money service provider (2509), receive money provider (2510), merchant gateway (2531) and music store (2532).

FIGS. 26, 27, 28, and 29 describe the detailed steps performed by the MGX platform in connection with a remittance transaction. A channel application (2601) is operable to send a ‘PrepareTrxRequest’ message (26.1) to the core (2602). Core system (2602) as previously described in FIG. 1, is comprised of application program interfaces (APIs), logic, and connectors used to facilitate remittance transactions. The remittance transactions may include various fields including, but not limited to, the following: SenderInfo, RecipientInfo, Country, State, City, Currency, PaymentMode, PaymentLocation, Amount, ReceiveCountry, and Fees. The data from ‘PrepareTrxRequest’ message (26.1) is stored as connector data and cashed within the database (108) at the connector layer. Connector APIs may first try to access the data from a data cache and/or from a service connector (103 of FIG. 1). If data is not found, the connector APIs may attempt to access the data from a third party system (113).

The Business Process Services (104) of Core (2602) responsive to the receipt of ‘PrepareTrxRequest’ message (26.1) are operable to initiate a ‘getCountries’ message (26.2) which is sent to a designated 3^{rd} party remittance partner (2603). Responsive to message (26.2), the 3^{rd} party remittance partner (2603) initiates ‘ListCountries’ message (26.3) comprised of ‘IdCountry’ and ‘NameCountry’ fields. The Business Process Services (104) of Core (2602), responsive to the receipt of message (26.3) are operable to initiate and send ‘PrepareTrxResponse’ message (26.4) to the originating Channel application (2601).

Channel application (2601) is operable to send a ‘PrepareTrxRequest’ message (26.5) to the Core (2602). The data from ‘PrepareTrxRequest’ message (26.5) is stored as Connector Data and cashed within the Database (108) at the connector layer. Connector APIs may first try to get the data from cache and service connector (103). If data is not found, the APIs may implement the third party system (113).

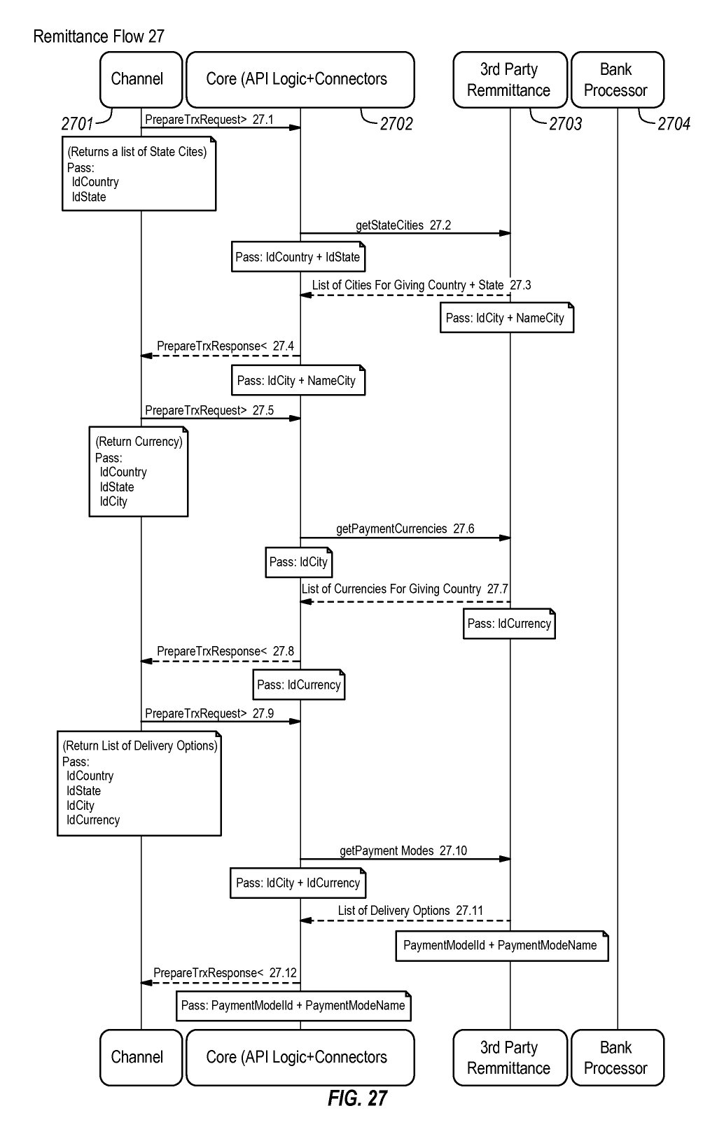

The Business Process Services (104) of Core (2602) responsive to the receipt of ‘PrepareTrxRequest’ message (26.5) are operable to initiate a ‘getCountryState’ message (26.6), which is sent to a designated 3^{rd} party remittance partner (2603). Responsive to message (26.6), the 3^{rd} party remittance partner (2603) initiates ‘ListofStatesForGivingCountry’ message (26.7) comprised of ‘IdState’ and ‘NameState’ and fields. The Business Process Services (104) of Core (2602), responsive to the receipt of message (26.7) are operable to initiate and send ‘PrepareTrxResponse’ message (26.8) to the originating Channel application (2601). The remittance flow of FIG. 26 continues with FIG. 27.

Channel application (2701) is operable to send a ‘PrepareTrxRequest’ message (27.1) to the Core (2702). The data from ‘PrepareTrxRequest’ message (27.1) is stored as connector data and cashed within the database (108) at the connector layer. Connector APIs may first attempt to access the data from the data cache and/or service connector (103). If data is not found, the APIs may attempt to go to the third party system (113).

The Business Process Services (104) of Core (2702) responsive to the receipt of ‘PrepareTrxRequest’ message (27.1) are operable to initiate a ‘getStateCities’ message (27.2), which is sent to a designated 3^{rd} party remittance partner (2703). Responsive to message (27.2), the 3^{rd} party remittance partner (2703) initiates ‘ListOfCitiesForGivingCountry+State’ message (27.3) comprised of ‘IdCity’ and ‘NameCity’ fields. The Business Process Services (104) of Core (2702), responsive to the receipt of message (27.3) are operable to initiate and send ‘PrepareTrxResponse’ message (27.4) to the originating channel application (2701), message (27.4) comprised of IdCity and NameCity fields.

Channel application (2701) is operable to send a ‘PrepareTrxRequest’ message (27.5) to the Core (2702). The data from ‘PrepareTrxRequest’ message (27.5) is stored as connector data and cashed within the database (108) at the connector layer. Connector APIs would first try to get the data from cache and service connector (103). If data is not found, the APIs may attempt to go to the third party system (113).

The Business Process Services (104) of Core (2702) responsive to the receipt of ‘PrepareTrxRequest’ message (27.5) are operable to initiate a ‘getCountryState’ message (27.6), which is sent to a designated 3^{rd} party remittance partner (2603). Responsive to message (27.6), the 3^{rd} party remittance partner (2703) initiates ‘ListofCurrenciesForGivingCountry’ message (27.7) comprised of an ‘IdCurrency’ field. The Business Process Services (104) of Core (2702), responsive to the receipt of message (27.7) are operable to initiate and send ‘PrepareTrxResponse’ message (27.8) to the originating channel application (2701), message (27.8) comprised of the IdCurrency field.

Channel application (2701) is operable to send a ‘PrepareTrxRequest’ message (27.9) to the Core (2702). The data from ‘PrepareTrxRequest’ message (27.9) is stored as connector data and cashed within the database (108) at the connector layer. Connector APIs would first try to get the data from cache and service connector (103). If data is not found, the APIs may attempt to go to the third party system (113).

The Business Process Services (104) of Core (2702) responsive to the receipt of ‘PrepareTrxRequest’ message (27.9) are operable to initiate a ‘getPaymentModes’ message (27.10), which is sent to a designated 3^{rd} party remittance partner (2703). Responsive to message (27.10), the 3^{rd} party remittance partner (2703) initiates ‘ListofDeliverOptions’ message (27.11) comprised of: ‘PaymentModelId’ and ‘PaymentModelName’ fields. The Business Process Services (104) of Core (2702), responsive to the receipt of message (27.11) are operable to initiate and send ‘PrepareTrxResponse’ message (27.12) to the originating channel application (2701), message (27.12) comprised of the PaymentModelId and PaymentModelName fields.

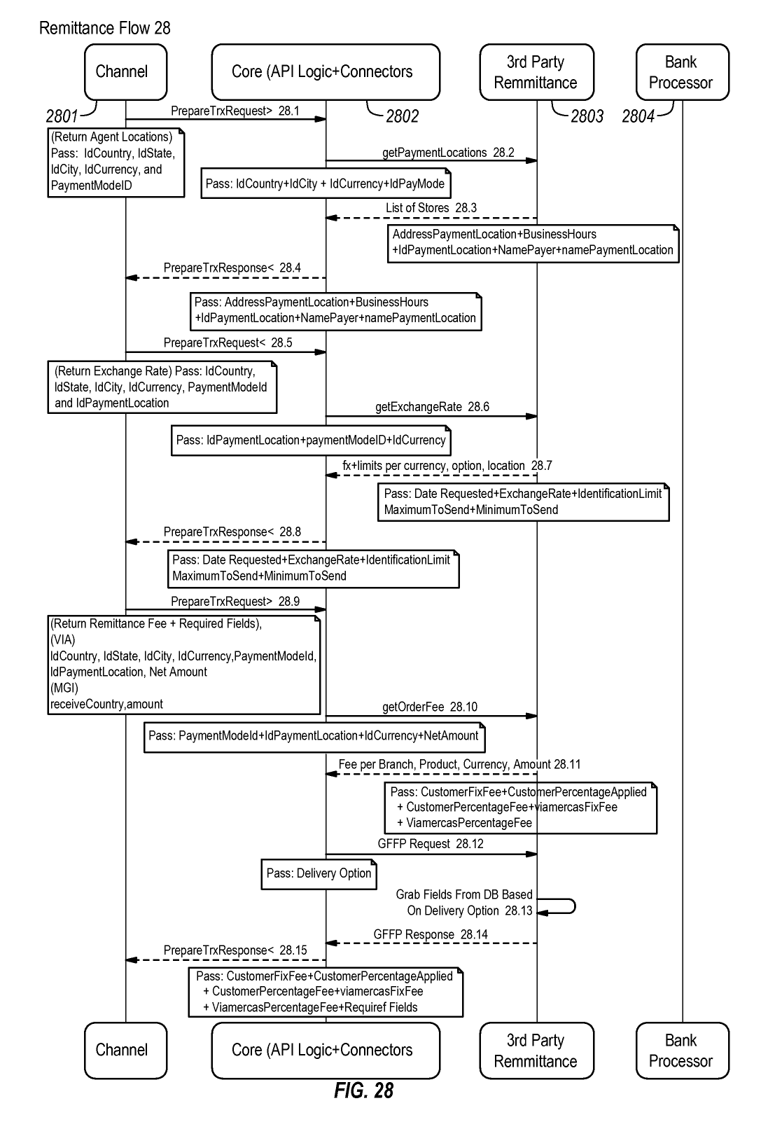

The remittance flow detailed description continues with FIG. 28. Channel application (2801) is operable to send a ‘PrepareTrxRequest’ message (28.1) to the Core (2802). The data from ‘PrepareTrxRequest’ message (28.1) is stored as connector data and cashed within the database (108) at the connector layer. Connector APIs would first try to get the data from cache and service connector (103). If data is not found, the APIs may attempt to go to the third party system (113).

The Business Process Services (104) of Core (2802) responsive to the receipt of ‘PrepareTrxRequest’ message (28.1) are operable to initiate a ‘getPaymentLocations’ message (28.2), which is sent to a designated 3^{rd} party remittance partner (2803). Responsive to message (28.2), the 3^{rd} party remittance partner (2803) initiates “AddressPaymentLocation+BusinessHours+IdPaymentLocation+NamePayer+NamePaymentLocation” message (28.3) comprised of: List of Stores fields which include: AddressPaymentLocation, BusinessHours, IdPaymentLocation, NamePayer, and PaymentLocation fields. The Business Process Services (104) of Core (2802), responsive to the receipt of message (28.3) are operable to initiate and send ‘PrepareTrxResponse’ message (28.4) to the originating channel application (2801), message (28.4) comprised of list of stores fields which include: AddressPaymentLocation, BusinessHours, IdPaymentLocation, NamePayer, and PaymentLocation fields.

Channel application (2801) is operable to send a ‘PrepareTrxRequest’ message (28.5) to the Core (2802). The data from ‘PrepareTrxRequest’ message (28.5) is stored as connector data and cashed within the database (108) at the connector layer. Connector APIs would first try to get the data from cache and Service Connector (103). If data is not found, the APIs may attempt to go to the third party system (113).

The Business Process Services (104) of Core (2802) responsive to the receipt of ‘PrepareTrxRequest’ message (28.5) are operable to initiate a ‘getExchangeRate’ message (28.6), which is sent to a designated 3^{rd} party remittance partner (2803). Responsive to message (28.6), the 3^{rd} party remittance partner (2803) initiates ‘fx+limitsPerCountry, option, location’ message (28.7) comprised of: Date Requested, Exchange Rate, Identification Limit, MaximumToSend, and MinimumToSend fields. The Business Process Services (104) of Core (2802), responsive to the receipt of message (28.7) are operable to initiate and send ‘PrepareTrxResponse’ message (28.8) to the originating Channel application (2801), message (28.8) comprised of the Date Requested, Exchange Rate, Identification Limit, MaximumToSend, and MinimumToSend fields.

Channel application (2801) is operable to send a ‘PrepareTrxRequest’ message (28.9) to the Core (2802). The data from ‘PrepareTrxRequest’ message (28.9) is stored as connector data and cashed within the database (108) at the connector layer. Connector APIs would first try to get the data from cache and service connector (103). If data is not found, the APIs may attempt to go to the third party system (113).

The Business Process Services (104) of Core (2802) responsive to the receipt of ‘PrepareTrxRequest’ message (28.9) are operable to initiate a ‘getOrderFee’ message (28.10); message (28.10) sent to a designated 3^{rd} party remittance partner (2803). Responsive to message (28.10), the 3^{rd} party remittance partner (2803) initiates ‘FeePerBranch, Product, Currency, Amount’ message (28.11) comprised of: CustomerFixFee, CustomerPercentageApplied, CustomerPercentageFee, 3rdPartyFixFee, 3rdPartyPercentageFee fields.

The Business Process Services (104) of Core (2802), responsive to the receipt of message (28.11) are operable to initiate and send the ‘GFFP Request’ message (28.12) to the 3^{rd} Party Remittance Partner (2803), message (28.12) comprised of the Delivery Option field. Third Party Remittance Provider (2803) responsive to the receipt of the ‘GFFP Request’ message (28.12) obtains the delivery options in step (28.13) and sends ‘GFFP Response’ message (28.14) to the Core (2802). The Business Process Services (104) of Core (2802), responsive to the receipt of message (28.14) are operable to initiate and send ‘PrepareTrxResponse’ message (28.15) to the originating channel application (2801), message (28.15) comprised of the CustomerFixFee, CustomerPercentageApplied, CustomerPercentageFee, 3rdPartyFixFee, 3rdPartyPercentageFee fields.

The remittance flow detailed description continues with FIG. 29. Channel application (2901) is operable to initiate the ‘ExecuteTrxRequest’ message (29.1), which is sent to Core (2902) and including all of the fields previously collected in steps described in FIGS. 26, 27, and 28 and additional fields including the PreparedMoneyContainerId and additional transaction information that may be required by a specific 3^{rd} party remittance partner (2903). For example Vimericas™ may require specific fields as required by its Software Development Kit (SDK) and MoneyGram may require fields such as: TrxID, Product Type, Sender, Recipient, PIN.

The Business Process Services (104) of Core (2902), responsive to the receipt of message (29.1) are operable to initiate a series of steps. Step (29.2) is operable to check the transaction amount against limits using the Limit Service Connector (103). Step (29.3) is operable to invoke the AML checks using the AML Service Connector (103). Having validated the transaction against prevailing limits and AML thresholds, Step (29.4) places a hold on the required funds associated with the remittance transaction.

The Business Process Services (104) of Core (2902), responsive to the request to hold funds are operable to initiate a ‘holdfunds’ message (29.5). Message (29.5) is delivered to Bank Processor (2904). The Business Process Services (104) of Core (2902), responsive to the response to the ‘funds on hold’ message (29.6) received from Bank Processor (2904) initiates Credit step (29.7) resulting in the initiation of ‘SetNewOrder’ message (29.8) which is sent to the 3^{rd} Party Remittance Partner (2903) and includes sender and transaction info fields.

The Business Process Services (104) of Core (2902), responsive to the response to the ‘confirmation’ message (29.9) received from 3^{rd} Party Remittance Partner (2903) initiates Commit step (29.10) resulting in the initiation of ‘unloadfunds’ message (29.11) which is sent to the 3^{rd} Party Remittance Partner (2903) and includes the Amount field. The Business Process Services (104) of Core (2902), responsive to the ‘confirmation’ message (29.12) received from 3^{rd} Party Remittance Partner (2903) initiates sendNoticeToBeneficiary step (29.13) resulting in the initiation of ‘ExecuteTrxResponse’ message (29.14) which is sent to the originating channel application (2901) and includes the PasswordReceiver, IdBranch, and IdSender fields.

The Mobile Global Exchange (MGX) platform is further described as a centralized message processing application that is aware of the enrolled programs that wish to participate and the capabilities and limitations of those programs. In the event that a customer wishes to cross the boundary of the program they are enrolled in with the payment instrument from that program, MGX allows for the processing of that payment. In addition, since MGX is aware of other programs, if customers are targeted as recipients of an 3^{rd} party payment instruction, the platform will be operable to engage those customers outside of the 3^{rd} party's infrastructure, guiding the customer to our program implementation. The primary use case of MGX involves crossing program boundaries with payment instruments.

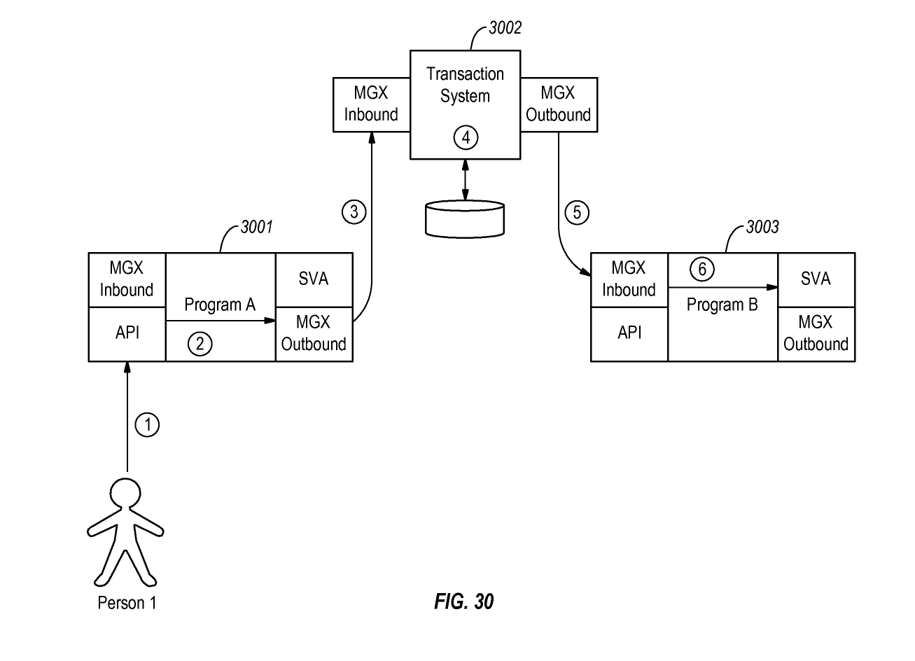

This concept is further described in FIG. 30. Element 3001 of FIG. 30 is an instance of the Mobile Global Exchange Platform comprised of Program A, which is a tenant configuration comprised within a Transaction System Platform which is further comprised of an API, an MGX inbound connector, an MGX outbound connector, and a stored value account (SVA). Element 3003 of FIG. 30 is an instance of the Mobile Global Exchange Platform comprised of Program B which is a tenant configuration of a Transaction System Platform which is further comprised of an API, an MGX inbound connector, an MGX outbound connector, and an SVA. Element 3002 of FIG. 30 is an instance of the MGX platform that includes a Transaction System Platform, an MGX inbound connector, a database, and an MGX outbound connector, where the database is configured to route instructions between instances of Transaction Systems.

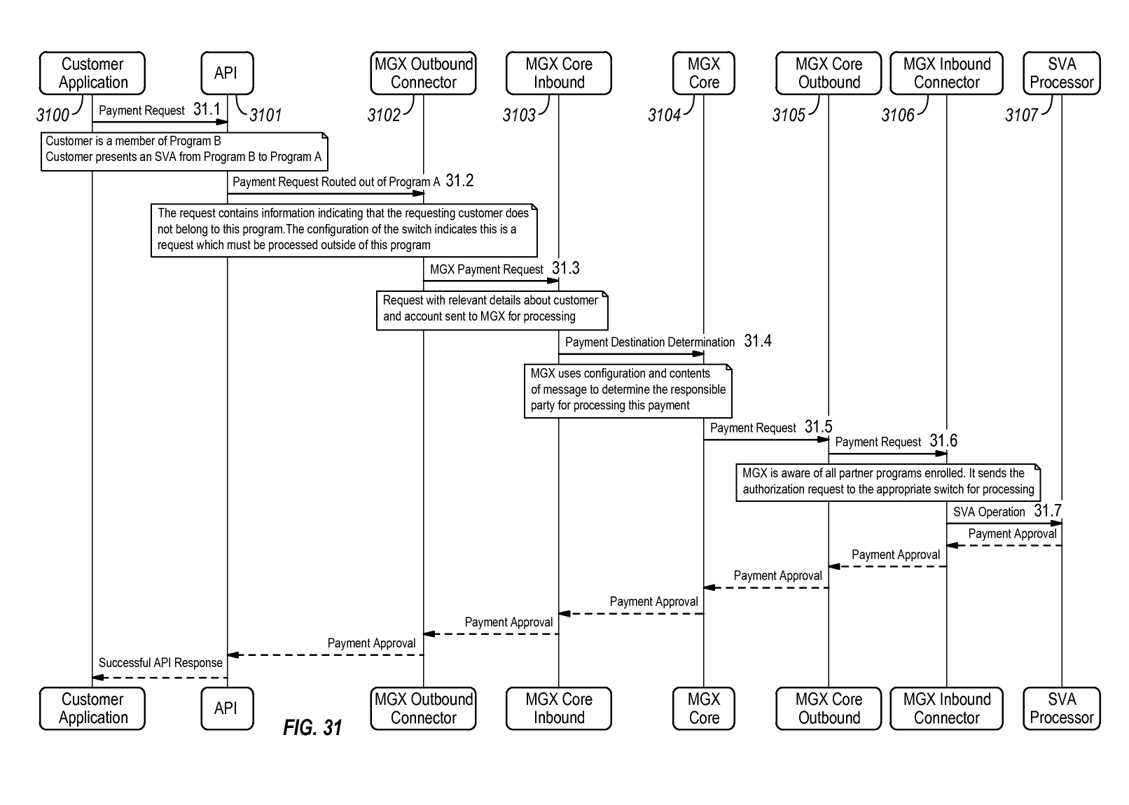

In one example, in Step 1: a user (e.g. ‘person 1’), who has pre-registered with and has pre-loaded funds or payment instruments into “Program B”, presents the details of their payment instrument at an MGX instance comprising “Program A”. In Step 2: the API of the MGX inbound connector comprised in element 3001 of FIG. 30, is configured to recognize that Person 1 is not associated with Program A and, using Step 3, routes the instruction through the MGX outbound connector to the MGX instance of element 3002. To ensure that authorization occurs against the appropriate account, the MGX instance comprised of element 3002 is operable to receive the instruction and, in Step 4, uses the database comprised within the MGX instance to determine the correct route for the instruction. Having determined the correct route for the instruction, the MGX instance of element 3002 routes the instruction using the MGX Outbound connector. In Step 5, the routed instruction is received by the API of the MGX inbound connector of the Transaction System in element 3003. In Step 6, the process is completed when the instruction is fulfilled by debiting or crediting the SVA account associated with Person 1 of Program B. Details related to this process are further described by the sequence diagram in FIG. 31.

As shown in FIG. 31, a Customer Application (3100) sends a ‘Payment Request’ message (31.1) to the API (3101) comprised within the Transaction System of Program A. The customer is a member of Program B and presents an SVA account associated with Program B to the API of the Transaction System comprising Program A. Program A, recognizing that the Customer SVA is not associated with Program A, is operable to route the transaction to the MGX Outbound Connector (3102) of the Transaction System associated with Program A. As reflected in message (31.2) the ‘Payment Request’ routed out of Program A contains information indicating that the requesting customer does not belong to this program. The configuration of the MGX platform indicates that this is a request which must be processed outside of this program.

Responsive to the receipt of the ‘Payment Request’ message associated, the MGX Outbound Connector (3102) of the Transaction System associated with Program A is further operable to initiate ‘MGX Payment Request’ message (31.3). As shown, the ‘MGX Payment Request’ message contains relevant details about the customer and account. The MGX Core Inbound Connector (3103) is operable to receive and process the ‘MGX Payment Request’ message sent from the MGX Outbound Connector (3102) of the Transaction System associated with Program A resulting in a ‘Payment Destination Determination’ message (31.4). As shown, the ‘Payment Destination Determination’ message is sent to the MGX Core (3104) for further processing.

The Business Processing Services (104) of the Transaction System that comprises the MGX Core (3104) is aware of all programs enrolled. The Business Process Services (104) of the MGX Core (3104) uses the configuration and contents of the received ‘Payment Destination Determination’ message to determine the responsible party (e.g. the Platform associated with Program A) for the processing of this payment resulting in a ‘Payment Request’ message (31.5) that is routed to the MGX Core Outbound Connector (3105). The MGX Outbound Connector (3105) routes ‘Payment Request’ message (31.5) to the MGX Inbound Connector (3106) comprised within the MGX which comprises Program B. The MGX Inbound Connector (3106), recognizing that the transaction is associated with a customer of Program B, routes the ‘SVA operations’ message (31.6) to the SVA Processor (3107). Payment approval messages traverse back through the system resulting in an approval to pay by Program A.

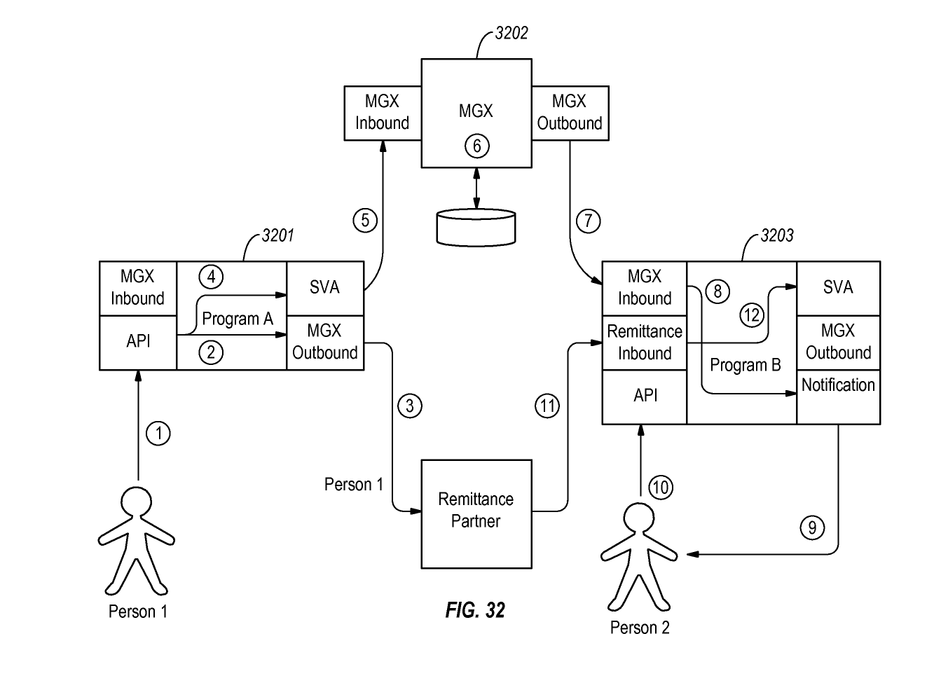

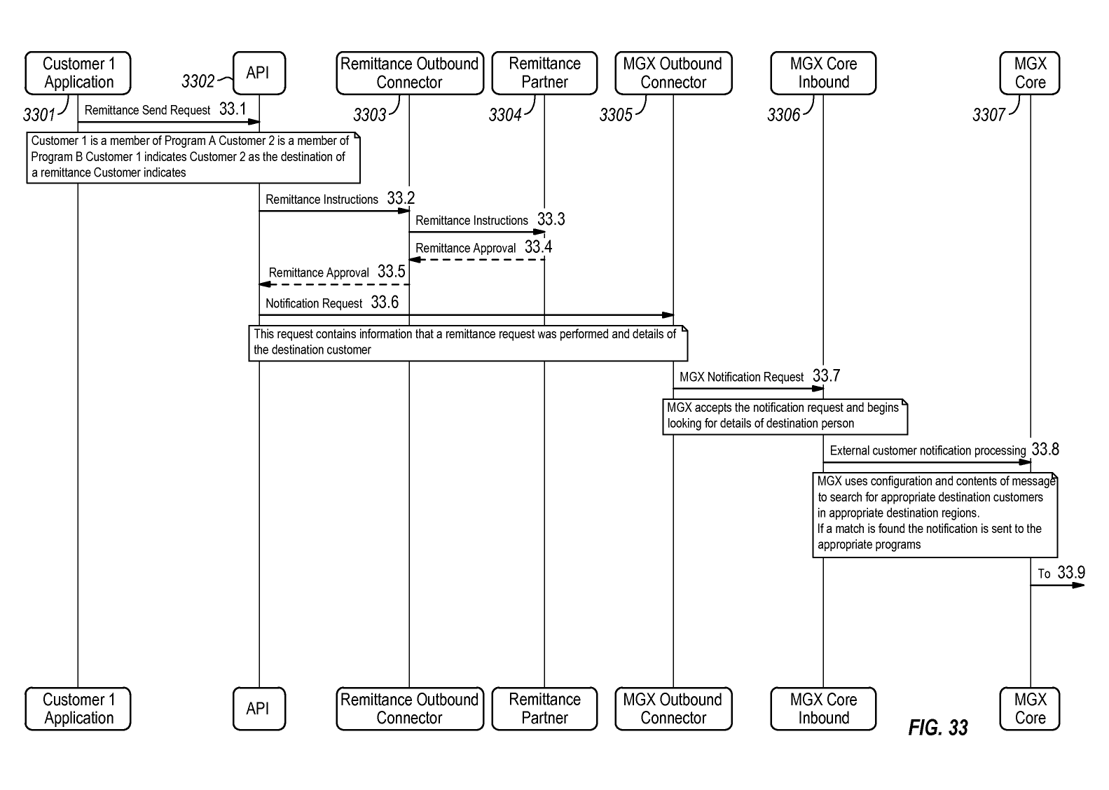

Another exemplary MGX use case as shown in FIG. 32 is that a customer (“Person 1”) has selected another customer (“Person 2”) as the recipient of a 3^{rd} party payment service. Person 2 is not a member of the same program as Person 1, but through the knowledge that MGX holds, MGX is able to notify Person 2 of the presence of the original payment within the boundaries of the program they are enrolled in. This allows the MGX to guide Person 2 to their program's application for completion of the service outside of the 3^{rd} party's infrastructure.

Element 3201 is an instance of the Mobile Global Exchange Platform comprised of Program A, which is a tenant configuration comprised within a Transaction System Platform which is further comprised of an API, MGX inbound connector, an MGX outbound connector, and a stored value account (SVA). Element 3203 is an instance of the Mobile Global Exchange Platform comprised of Program B which is a tenant configuration of a Transaction System Platform which is further comprised of an API, MGX inbound connector, an MGX outbound connector, a remittance inbound connector, and a stored value account (SVA). Element 3202 is an instance of the Mobile Global Exchange Platform. The MGX platform is comprised of a Transaction System Platform, MGX inbound connector, database, and MGX outbound connector; database configured to route instructions between instances of Transaction Systems.

In this example case, in Step 1: a user (e.g. ‘person 1’), who has pre-registered with and has pre-loaded funds or payment instruments into “Program A”, presents the details of his payment instrument at “Program A” with instructions to pay ‘person 2’ who is associated with Program B. In Step 2: the API of the MGX inbound connector comprised in FIG. 32, is configured to recognize that Person 2 is not associated with Program A and using Step 3 routes the instruction through the MGX outbound connector to the third party remittance partner (e.g. MoneyGram, Viamericas, Western Union) designated in the payment instruction received from person 1. Concurrently with Step 3, Step 4 is completed wherein the SVA account associated with person 1 and associated with Program A is debited for the full amounts of the funds to be transferred to person 2 and including any fees related to the transfer.

The MGX instance comprised in element 3202 comprised in FIG. 32 is operable to ensure that authorization occurs against the appropriate account for person 2. As such, the MGX instance 3202 comprised in FIG. 32 is operable to receive the instruction and using Step 5 and in Step 6, uses the database comprised within the MGX instance to determine the correct route for the instruction. Having determined the correct route for the instruction, the MGX instance comprised in element 3202, routes the instruction using the MGX Outbound connector. In Step 7, the routed instruction is received by the API of the MGX Inbound Connector of the Transaction System comprised in element 3203. In Step 8, a notification message is generated by Program B to notify person 2 regarding the pending remittance transaction. An outbound notification module comprised within the MGX platform comprised in FIG. 3203 sends the notification to person 1. Notification message may be in the form of an SMS message, push message, email message or proprietary or open format electronic message. Notification message may also be in the form of a phone call to person 1 or a postal or courier message.

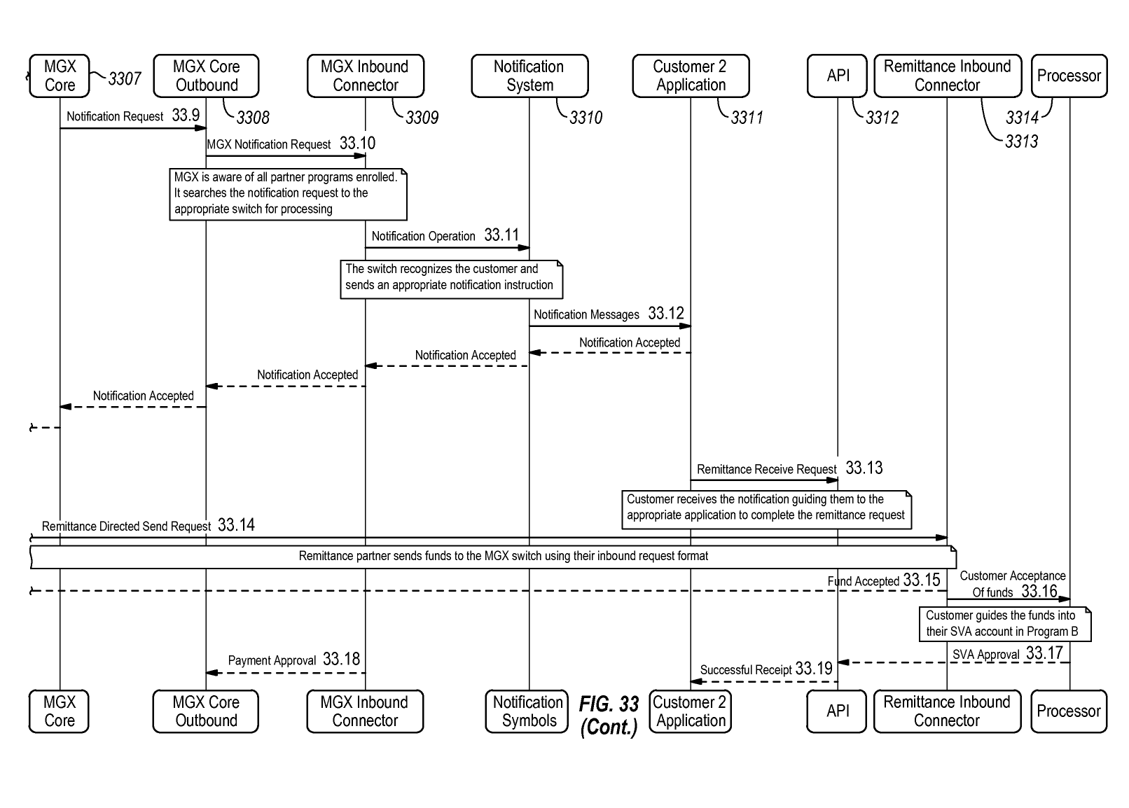

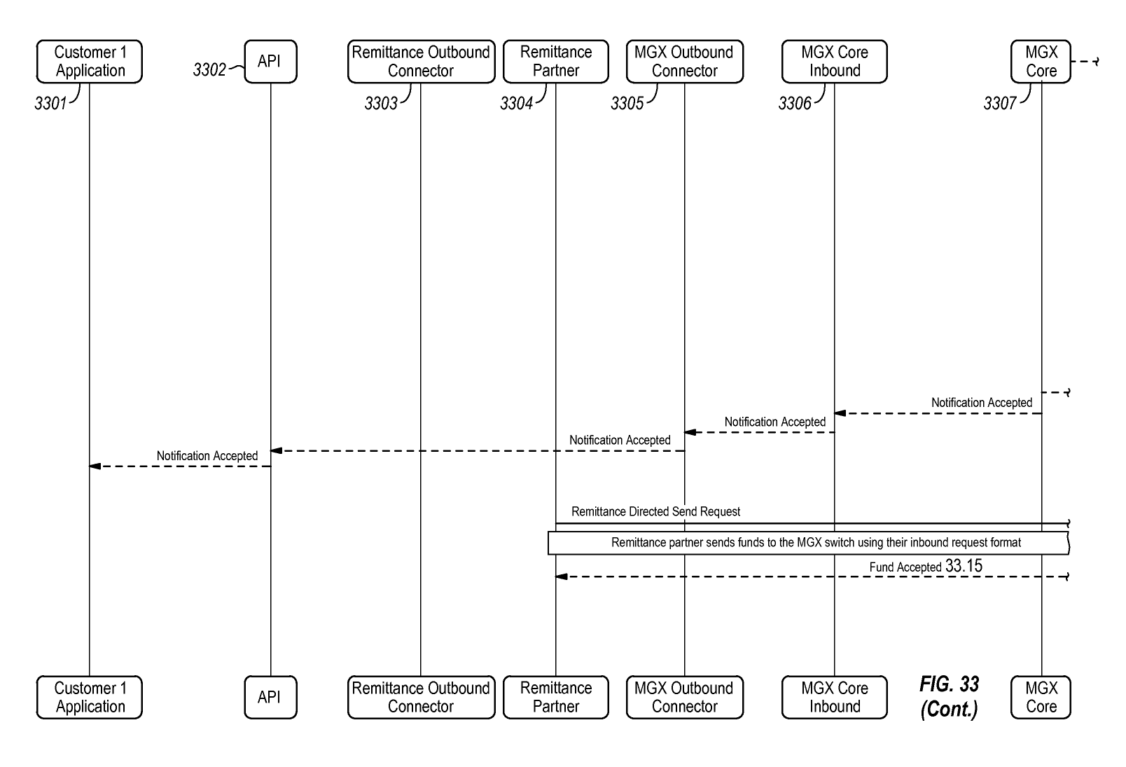

Having now received the notification message, person 2 initiates a remittance receive transaction using Step 10; transaction initiated with a mobile device of person 2 and received by the API of the inbound MGX connector of the MGX platform comprised in element 3203. The remittance receive transaction causes a workflow of the MGX platform to invoke the remittance inbound connector of the MGX platform with is operable to receive a remittance transaction instruction from the third party remittance partner. In Step 11 the third party remittance partner sends transaction details associated with the remittance transaction associated with person 2 and originally received in Step 3. The process is completed when the instruction is fulfilled in Step 12 by crediting the SVA account associated with Person 2 of Program B. Details related to Steps 1-12 are further described in conjunction with the sequence diagram of FIG. 33.

As shown, FIG. 33 is comprised of multiple components: Customer 1 Application (3301) is the application associated with Customer 1 who is associated with Program A which is comprised within the first Mobile Global Exchange. API (3302) is the channel API of the first MGX operable to receive instructions from the mobile device comprising the Application of Customer 1. Remittance Outbound Connector (3303) is the outbound connector of the first MGX. Remittance Partner (3304) may be a 3^{rd} Party Remittance Partner (e.g. MoneyGram, Viamericas, Western Union) associated with the MGX eco system. MGX Outbound Connector (3305) is the outbound MGX connector of the first Transaction System. MGX Core Inbound (3306) is the inbound MGX connector of the second Transaction System. MGX Core (3307) is the second instance of the Monetary Transaction and configured as the MGX Core platform. MGX Core Outbound (3308) is the outbound MGX connector of the second Transaction System.

MGX Inbound Connector (3309) is the inbound MGX connector of the third Transaction System. Notification System (3310) is the notification system of the third Transaction System. Customer 2 Application (3311) is the application associated with Customer 2 who is associated with Program B which is comprised within the third Transaction System. API (3312) is the channel API of the third Transaction System. Remittance Inbound Connector (3313) is the inbound remittance connector of the third Transaction System. SVA Processor (3314) is the SVA processor of the third Transaction System.

Components are operable for performing the following sequence of steps in connection with a remittance between two customers that are each associated with different Transaction Systems connected by a Transaction System configured and operable to facilitate a remittance transaction between members of different programs: 1) Remittance Send Request (33.1). 2) Where Customer 1 is a member of Program A and Customer 2 is a member of Program B. Customer 1 indicates Customer 2 as the destination of a remittance. 3) Remittance Instruction (33.2), 4) Remittance Instruction (33.3), 5) Remittance Approval (33.4), 6) Remittance Approval (33.5), 7) Notification Request (33.6). The request contains information indicating that a remittance request was performed and details of the destination customer. 8) MGX Notification Request (33.7)—MGX accepts the notification request and begins looking for details of destination person. 9) External customer notification processing (33.8) MGX uses configuration and contents of message to search for appropriate destination customers in appropriate destination regions. If a match is found, the notification is sent to the appropriate program.

10) Notification Request (33.9), 11) MGX Notification Request (33.10)—the MGX is aware of all partner programs enrolled. The MGX sends the notification request to the appropriate switch for processing. 12) Notification operation (33.11)—This notification system 3310 recognizes the customer and sends an appropriate notification instruction. 13) Notification Message (33.12) is sent to the application of Customer 2. 14) Remittance Receive Request (33.13)—the customer receives the notification, guiding them to the appropriate application to complete the remittance receipt. 15) Remittance Directed Send Request (33.14)—the remittance partner sends funds into the switch via their inbound request format. 16) Customer 2 acceptance of funds (33.16)—Customer 2 guides the funds into their SVA account in Program B. 17) SVA Approval (33.17), 18) Payment Approval (33.18) and 19) Successful Receipt (33.19). From this point notification messages traverse back through the system to the originating Customer application as a Successful API Response message.

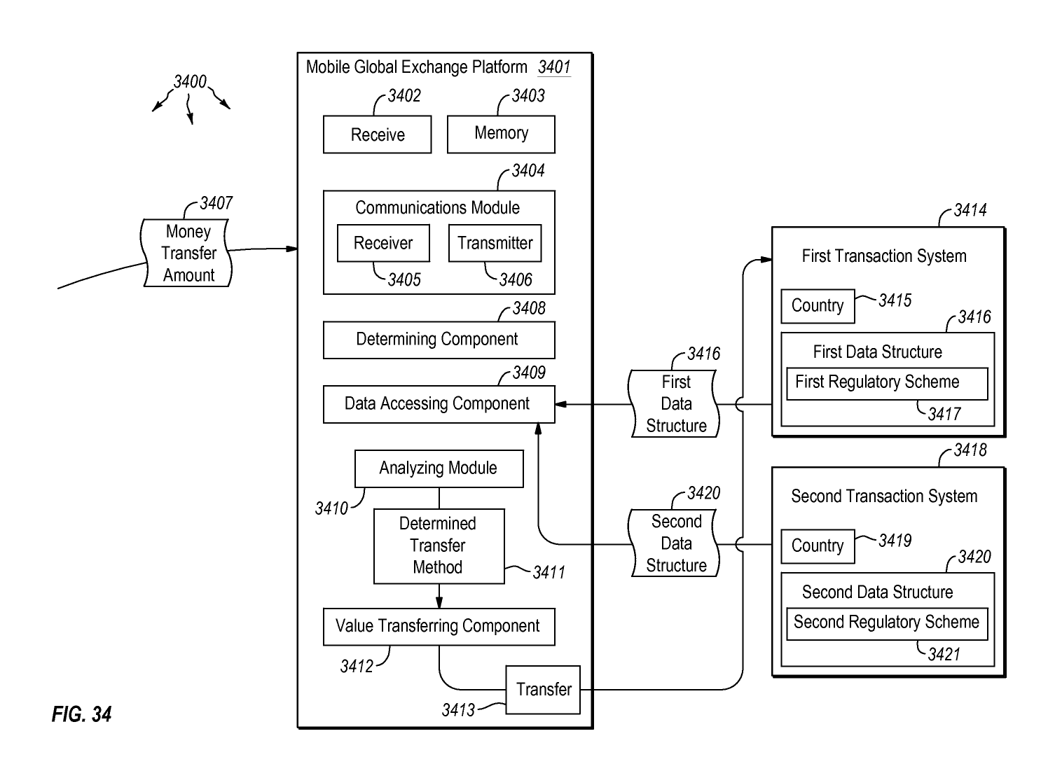

Turning now to FIG. 34, an embodiment of a mobile global exchange platform is provided in the environment 3400. The mobile global exchange platform 3401 includes one or more processors 3402 and memory 3403, a hardware receiver 3405 that receives an indication 3407 that a specified sum 3422 is to be transferred between a first transaction system 3414 and a second transaction system 3418, a determining component 3408 that determines a country of origin 3415 for the first transaction system, and further determines a country of origin 3419 for the second transaction system. The MGX platform 3401 further includes a data accessing component 3409 that accesses a database with a first data structure 3416 indicating a first regulatory scheme 3417 under which the first transaction system currently operates. The MGX platform 3401 is further configured to access a second data structure 3420 indicating a second regulatory scheme 3421 under which the second transaction system currently operates, where the first and second regulatory schemes indicate multiple rules that are to be enforced when transferring value in or out of the country of origin, and where the first regulatory scheme has at least one rule that is different than the second regulatory scheme.

The MGX platform also includes an analysis engine 3410 that conducts a real-time analysis of the current regulatory schemes for the first and second transaction systems to determine which specific rules apply (e.g. transfer method 3411) when transferring a sum between the first and second transaction systems in accordance with each system's respective regulatory scheme. The MGX platform further includes a value transferring component 3412 configured to electronically transfer the specified sum 3413, in compliance with the regulatory schemes of the first and second transaction systems (3414 and 3418, respectively), such that the specified sum is transferred from the first transaction system to the second transaction system according to each system's respective current regulatory schemes (3417 and 3421, respectively).

In some embodiments, the first transaction system and the second transaction system are located in different countries that use the same currency (such as Euros) or use a different currencies (such as U.S. dollars). The mobile global exchange platform 3401 ties each of the first and second transaction systems to a centralized exchange rate. As such, one currency would be exchanged into the other currency at the centralized exchange rate. In some cases, at least one bank may be involved in the monetary transfer between the first and second transaction systems.

In some cases, the money 3422 may be transferred from the first transaction system 3414 to the second transaction system 3418 using a SWIFT exchange. As mentioned above, the Society for Worldwide Interbank Financial Telecommunication (SWIFT) 2012 is a global organization that handles secured exchange of messages between many different financial institutions, and between financial institutions and their corporate or other clients. The SWIFT exchange money transfer from the first transaction system to the second transaction system may be performed according to an established fee schedule. The fee schedule may specify higher fees for transactions that are processed sooner, and lower fees for transactions that are processed later.

Thus, in some embodiments, when transactions are not as urgent, they may be held back for a period of time which is long enough to reduce the transaction fee. Still further, the transactions may be processed together in a bulk transaction. This bulk transaction may group those transactions together that are to be processed sooner, and may receive some discount for the bulk transaction. Those transactions that may be delayed for some time may also be grouped together and processed at a later time at the lower transaction fee schedule.

In other embodiments, SWIFT exchanges may be performed automatically when a transaction is initiated from within a certain country, and is not performed automatically when the transaction is initiated in other countries. For example, a user may specify that when they are in Europe, and they have initiated a transaction to the United States, then SWIFT exchanges are to be used automatically, while if the user is in Japan and they have initiated a transaction to the U.S., SWIFT exchanges will not be used automatically. The user may thus specify preferences that are to be followed when processing transactions. The preferences may be applied on a permanent basis, so that each time a user is in a certain country, certain transfer rules apply, or may be applied on a per-trip basis or on a calendar basis, such that while the user is on a trip to a specified country, certain transfer rules will be used (e.g. whether or not to use a SWIFT exchange), or that certain transfer rules will be used for a certain amount of time (e.g. number of days, weeks, months, etc.). As described further below, GPS, WiFi or other radio signals may be used to determine a user's current location. Decisions as to whether to use a SWIFT exchange or apply other transfer-specific rules may be based on this current location data.

In some cases, a mobile wallet application may communicate with the mobile global exchange platform 3401 using local financial regulations, regardless of which country the mobile wallet application is communicating from. Thus, if a mobile wallet application user is using the application in the United States, but is transferring money with Europe, the mobile wallet application may communicate with the MGX to determine local regulations for the European Union, and may conduct transactions according to those local regulations. The user may send authentication credentials using the mobile wallet application. The MGX platform 3401 may use the authentication credentials to authenticate the user and, potentially, to access the user's associated stored value accounts.

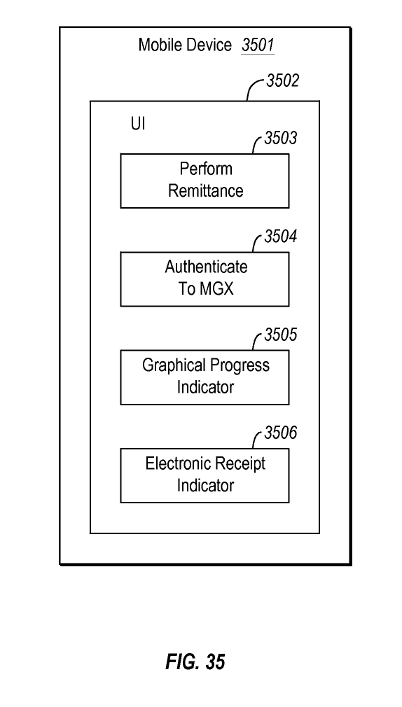

In another embodiment as shown in FIG. 35, a computer program product is provided that causes a computing system to instantiate a user interface 3502 on a mobile device 3501 that includes the following: a first button 3503 that, when selected, transmits one or more portions of data indicating that a specified amount of money is to be transferred between a first transaction system and a second transaction system, a second button 3504 that, when selected, transmits authentication credentials from a mobile wallet application, the authentication credentials corresponding to a mobile wallet user, a graphical indicator 3505 indicating that the money transfer is currently being processed, and an electronic receipt indicator 3506 configured to show that the transaction amount was transferred between the first transaction system and the second transaction system.

The UI 3502 may thus allow a user to perform a remittance between two countries. The UI show the mobile wallet user's current stored value account balance, and may allow the user to remit all or part of that balance to another user in another country. The UI provides a button 3503 to initiate the remittance. If the user is not already logged in, the authentication button 3504 may allow the user to authenticate to the MGX. Upon pressing the perform remittance button 3503, the MGX may begin identifying which countries will be involved in the remittance, and may determine an exchange rate and which financial regulatory schemes will be involved in the transfer. Once the user provides a recipient and an amount to transfer, the graphical indicator 3505 may indicate the progress of the remittance. Once processed, the electronic receipt indicator 3505 may indicate whether the transfer was successful or not.

In some cases, the UI 3502 may provide an additional button that allows a user to add a third transaction system to the remittance. As such, money may be transferred between a first transaction system (e.g. in the U.S.), and the third transaction system (e.g. in Japan), or between a second transaction system (e.g. in Europe) and the third transaction system in Japan, or between the first and third transaction systems. It will be recognized that other transaction systems may also be involved. Indeed, substantially any number of countries or transaction systems may be involved.

In some cases, the user may configure their smart phone or other mobile device to perform functions or perform functions in a certain manner based on their location. For instance, if the user is determined to be in a certain country, they may have a first specified bank that would perform a remittance, while if the user is in another country, they may have a second specified bank that would perform the remittance. Similarly, if the user is in one country, they may wish to have their transactions processed more quickly at a higher fee, whereas if they are in a different country when they initiate the remittance (or other function), they may prefer a slower transaction processing time at the lower fee. The mobile device may use a global positioning system (GPS) radio, WiFi radio, Bluetooth radio or other means of determining the device's location to determine where the user currently is. The determined location may be combined with map data to determine which country the mobile device is currently in. As such, functions may be performed (or not performed) or performed differently based on the device's detected location.

In another embodiment, a mobile global exchange platform includes processors and computer-readable storage media having stored thereon computer-executable instructions that, when executed by the processors, cause the computing system to perform a monetary remittance. Performing a monetary remittance includes the following: receiving subscriber communication over one of a plurality of channels connected to the mobile global exchange platform, where the subscriber communication indicates that a subscriber desires to transfer a specified amount of funds to a recipient using a selected payment method from the subscriber.

Performing a monetary remittance further includes verifying that the selected payment method is capable of providing the specified amount of funds, validating the status of the recipient to ensure the recipient has a valid subscriber account, debiting the selected payment method by the specified amount of funds, transferring the specified amount of funds to the recipient over at least one of the plurality of channels connected to the mobile global exchange platform and notifying the subscriber that the specified amount of funds was transferred to the recipient over at least one of the plurality of channels connected to the mobile global exchange platform.

In some cases, validating the status of the recipient may include performing a check on the specified recipient to comply with a financial regulatory scheme. The check may be a velocity check to ensure that the recipient has not performed too many transfers within a given time window. Additionally or alternatively, the check may be to determine that the recipient is a known and trusted individual. The money may be transferred internationally between mobile wallet applications from one mobile wallet user to another. The transferred funds are available for use in the subscriber's mobile wallet application substantially immediately after transfer. The sender or the recipient may have bank accounts, or may be unbanked, as described above. Thus, in this manner, international remittances may be performed using a mobile global exchange platform.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A cloud-based, mobile global exchange platform comprising the following:
one or more processors;
a hardware receiver configured to receive an indication that a specified sum is to be transferred between a first transaction system and a second transaction system;
a determining component configured to determine a country of origin for the first transaction system, and further determine a country of origin for the second transaction system;
a data accessing component configured to access a database with a first data structure indicating a first regulatory scheme under which the first transaction system currently operates, and further configured to access a second data structure indicating a second regulatory scheme under which the second transaction system currently operates, the first and second regulatory schemes indicating a plurality of rules that are to be enforced when transferring value in or out of the country of origin, the first regulatory scheme having at least one rule that is different than the second regulatory scheme;
an analysis engine configured to conduct a real-time analysis of the current regulatory schemes for the first and second transaction systems to determine which specific rules apply when transferring the specified sum between the first and second transaction systems in accordance with each system's respective regulatory scheme; and
a value transferring component configured to electronically transfer the specified sum in compliance with the regulatory schemes of the first and second transaction systems, such that the specified sum is transferred from the first transaction system to the second transaction system according to each system's respective current regulatory schemes.

2. The mobile global exchange platform of claim of claim 1, wherein the first transaction system and the second transaction system are located in countries that use different currencies.

3. The mobile global exchange platform of claim 2, wherein the cloud-based mobile global exchange platform ties each of the first and second transaction systems to a centralized exchange rate.

4. The mobile global exchange platform of claim 1, wherein at least one bank is involved in the transfer between the first and second transaction systems.

5. The mobile global exchange platform of claim 4, wherein the sum is transferred from the first transaction system to the second transaction system using a SWIFT exchange.

6. The mobile global exchange platform of claim 5, wherein the SWIFT exchange transfer from the first transaction system to the second transaction system is performed according to a fee schedule.

7. The mobile global exchange platform of claim 6, wherein the fee schedule specifies higher fees for transactions that are processed sooner, and lower fees for transactions that are processed later.

8. The mobile global exchange platform of claim 7, wherein the transactions are processed together in a bulk transaction.

9. The mobile global exchange platform of claim 1, wherein a mobile wallet application communicates with the mobile global exchange platform using local financial regulations, regardless of which country the mobile wallet application is communicating from.

10. The mobile global exchange platform of claim 1, wherein the first country of origin for the first monetary transaction system is determined based on a location indicator received from a mobile device, the location indicator being generated based on wireless data received on a wireless radio of the mobile device.

11. A computer program product comprising one or more computer storage media having thereon computer-executable instructions that, when executed by one or more processors of a computing system, cause the computing system to instantiate a user interface that includes the following:
a first button that, when selected, transmits one or more portions of data indicating that a specified sum is to be transferred between a first transaction system and a second transaction system;
a second button that, when selected, transmits authentication credentials from a mobile wallet application, the authentication credentials corresponding to a mobile wallet user;
a graphical indicator indicating that the transfer is currently being processed; and
an electronic receipt indicator configured to show that the sum was transferred between the first transaction system and the second transaction system.

12. The computer program product of claim 11, wherein the user interface further includes an indication of the mobile wallet user's current stored value account balance.

13. The computer program product of claim 11, wherein the money sum is transferred from the first monetary transaction system to the second monetary transaction system using a SWIFT exchange, based on a determination that the transaction is being initiated from a certain country.

14. The computer program product of claim 11, wherein the user interface includes a third button that allows a user to add a third transaction system, such that transfers between the first transaction system and the third transaction system, or between the second transaction system and the third transaction system.

15. A cloud-based mobile global exchange platform comprising the following:
one or more processors;
an integration tier configured to manage mobile wallet sessions and maintain the integrity of financial transactions; integration tier also comprised of a communication API and other communication mechanisms to accept messages from channels;
notification services configured to send notifications through different notification channels including short message peer-to-peer, short-message services and simple mail transfer protocol emails;
service connectors configured to connect to third party systems; each connector deployed as a separate module intended to integrate an external service to the system architecture;
business process services configured to implement business workflows, including executing financial transactions, auditing financial transactions, invoking third-party services, handling errors, and logging platform objects;
a payment handler configured to wrap APIs of different payment processors including banking accounts, credit and debit cards or processors; payment handler exposing a common API to facilitate interactions with many different kinds of payment processors;
security services configured to perform subscriber authentication;
authorization services configured to perform client authorization using a database-based access control list table;
database configured to manage customer accounts, manage company accounts manage transaction histories, store financial transaction details, store customer profiles, store dictionaries used by the mobile wallet platform including countries and currencies, and managing money containers;
a rules engine configured to gather financial transaction statistics and use the gathered statistics to provide transaction properties including fees and bonuses; rules engine also configured to enforce business constraints including transaction and platform license constraints;
one or more computer-readable storage media having stored thereon computer-executable instructions that, when executed by the one or more processors, cause the computing system to perform a remittance, the method comprising the following:
receiving subscriber communication over one of a plurality of channels connected to the mobile global exchange platform; message received using an API of the integration tier, the subscriber communication indicating that a subscriber desires to transfer a specified sum to a recipient using a selected transfer method from the subscriber;
verifying that the selected transfer method is capable of providing the specified sum; validation performed by the rules engine in accordance with business constraints;
validating the status of the recipient to ensure the recipient has a valid subscriber account; subscriber account comprised within the database;
debiting the selected transfer method by the specified sum; debit performed by an API of the payment handler;
transferring the specified sum to the recipient over at least one of the plurality of channels connected to the mobile global exchange platform; transfer completed using a service connector; and
notifying the subscriber that the specified sum was transferred to the recipient over at least one of the plurality of channels connected to the mobile global exchange platform; notification completed by the notification services.

16. The mobile global exchange platform of claim 15, wherein validating the status of the recipient comprises performing a check on the specified recipient to comply with a financial regulatory scheme.

17. The mobile global exchange platform of claim 15, wherein the sum is transferred internationally between mobile wallet applications.

18. The mobile global exchange platform of claim 17, wherein the transferred sum is available in the subscriber's mobile wallet application.

19. The mobile global exchange platform of claim 15, wherein the subscriber is an unbanked subscriber.

20. The mobile global exchange platform of claim 15, further comprising performing at least one of a limit check and a velocity check on the selected payment method.
